(19) United States
(12) Patent Application Publication
(10) Pub. No.: US 2024/0274311 A1
(43) Pub. Date: Aug. 15, 2024

(54) COMPOSITE NUCLEAR WASTE DISPOSAL CAPSULES

(71) Applicant: Henry Crichlow, Norman, OK (US)

(72) Inventor: Henry Crichlow, Norman, OK (US)

(21) Appl. No.: 18/375,922

(22) Filed: Oct. 2, 2023

Related U.S. Application Data
(63) Continuation-in-part of application No. 18/108,001, filed on Feb. 9, 2023.
(63) Continuation-in-part of application No. 18/235,277, filed on Aug. 17, 2023.
(63) Continuation-in-part of application No. 18/212,978, filed on Jun. 22, 2023.

(51) Int. Cl. G21F 9/30; B22D 7/00; B22D 17/08; B22D 17/20; B22D 19/00; B22D 21/02; B22D 21/06; E21B 41/00; G21F 5/008; G21F 9/34

(52) U.S. Cl. CPC G21F 9/302; B22D 7/00; B22D 17/08; B22D 17/2084; B22D 19/00; B22D 21/025; B22D 21/06; E21B 41/005; G21F 5/008; G21F 9/34

(57) ABSTRACT

Nuclear waste, such as, but not limited to, spent nuclear fuel (SNF) assemblies or portions thereof, are chipped and compacted into (waste) pucks that are placed within diecast molds, and then diecast injection molding occurs within the diecast molds and around the pucks that are emplaced within those diecast molds, with injected molten alloy(s), to form solid metal ingots upon sufficient cooling after the diecasting injection that contain within the ingots the emplaced pucks. The molten alloy(s) may contain a copper alloy. The molten alloy(s) may also contain neutron absorbers. The ingots may be placed into waste capsules. The ingots and/or the waste capsules may be landed in deeply located horizontal wellbores. The deeply located horizontal wellbores may be at least partially located within deeply located geologic formations.

### PRIORITY NOTICE

The present patent application, as a continuation-in-part (CIP) patent application, claims priority under 35 U.S.C. § 120 to earlier filed and copending U.S. nonprovisional patent application Ser. No. 18/235,277 filed on Aug. 17, 2023, by the same inventor as the present patent application; wherein the disclosure of U.S. nonprovisional patent application Ser. No. 18/235,277 is incorporated herein by reference in its entirety.

The present patent application, as a continuation-in-part (CIP) patent application, claims priority under 35 U.S.C. § 120 to earlier filed and copending U.S. nonprovisional patent application Ser. No. 18/212,978 filed on Jun. 22, 2023, by the same inventor as the present patent application; wherein the disclosure of U.S. nonprovisional patent application Ser. No. 18/212,978 is incorporated herein by reference in its entirety.

The present patent application, as a continuation-in-part (CIP) patent application, claims priority under 35 U.S.C. § 120 to earlier filed and copending U.S. nonprovisional patent application Ser. No. 18/108,001 filed on Feb. 9, 2023, by the same inventor as the present patent application; wherein the disclosure of U.S. nonprovisional patent application Ser. No. 18/108,001 is incorporated herein by reference in its entirety

### CROSS REFERENCE TO RELATED U.S. PATENTS

The disclosures and teachings of U.S. utility Pat. Nos. 5,850,614, 6,238,138, 10,427,191, and 11,289,234, all by the same inventor as the present patent application, are all incorporated by reference as if fully set forth herein.

### TECHNICAL FIELD OF THE INVENTION

The present invention relates in general to containment, preparation, storage, and/or disposal of radioactive materials, such as, but not limited to, nuclear waste; and, more specifically, to the containment, preparation, storage, and/or disposal of modified spent nuclear fuel (SNF) assemblies, portions thereof, and/or other radioactive waste forms, into generally cylindrical solid metal disposal capsules, wherein such generally cylindrical solid metal disposal capsules may then be emplaced within deeply located geological formations of predetermined characteristics (such as, but not limited to predetermined rock properties) in which geological repositories may be implemented as human-made deep horizontal (lateral) wellbores in the deeply located geological formations.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Today (circa 2023), there is a massive quantity of nuclear waste accumulating across the world, including the United States (U.S.). There are two significant sources of a majority of nuclear waste. The first source is high-level waste (HLW) from generating electric power in nuclear-fired power plants and from military nuclear operations. The second source is low-level waste (LLW) from various industrial activities using radioactive sources and using radioactive production systems. Both sources of radioactive (nuclear) waste must be addressed, controlled, and disposed of safely. This patent application addresses one of these sources of radioactive waste and how to dispose of that waste safely and, more importantly, in a timely manner. This patent application is directed to the disposal of HLW, such as, but not limited to, spent nuclear fuel (SNF) materials so that the SNF may be disposed of safely, securely, economically, and timely.

Current and prior art disposal of SNF, as HLW, in vertical wellbores involves the placement of the nuclear waste within capsules, wherein the capsules containing nuclear waste are usually placed in the bottom one-third section of a vertical wellbore. Well-bore sealing plugs have been placed above the emplaced capsules. Above these sealing plugs are various backfill materials that are designed to swell and fill the vertical well-bore above the emplaced nuclear waste in capsules. However, in practice, some structural/physical changes may occur in and at the near wellbore region between the drilled-out wellbore and the native rock formation due to the drilling process. Fissures, microfractures, and permeability changes may occur at the interface between the wellbore and into the proximate surrounding native rock, wherein this phenomenon is sometimes called “near-wellbore damage” in the oil drilling industry. These changes contribute to and may allow fluid bypass, migration, and movement of waste material over time out of the emplaced capsules and into the surrounding native rock, which is undesired and can threaten the water table with radioactive contamination.

Nuclear waste disposal in horizontal wellbores has been illustrated in some previous U.S. utility patents, such as, U.S. Pat. Nos. 5,850,614, 6,238,138, 11,289,234, and 10,427,191 all by the same inventor as the present patent application. The disclosures and teachings of U.S. utility patents such as, U.S. Pat. Nos. 5,850,614, 6,238,138, 11,289,234, and 10,427,191 are all incorporated by reference as if fully set forth herein. Various embodiments taught in this patent application may place encapsulated nuclear (radioactive) waste materials into lateral or horizontal wellbores.

In prior art technology and operations, two diametrically opposing approaches to treating SNF assemblies are taught. A first approach reprocesses SNF assemblies to separate plutonium and/or uranium from other nuclear waste contained in the used (or “spent”) nuclear fuel (SNF) from nuclear power reactors (and the separated plutonium can be re-used to fuel reactors and/or to make nuclear weapons). And the second approach is to dispose of SNF assemblies, intact or disassembled, as waste into near-surface or deep geological repositories.

With respect to the first prior art approach of reprocessing, this prior art reprocessing is a series of chemical operations that separates plutonium and/or uranium from other nuclear waste contained in the used (or “spent”) fuel (SNF) from nuclear power reactors. FIG. 2A is a flow chart showing this prior art reprocessing method. The separated plutonium can be used to fuel reactors and/or to make nuclear weapons. In the late 1970s, the U.S. decided on nuclear non-proliferation grounds not to reprocess spent fuel from U.S. power reactors but to directly dispose of it in a deep underground geologic repository where it would remain isolated from the environment for at least tens of thousands of years (at least that was the general theory).

Note, the prior art reprocessing approach does not reduce the need for storage and disposal of radioactive waste. Worse, reprocessing would make it easier for terrorists and/or bad actors to acquire nuclear materials to weaponize and for nations to develop nuclear weapons programs. Less than twenty (20) pounds of plutonium is needed to make a simple nuclear weapon. Whereas, stealing is nearly impossible if the plutonium remains bound in large, heavy, and highly radioactive spent fuel (SNF) assemblies (which has been and is the current U.S. practice, i.e., most plutonium in the U.S. is tied up [bound] in SNF assemblies).

Moreover, outside of the U.S., commercial-scale reprocessing facilities handle so much of this material that it has proven impossible to keep track of it accurately in a safe and timely manner, making it feasible that the theft of enough plutonium to build several bombs could go undetected for years.

First, there is no spent fuel (SNF) storage crisis, current storage space is ample, nor is there a serious shortage of available naturally available uranium. Thus, there is no need for such a drastic change in course to the reprocessing approach noted in FIG. 2A. Hardened interim storage of spent fuel (SNF) in dry casks is an economically viable and secure option for at least fifty (50) years. And deep geological storage/disposal is the long-term viable SNF assembly disposal pathway after that interim short-term storage period.

Second, reprocessing does not reduce the need for eventual long-term storage and/or disposal of radioactive waste, such that a geologic repository will still be required at some point. Plutonium constitutes only about one percent (1%) of the spent fuel (SNF) from U.S. reactors. After reprocessing, the remaining (up to ninety-nine percent [99%] of) material will be in several different waste forms, much of which will be radioactive. The total nuclear waste volume will have been increased by a factor of twenty (20) or more by reprocessing, including the generation of low-level waste (LLW) and plutonium-contaminated HLW waste.

Further, the reprocessing prior art approach is very expensive. Multiple governmental and quasi-governmental agencies and technical publications indicate that such prior art reprocessing and using plutonium as reactor fuel are also far more expensive than using uranium fuel and directly disposing of the spent fuel (SNF). Some 60,000 tons of nuclear waste have already been produced in the U.S., and existing reactors add some 2,000 metric tons of spent fuel (SNF) annually. The U.S. Energy Department recently released an industry estimate that a reprocessing plant with an annual capacity of 2,000 metric tons of spent fuel (SNF) would cost up to $20 billion to build, and the U.S. would need at least two (2) of such sized reprocessing facilities just to reprocess all its spent fuel (SNF). An Argonne National Laboratory scientist recently estimated that the cost premium for re-processing spent fuel (SNF) would range from $0.40 to $0.60 cents per kilowatt-hour, corresponding to an extra $3 to $4.5 billion per year for the current U.S. nuclear reactor fleet. The U.S. public would end up having to pay such burdensome costs, either through increased taxes and/or higher electricity bills.

There is a need for a different and better method of SNF disposal as compared to the prior art reprocessing approach (see e.g., FIG. 2A for this prior art reprocessing approach).

Today (2023), and in the recent past (e.g., since 1994), the treatment and reprocessing of SNF have been reported by at least two major groups or organizations across the globe.

The first is at SELLAFIELD nuclear-reprocessing operations in the United Kingdom. The SNF assemblies are mechanically “cut-up,” or fragmented, and then chemically treated to provide re-useable fissile materials. See e.g., FIG. 2B.

And second, in France, the ORANO nuclear reprocessing operations follow a similar operational path: initial mechanical chipping/cutting is followed by chemical treatment with nitric acid of the SNF material pieces to extract the fissile materials for re-use. The nonradioactive material is then disposed of as generalized metal waste at landfills or similar systems. See e.g., FIG. 2C.

These two prior art reprocessing systems (FIG. 2B and FIG. 2C) have some operational processes partially incorporated in the disposal processes illustrated herein in this subject patent application. However, the disposal of the SNF, as taught herein, does not include the chemical treatment of the SNF for extracting the fissile materials for re-use. Embodiments of the present invention do not chemically treat SNF to extract fissile materials for re-use. The novel processes taught herein dispose of all the structural metal elements, along with the radioactive constituents, that together comprise an original SNF assembly, without any physical and/or chemical separation from each other, which is a departure from the prior art reprocessing teachings.

Based on the prior art's inherent shortcomings, there is a critical need for an effective, long-lasting, robust, repeatable, and economical method for disposing of SNF assemblies (without reprocessing for re-use). Such inventive processes preclude the need for all the expensive, time-consuming, and dangerous intermediate operations currently being used or contemplated to render the nuclear waste in a form that, eventually, still has to be buried in deep underground repositories. An approach is needed that minimizes or foregoes these complex operational steps of the prior art. To solve the above-described problems, the present invention provides systems, methods, devices, apparatus, and efforts to dispose of the nuclear waste, such as, but not limited to SNF assemblies, accumulating on the surface.

The novel approaches taught as part of this patent application provide systems, methods, devices, apparatus, and steps wherein the HLW and/or SNF assemblies waste disposal operations may go directly from the existing fuel assembly rod cooling ponds to a mechanical transformation process and then to the underground disposal repository in deep (geologic/rock) formations with minimal additional effort.

It is to these ends that the present invention has been developed to dispose of HLW and/or SNF assemblies materials in deeply located human-made systems that can be effectively sealed off from the ecosphere by geological means and at great depths below the Earth's surface. It is to these ends that the present invention has been developed.

### BRIEF SUMMARY OF THE INVENTION

To minimize the limitations in the prior art, and to minimize other limitations that will be apparent upon reading and understanding the present specification, various embodiments of the present invention describe devices, apparatus, systems, and methods for mechanical and/or physical modifications of nuclear waste forms, such as, but not limited to, spent nuclear fuel (SNF) assemblies for disposing of within deeply located geologic repositories.

At least some embodiments of the present invention may describe systems, methods, processes, and/or steps for the long-term protection of high-level nuclear and radioactive waste (HLW) products/materials, such as, but not limited to spent nuclear fuel (SNF) assemblies, and/or other radioactive waste forms, by providing systems, methods, processes, and/or steps to securely protect the surface environment by sealing the disposed of waste within deeply located horizontal (lateral) wellbores.

Additionally, at least some embodiments of the present invention focus on satisfying a need to prepare the SNF assemblies for deep geological disposal in a manner that is safe, cost-effective, timely and allows for maximal disposal of radioactive waste materials.

At least some embodiments of the present invention may focus on mechanically modifying the SNF assemblies and then implementing the modified waste form inside cylindrical waste capsule systems that are configured to receive the modified waste. This modified waste form is mechanically derived from existing SNF assemblies without any chemical modification and without separating the (metal) structural elements of a given SNF assembly from its radioactive fuel materials.

In some embodiments, nuclear waste, such as, but not limited to, spent nuclear fuel (SNF) assemblies or portions thereof, are chipped (reduced in size) and compacted into (waste) pucks that may be placed within diecast molds; and then diecast injection molding occurs within the diecast molds and around the (waste) pucks that are emplaced within those diecast molds, with injected molten alloy(s), to form solid metal ingots upon sufficient cooling after the diecasting injection that contain within the ingots the emplaced pucks. The molten alloy(s) may contain a copper alloy. The molten alloy(s) may also contain neutron absorbers. The ingots may be placed into waste capsules. The ingots and/or the waste capsules may be landed in deeply located horizontal wellbores. The deeply located horizontal wellbores may be at least partially located within deeply located geologic formations.

In some embodiments, such a method may comprise: (1) reducing the size of the original nuclear waste form(s) by feeding the original nuclear waste form(s) into specialty industrial machines, such as, but not limited to, industrial chipping machines, for size reduction to yield (output) waste chips; (2) compressing, compacting, extruding, and/or shaping the waste chips into dense waste pucks by using industrial compactor machines; (3) loading the generated dense waste pucks into waste capsules; (4) placing the waste pucks within diecast molds, and then diecast injection molding may occur within the diecast molds and around the waste pucks or portions thereof that are emplaced within those diecast molds, with injected molten alloy(s), to form solid composite metal matrix composites or ingots upon sufficient cooling, after the injection (diecast) process has stopped. These resulting radioactive ingots (that contain the waste pucks) may then be disposed of within deeply located horizontal (lateral) wellbores in deeply located appropriate geologic formations.

At least some embodiments of the present invention differ from the prior art SNF reprocessing method for generating nuclear fuel for reuse as nuclear fuel by one or more of the following: (1) a mechanical fragmentation, shredding and/or chipping operation of intact SNF assemblies; (2) a volume reduction process, that compacts and/or compresses the outputs from the (1) mechanical fragmentation shredding and/or chipping operations; (3) a molding and/or extruding process of the outputs from the (2) volume reduction process, wherein in this (3) process, the waste is shaped and sized into (cylindrical) elements that are specifically configured to fit within the waste capsules; and (4) making an ingot of the shredded/compacted waste material by diecast injection and lastly (5) encapsulation and disposal of the converted nuclear waste into the waste capsules, which are then emplaced within the deeply located horizontal (lateral) wellbores. The outputs of (2) and/or of (3) may be waste in the puck form. In some embodiments, processes (2) and (3) may be combined. Waste pucks may be the main inputs into the diecasting operation of (4).

Metal matrix composites have been illustrated in some U.S. utility Pat. No. 7,22,0492 to Fick, in published U.S. nonprovisional patent application 2004/0173291 to Rozenoyer, and in published international patent application WO86/03997 to Barlow, wherein the teachings of such publications are incorporated by reference herein. There are today three industrial means of making metal composites. These are stir casting, infiltration, and high-pressure die casting. However, in this patent application, only high-pressure diecasting process (HPDC) may be utilized because of its operational and technical advantages.

Note, the metal matrix composite ingots produced according to embodiments of the present invention, do contain within the ingots the emplaced SNF assembly materials, which were in waste puck form.

In some embodiments, the molten alloy(s) used in the diecasting operations contemplated herein may comprise (contain) a copper alloy. In some embodiments, the molten alloy(s) may also comprise (contain) neutron absorbers.

In some embodiments, the output (radioactive) ingots may be placed into waste capsules by loading the diecast ingots into waste capsules.

In some embodiments, the ingots and/or the waste capsules may be landed (placed and/or inserted) in deeply located horizontal (lateral) wellbores. In some embodiments, the deeply located horizontal (lateral) wellbores may be located within deep geological formations.

In some embodiments, as a safety precaution, a criticality analysis may be desired, required, and/or implemented prior to making a given waste capsule, filling a given waste capsule with nuclear (radioactive) waste, and/or emplacing a given waste capsule with the nuclear (radioactive) waste within a given deeply located geological repository, to ensure no critical (nuclear) reactions occur in the nuclear waste material during processing, emplacement, and/or residency in the given deeply located geological repository.

In some embodiments, a fissile criticality analysis (FCA) may be performed on the waste capsule, the nuclear (radioactive) waste itself, and on the equipment that may handle the waste capsules and/or the nuclear (radioactive) waste, to determine metrics such as, waste composition, waste type, waste density, waste weight, waste volume, waste size (dimensions), waste shape (geometry), waste capsule materials of construction, waste capsule thickness, waste capsule size (dimension), waste capsule shape (geometry), waste capsule packing of waste, a quantity of packed waste capsules, formation (rock) properties of the formation (rock) that immediately surrounds a given or planned deeply located geological repository, and geometry of the disposal system and its contents such that the nuclear (radioactive) waste material always remains subcritical.

In some embodiments, this FCA analysis may provide (yield) upper limits on the weight per unit of material, typically called “gram-limits,” which may be the maximum quantity of fissile material in a given waste package (waste capsule). In some embodiments, the required gram limits may be used in all the subsequent waste disposal processes contemplated in a given embodiment of the present invention. In addition, the criticality analysis (FCA) may utilize factors such as, physical volumes of waste, material burnup times, time out of the reactor, and other well-known safety metrics to define the final configuration of the waste package (waste capsule).

In some embodiments, devices, apparatus, systems, methods, steps, and/or the like may place at least one SNF assembly (or portion thereof) within a mold (cast and/or die); may then seal and/or close that mold (cast and/or die); and then inject into that closed and sealed mold (cast and/or die), that is housing the SNF assembly (or portion thereof), pressurized molten (liquid) metal(s) and/or alloy(s) (such as, but not limited to, copper and/or copper alloy(s)), that by virtue of the pressure, heat, and liquid (fluid) nature of the molten metal(s) and/or alloy(s) may also penetrate substantially into all of the void spaces within the SNF assembly material (or portion thereof) resulting in an output of a heterogenous metal solid ingot comprising both the injection metal(s)/alloy(s) in a resolidified state and the SNF materials (also in a solid state), and that now has no internal void spaces in the SNF materials (or in the ingot). In some embodiments, the injected pressurized molten (liquid) metal(s) and/or alloy(s) may comprise neutron-absorbing material(s). In some embodiments, the SNF assembly or portion thereof may be in a form of a plurality of waste pucks.

In some embodiments, this high-pressure die casting (HPDC) process may involve (comprise) injecting molten metal alloys into a die cavity under high pressure. In some embodiments, at least some steps involved in this HPDC injection of metal alloys method (process) may be as follows: Die (Mold) Preparation; Die (Mold) Loading with the SNF material (e.g., waste pucks); Die (Mold) Closing; Shot Sleeve Filling; Injection; Cooling; Die (Mold) Opening; Ejection; Trimming and Finishing; Inspection; Post-Treatment; Quality Control; portions thereof; combinations thereof; and/or the like.

In some embodiments, with respect to the Die (Mold) Preparation step, the die (mold) may be prepared by cleaning and/or lubricating surfaces of the die (mold) to promote smooth molten metal flow, easy ejection of the casting, and desired release of the formed ingot after the diecasting and mold is opened.

In some embodiments, with respect to the Die (Mold) Loading with SNF material step, the SNF assembly materials may be a plurality of waste pucks that get loaded into the die (mold) cavity before the die (mold) is closed (sealed).

In some embodiments, with respect to the Die (Mold) Closing step, the two (2) halves of the die (mold), a stationary half (die) and a moving half (cover), are closed together securely (e.g., by hydraulic means or the like). Note the “halves” of a given die (mold) are not necessarily geometric or dimensional halves; i.e., the “halves” may be of different sizes, dimensions, and/or geometry with respect to each other. Additionally, in some embodiments, a given die (mold) may have more than two (2) “halves.”

In some embodiments, with respect to the Shot Sleeve Filling step, the shot sleeve, which acts as a reservoir for the molten metal(s) and/or alloy(s), may be at least partially (sufficiently) filled with the molten (liquid) desired and/or predetermined metal(s) and/or alloy(s) such that at least one complete casting may be carried out. In some embodiments, the metal(s) and/or alloy(s) may typically be melted in a furnace before being transferred to the shot sleeve.

In some embodiments, with respect to the Injection step, the shot sleeve may be hydraulically (or the like) (piston) driven to force the molten metal(s) and/or alloy(s) into the die cavity through a sprue and runner system. The high pressure, high temperature, and molten (liquid/fluid) nature ensure rapid and complete filling of the mold (die) cavity as well as the void spaces within the plurality of pucks (SNF material).

In some embodiments, with respect to the Cooling step, after the injection, the formerly molten metal(s) and/or alloy(s) of the casting (ingot) start to resolidify as it cools below its melting point. In some embodiments, cooling channels within the die (mold) help expedite (speed up) this cooling and re-solidification process. In some embodiments, the cooling channels may be in physical communication with a heat exchanger configured to pull heat out of the die (mold).

In some embodiments, with respect to the Die (Mold) Opening step, once the metal(s) and/or alloy(s) of the molten metal composite (ingot) have sufficiently resolidified (and/or attained a required [predetermined] strength), the die halves are opened.

In some embodiments, with respect to the Ejection step, ejector pins or other mechanisms may be used to push the casting (ingot) out of the die cavity, and/or material handling means (e.g., a robotic arm) may be used to removably attach to the casting to pull the casting (ingot) out of the die (mold) cavity.

In some embodiments, with respect to the Trimming and Finishing step, excess material, such as flash or burrs, if any, may be removed from the casting (ingot) using trimming tools or other finishing processes. In some embodiments, excess material that is removed may be used as feed material in a subsequently produced diecast ingot.

In some embodiments, with respect to the Inspection step, the casting (ingot) may be inspected for any defects, dimensional accuracy, and/or adherence to (predetermined) quality standards.

In some embodiments, with respect to the Post-Treatment step, additional treatments may be (optionally) performed as needed and/or as desired, such as, but not limited to, passivation, heat treatment, surface finishing (e.g., shot blasting, polishing, coating), and machining, to achieve the desired properties and final product specifications. For example, and without limiting the scope of the present invention, a finished casting (ingot) should have an exterior surface that is generally smooth and free of exterior surface defects that may increase friction and/or be more likely to get caught as the casting (ingot) moves within a given wellbore.

In some embodiments, with respect to the Quality Control step, the finished casting (ingot) may undergo a rigorous quality control inspection to ensure it meets any required standards before being inserted into a given wellbore.

It's worth noting that the specific steps and/or details may vary depending on the: complexity of the SNF material (or portion thereof) [the waste pucks]; complexity of the intended outputted casting (ingot); the chosen and/or selected metal(s) and/or alloy(s) for injection; the chosen and/or selected neutron absorbing material(s) to be mixed into the molten metal(s) and/or alloy(s), if any; the HPDC equipment used; portions thereof; combinations thereof; and/or the like.

In some embodiments, a method for encapsulating SNF material (or portions thereof) may comprise one or more of the following steps: (1) mounting a die (mold) (that is configured to receive at least one SNF assembly material [or portion thereof]) onto a high-pressure injection die casting (molding) machine (press), cleaning that die (mold), spraying a mold release agent onto surfaces of the die (mold) (e.g., with a sprayer), loading the at least one SNF assembly material [or portion thereof]) into the die (mold), and then closing that die (mold); (2) melting metal(s) and/or alloy(s) with a heating furnace (and/or other sufficiently hot heating means) and putting the molten (liquid) metal(s) and/or alloy(s) into a holding reservoir (wherein the metal(s) and/or alloy(s) may be copper and/or a copper alloy); (3) adding (and mixing) a neutron-absorbing material (such as, but not limited to, boron carbide [B₄C]) as needed and/or as desired to the molten (liquid) metal(s) and/or alloy(s) (e.g., within the holding reservoir); (4) injecting, under pressure, the melted molten metal(s) and/or alloy(s) (and neutron-absorbing material, if any) into the die (mold) of the diecasting machine, that also has the at least one SNF assembly material (or portion thereof) located entirely within the die (mold); (5) injection molding under pressure using diecasting machine to form a casting which may be in the form of a modified SNF assembly material (or portion thereof) solid that looks and behaves like a solid cylindrical rod or “ingot” of metal(s) and/or alloy(s), then opening the die (mold) after the casting (ingot) has sufficiently cooled to be at least mostly (substantially) entirely solid, extracting the casting (ingot) out of the die (mold); portions thereof; combinations thereof; and/or the like. In some embodiments, the SNF assemblies materials may be in the form of a plurality of waste pucks.

In some embodiments, in the step (2), the step (4), and/or in the step (5) of the immediate preceding paragraph, the diecasting machine may be a suitably configured diecasting machine with a diecasting temperature of at least 2,100 degrees Fahrenheit (° F.) to 2,282° F. Copper alloys may be formulated to have lower melting points compared to pure copper. By alloying copper with other metals and/or elements, the melting point of the resulting copper alloy may be significantly reduced for use in this process.

By implementing the above technical solution, the following beneficial practical effects may be accomplished. First, with regard to the injection process method for molding of the given SNF assembly material (or portion thereof) of the present invention, the molded outputted product, i.e., the composite casting (or ingot), may be uniformly compact interiorly, with the best interior structure, and the preferred mechanical properties of the molded SNF product may be guaranteed. (In some embodiments, the SNF assemblies materials that went into the die may have been in the form of a plurality of waste pucks.)

Second, with regard to the injection process method for molding of a given SNF assembly material (or portion thereof) of the present invention, the molded outputted product, i.e., the casting (ingot), may be substantially (mostly) free of void spaces within the SNF assembly material (or portion thereof) and as such the casting (or ingot) may be configured to withstand (i.e., without significant collapsing, deforming, and/or imploding) high exterior pressures and/or loads being placed upon the casting (ingot), such as, those that may be found within some wellbores and the deep geological disposal formations. Third, with regard to the injection process method for molding of a given SNF assembly material (or portion thereof) of the present invention, the molded outputted product, i.e., the casting (ingot) may be configured for significant neutron absorbing characteristics due to the presence of neutron absorbing material(s) being located within the former void spaces of the SNF assembly (or portions thereof), as well as, the presence of neutron absorbing material(s) being located around the exterior of the SNF assembly material (or portions thereof). Fourth, with regard to the injection process for molding (die casting) of a given SNF assembly material (or portion thereof) of the present invention, compared with the traditional (prior art) encapsulation methods, the new outputted castings (ingots) may be in a state or substantially close to being in a state to function and/or operate as an end-product disposal capsule that is configured to be inserted into a wellbore system for final disposal. Fifth, with regard to the injection mold process method for diecast molding of molten alloys of the present invention, the diecast outputted end product, i.e., the casting (ingot), may be easily and/or readily handled, moved around, and/or transported; and easily and/or readily sequestered into available capsule transport and container systems without much reimagining and repurposing of current equipment.

At least some embodiments of the present invention may describe devices, apparatus, systems, methods, processes, steps, and/or the like for the modification and management of HLW nuclear waste, such as but not limited to SNF assemblies, which may then be sequestered (inserted) into deeply located geological repositories for final disposal (below water tables and entirely isolated from the ecosphere).

Additionally, at least some embodiments of the present invention may focus on satisfying a need to prepare the SNF assemblies (or portions thereof) for deep geological disposal in a manner that is safe, relatively cost-effective, timely (quick), and allows for maximal disposal of radioactive waste materials.

At least some embodiments of the present invention may focus on mechanically modifying the SNF assemblies (or portions thereof) and then implementing the modified waste form inside cylindrical waste capsule systems that are configured to receive the modified waste. This modified waste form may be mechanically derived from existing SNF assembly material (or portions thereof) by utilizing the high-pressure injection of molten metal(s) and/or alloy(s) into and around a given SNF assembly material (or portion thereof), that is disposed inside pre-designed molds, which allow for creating a fully formed solid SNF “ingot” that is devoid of void spaces.

At least some embodiments of the present invention differ from the prior art SNF management methods by one or more of the following: (1) a mechanical solidification operation on SNF assembly material; (2) producing waste castings (ingots) that are (substantially [mostly]) free of void spaces; (3) producing waste castings (ingots) that are configured to withstand significant (high) external pressures and/or loads because the waste castings (ingots) are (substantially [mostly]) free of void spaces; (4) producing waste castings (ingots) with significant neutron absorbing capabilities due at least in part to the waste castings (ingots) comprising neutron absorbing material(s) located within the former void spaces of the SNF assemblies (or portions thereof); (5) a molding process wherein in this process, the (SNF) waste is shaped and sized into (cylindrical) (structural) member that may be specifically configured to fit within existing (certified) waste capsules; (6) encapsulation and disposal of the converted nuclear waste castings (ingots) into the waste capsules, which may then be emplaced within the deeply located horizontal (lateral) wellbores that may themselves located within deeply located geologic formations.

It is an objective of the present invention to allow the processing and disposal of large volumes (e.g., on the order of thousands of metric tons) of waste (e.g., HLW).

It is another objective of the present invention to allow the processing and disposal of large volumes of waste in a manner that is both safe and effective.

It is another objective of the present invention to allow the processing and disposal of large volumes of waste in a scalable manner.

It is another objective of the present invention to allow the processing and disposal of waste in an exponentially scalable manner.

It is another objective of the present invention to mechanically cut, shred, chip, fragment, and/or the like SNF assemblies or portions thereof, to produce an intermediary waste form that may then be compacted, extruded, and/or shaped into dense waste pucks.

In some embodiments, it may be a requirement of at least one embodiment of the present invention that the disclosed and taught devices, apparatus, systems, methods, steps, and/or the like are capable of protecting the environment (ecosphere) from the deleterious effects of high nuclear waste disposal and waste migration away from the final disposal location.

It is an objective of the present invention to provide devices, apparatus, systems, methods, steps, and/or the like for the long-term disposal of HLW, such as, but not limited to, SNF, in a manner that protects the environment (ecosphere) from the deleterious effects of radiation and radioactive waste migration away from the final disposal location in a manner that is significantly better as compared against prior art systems.

It is another objective of the present invention to allow the processing and disposing of large volumes (e.g., on the order of thousands of metric tons) of waste (such as, but not limited to, HLW, SNF, portions thereof, combinations thereof, and/or the like) in relatively short periods of time as compared against prior art systems.

It is another objective of the present invention to allow the processing and disposal of large volumes of waste (such as, but not limited to, HLW, SNF, portions thereof, combinations thereof, and/or the like) in a manner that is safe, timely, effective, cost-effective, robust, repeatable, scalable, reliable, portions thereof, combinations thereof, and/or the like as compared against prior art systems.

It is another objective of the present invention to allow the processing and disposal of large volumes of waste (such as, but not limited to, HLW, SNF, portions thereof, combinations thereof, and/or the like) in a manner that may be scalable to thousands of cycles per die (mold) and/or high pressure die casting machine (press).

It is another objective of the present invention to modify SNF assembly material (or portions thereof) by injecting molten (liquid) metal(s) and/or alloy(s) into the void spaces of the SNF assembly material (or portions thereof) and around the exteriors of the SNF assembly material (or portions thereof) to form waste castings (or waste ingots).

It is another objective of the present invention to generate waste castings (or waste ingots) that are (substantially [mostly]) free of internal void spaces within the SNF assembly material (or portions thereof) that are within the waste castings (or waste ingots).

It is another objective of the present invention to generate waste castings (or waste ingots) that are configured to have significant neutron-absorbing capabilities by at least having neutron-absorbing material(s) placed within the former void spaces of the SNF assemblies (or portions thereof) that are within the waste castings (or waste ingots).

It is another objective of the present invention to generate waste castings (or waste ingots) that are configured to withstand high (significant) external pressures and/or loads by filling the former void spaces of the SNF assemblies (or portions thereof) that are within the waste castings (or waste ingots) with the resolidified metal(s) and/or alloy(s) from the high pressure, high temperature, molten (liquid) injection die casting process.

It is another objective of the present invention to allow the processing and disposal of waste, such as SNF assembly material, using multiple diecasting injection processing systems in parallel and/or in an assembly line fashion.

It is another objective of the present invention to dispose of waste (such as, but not limited to, HLW, SNF, portions thereof, combinations thereof, and/or the like) within deeply located horizontal (lateral) wellbores (note such a horizontal wellbore may be referred to as a SuperLAT); wherein at least a portion of the given horizontal wellbore may be located within a given deeply located geologic formation.

It is another objective of the present invention to dispose of waste, in different or multiple waste forms, within deeply located horizontal (lateral) wellbores.

It is another objective of the present invention to provide novel means of modifying SNF assemblies to allow for disposal efficiently, timely, economically, and safely for final placement into cylindrical wellbore repositories.

It is another objective of the present invention to provide novel means of modifying SNF assemblies to minimize the effects of corrosion of the SNF material while in the disposal repository by completely protecting the parts of the SNF assembly both internally and externally by the corrosion-protective solidified alloy.

It is another objective of the present invention to allow the prepared waste material to be easily disposed of using the geometry of the (existing) cylindrical wellbores without unnecessary experimentation and modifications.

It is another objective of the present invention to significantly reduce costs of SNF assemblies disposal by utilizing available economic means of processing the waste into novel forms for disposal that may be at least partially to mostly automated.

It is another objective of the present invention to provide underground waste storage in deep-closed geological systems, zones, and/or formations (rocks).

It is another objective of the present invention to implement deep geological disposal devices, apparatus, systems, methods, steps, and/or the like for the long-term disposal of HLW/LLW and/or derivatives, such as, but not limited to, spent nuclear fuel (SNF) assemblies into waste capsules and for disposal of solid wastes such as transuranic products or transuranic waste which is now disposed of in shallow near surface salt mines.

It is another objective of the present invention to allow the processing and disposal of large volumes (e.g., on the order of thousands of metric tons) of multiple waste forms waste (e.g., HLW in horizontal wellbores or SuperLAT systems) for disposal underground.

It is another objective of the present invention to dispose of waste within deeply located horizontal wellbores (note such a deeply located horizontal [lateral] wellbore may be referred to as a SuperLAT).

It is another objective of the present invention to significantly reduce the volume of mechanically modified waste to allow for more efficient disposal in horizontal wellbore systems.

It is another objective of the present invention to implement deep geological disposal devices, systems, and/or methods for the long-term disposal of HLW/LLW and/or derivatives, such as, but not limited to, spent nuclear fuel (SNF) assemblies into waste capsules and for disposal of solid LLW products or waste in slurry, powder, or aggregate forms.

It is yet another objective of the present invention to implement a fissile criticality analysis (FCA) prior to making a given waste capsule, filling a given waste capsule with nuclear (radioactive) waste, and/or emplacing a given waste capsule with the nuclear (radioactive) waste within a given deeply located geological repository, to ensure no critical (nuclear) reactions occur in the nuclear (radioactive) waste material during processing, emplacement, and/or residency in the given deeply located geological repository.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale to in order to enhance their clarity and improve understanding of these various elements and embodiments of the invention. Furthermore, elements known to be common and well-understood to those in the industry are not necessarily depicted to provide a clearer view of the various embodiments of the present invention. Some common items may be left off the drawings for clarity and ease of viewing. For example, in some instances, specific devices or apparatuses may not be shown in a given view. Still, it may be obvious to a person of ordinary skill in the relevant arts (technical fields) from the description that any such items may be present and/or used in the given embodiment. Still, it may be obvious to a person of ordinary skill in the relevant arts (technical fields) from the description that these items may be present and/or used in the given embodiment.

FIG. 1A is prior art and shows a Canadian model CANDU of a nuclear fuel assembly.

FIG. 1B is prior art and shows a Russian nuclear fuel assembly.

FIG. 1C is prior art and shows U.S. nuclear fuel assemblies.

FIG. 2A is prior art and depicts a flow chart of an existing prior art method of reprocessing SNF in which the SNF assemblies are chipped and chemically processed to separate and retrieve the radioactive fissile materials from the structural elements of the SNF assemblies.

FIG. 2B depicts a two-dimensional (2D) schematic of a prior art chipper system, which illustrates the type of chipping operation at the SELLAFIELD United Kingdom (U.K.) reprocessing plant for SNF assemblies.

FIG. 2C depicts a 2D schematic of a prior art chipper system, which illustrates the type of chipping operation at the ORANO reprocessing facility for SNF assemblies operating in France.

FIG. 3A may depict an isometric schematic of one type of industrial compactor machine that illustrates a type of machine capable of compacting outputs from chipper operations into more dense compacted discs, plugs, or pucks.

FIG. 3B may depict a schematic of another industrial compactor machine that may operate on compaction and extrusion principles such that the compacted material is sequentially extruded to form cylindrical discs, plugs, or pucks of compacted waste material (continuously). Sometimes, such combination compaction and extruder machines may form “bricks” or briquettes geometries as the outputs from the fed inputs.

FIG. 3C may depict a schematic of another type of industrial compactor machine that may operate with a hopper to collect the waste material and a feeder system to allow the collected waste (in the hopper) to be fed to the compactor systems of the industrial compactor machine on demand.

FIG. 3D shows a schematic lengthwise cross-section through of a given waste container with the chipped nuclear waste inside.

FIG. 3E shows a schematic lengthwise cross-section through a waste container with the chipped nuclear waste inside of that waste container, wherein the chipped nuclear waste materials may be compressed or compacted by the structural elements which provide compression, compaction, and/or extrusion.

FIG. 3F may depict a flow chart of at least one step in a novel method of disposing of SNF in which the SNF assemblies are mechanically modified, loaded in waste capsules, and then disposed of in deeply located horizontal wellbores.

FIG. 4A is a perspective view showing a general diecast and/or injection molding system for generating (producing and/or outputting) specialized “ingots,” wherein a given ingot may comprise at least one SNF assembly material or portion thereof within that given ingot.

FIG. 4B depicts a two-dimensional (2D) schematic lengthwise cross-sectional view of a generalized diecast system, such as, but not limited to the system of FIG. 4A, used for generating (producing and/or outputting) the specialized ingots, wherein the given ingot may comprise at least one SNF assembly material or portion thereof within that given ingot.

FIG. 4C may depict a 2D schematic isolated cross-section close-up of an injection system and a pressure system for pushing (forcing) a liquid (molten) fluid medium into a closed die (mold) from a molten reservoir that holds the liquid (molten) fluid medium.

FIG. 5A may depict a schematic lengthwise cross-section of a completed waste casting (waste ingot) after the diecasting formation process and illustrating the plurality of waste pucks located entirely within that completed waste casting (waste ingot).

FIG. 5B may depict a representational transverse width cross-section of a completed composite waste casting (waste ingot) after the diecasting formation process, showing the resolidified metal(s) and/or alloy(s) surrounding and completely enclosing the plurality of waste pucks located therein.

FIG. 5C is a partial exterior perspective view showing exterior surfaces of a portion of a completed composite waste casting (waste ingot) after the diecasting formation process.

FIG. 6 may depict a schematic lengthwise cross-sectional view of encapsulated waste castings (waste ingots) implemented inside of a disposal waste capsule, wherein the disposal capsule may be configured for emplacement within a given deep wellbore (SuperLAT) disposal system.

FIG. 7 may show a section, in cross-section, of a deep wellbore (SuperLAT) system that is configured to receive disposal waste capsules (with waste ingots located inside of the disposal capsules) within the wellbore(s).

FIG. 8A may depict a flow chart of at least some steps in a novel method of forming waste castings (waste ingots), that may entirely contain waste pucks (of SNF assembly materials), using high pressure, high temperature, molten metal injection diecasting machinery and/or equipment.

FIG. 8B is a flowchart that depicts an embodiment of some steps in a novel method of forming waste castings (waste ingots), that may entirely contain waste pucks (of SNF assembly materials), using high pressure, high temperature, molten metal injection diecasting machinery and/or equipment.

FIG. 9 may depict a waste disposal repository system in which waste capsules (with ingots containing pluralities of waste pucks) are sequestered in horizontal wellbore(s), wherein the horizontal wellbore(s) are located within deeply located geological formation(s) (wherein a waste disposal repository system that uses such horizontal wellbore(s) that are located within deeply located geological formation(s) may be referred to as a SuperLAT deep disposal system).

### REFERENCE NUMERAL SCHEDULE

With regard to the reference numerals used herein, the following numbering is used throughout the various drawing figures.
101 prior art Canadian nuclear fuel assembly 101
102 prior art Russian nuclear fuel assembly 102
103 prior art U.S. nuclear fuel assemblies 103
200 prior art method of reprocessing SNF assemblies 200
201 step of collecting SNF assemblies 201
202 step of chipping SNF assemblies into radioactive and non-radioactive chips 202
203 step of treating radioactive chips with nitric acid 203
204 step of chemical processing of radioactive nitric acid solution 204
205 step of reusing radioactive elements for fuel 205
206 step of collect undissolved non-radioactive metal parts 206
207 step of dispose of non-radioactive metal parts 207
208 step of placing non-radioactive metal parts in landfills or recycling 208
210 SNF assembly 210
211 U.K. prior art chipper system for SNF assemblies 211
212 pusher for SNF 212
214 cutting means (blade or guillotine) 214
220 container (collector for chipped SNF material) 220
250 French prior art chipper system 250
260 guide (for SNF assembly movement and positioning) 260
299 chipped SNF material (output from chipper machine) 299
300 industrial high-capacity compactor machine/system 300
301 waste puck (disc or plug) 301
302 hydraulic subassembly of compactor/extruder 302
303 container (for chipped SNF material) 303
304 extruder type compactor machine 304
305 subassembly 305
306 extruder subassembly 306
307 plurality of waste plugs 307
308 industrial high-capacity compactor machine/system 308
309 feeder (conveyor) 309
310 waste feed hopper 310
311 compactor system 311
312 compactor controller 312
313 container (for collected chips) 313
314 compactor rod (arm) and piston subassembly 314
315 compactor cylinder wall 315
320 method of mechanical processing of SNF assemblies 320
321 step of collecting SNF assemblies and/or transporting SNF assemblies to processing site(s) 321
322 step of chipping operations of SNF assemblies 322
323 step of selecting mechanical processing means 323
324 step of collecting chipped material, along with neutron absorbent material and preparing for compaction 324
325 step of performing fissile criticality analysis (FCA) 325
326 step of compacting chips forming waste plug(s) 326
327 step of mixing neutron absorber(s) with chipped waste 327
328 step of collecting waste plugs 328
329 step of transporting/sending waste plugs for diecast processing 329
400 diecasting system for producing ingots of waste pucks 400
401 diecasting machine (press) 401
403 die (mold) 403
405 injection system 405
407 melt furnace/reservoir 407
409 molten/liquid metal(s) and/or alloy(s) (molten composition or medium) 409
410 ladle 410
411 flow port 411
413 injection port 413
415 pressure means 415
417 ram 417
419 pusher/arm 419
421 neutron absorber reservoir 421
423 port for neutron absorber 423
425 gas cylinder 425
427 robotic handler 427
429 cooling bath 429
431 controller 431
433 volume in die (mold) 433
435 release agent 435
437 outlet port (connector tube) 437
439 outlet reservoir 439
441 support 441
500 ingot or casting (with SNF assembly [or portion thereof]) 500
501 exterior surface (of ingot/casting) 501
503 minimum thickness of ingot to waste pucks 503
507 modified plurality of waste pucks 507
600 waste disposal capsule 600
601 common central axis 601
603 plate (for neutron absorption) 603
605 metal tube (pipe) 605
607 pipe coupling 607
609 sleeve (for neutron absorption) 609
611 support (standoff) 611
700 waste disposal system using deeply located wellbore(s) 700
701 string (of connected waste capsules) 701
703 wellbore 703
705 deeply located geologic formation 705
800 method of processing waste pucks for disposal 800
801 step of collecting and/or selecting waste pucks (and/or other waste forms) 801
803 step of calculating free void space of SNF assembly (or of other waste forms) 803
805 step of selecting metal(s) and/or alloy(s) 805
807 step of calculating volume of metal(s) and/or alloy(s) for diecasting injection 807
809 step of performing criticality analysis (FCA) on planned ingot with waste 809
811 step of melting metal(s) and/or alloy(s) 811
813 step of collecting & maintaining melted volume of metal(s) and/or alloy(s) 813
815 step of feeding injector with melted metal(s) and/or alloy(s) 815
816 step of feeding neutron absorber to melted metal(s) and/or alloy(s) 816
817 step of building die (mold) 817
819 step of inserting waste material (e.g., waste pucks) into die (mold) 819
821 step of adding release agent(s) onto die (mold) surfaces 821
823 step of injecting (purging) (inert) gas into loaded & closed die (mold) 823
825 step of injecting melted metal(s) and/or alloy(s) into loaded & closed die (mold) 825
827 step of cooling and/or removing ingot (casting) from die (mold) 827
829 step of passivating ingot (casting) 829
831 step of loading ingots into waste capsules 831
833 step of inserting loaded waste capsules into wellbore(s) within deep geological formation(s) 833
835 step of building (constructing) wellbore(s) system(s) 835
837 step of sealing (closing) (loaded) wellbore(s) system(s) 837
900 waste disposal system using deeply located horizontal wellbore(s) 900
901 horizontal (lateral) wellbore(s) 901
903 vertical wellbore(s) 903
905 terrestrial (Earth) surface 905
907 drilling rig 907
911 nuclear power generation reactor plant 911
913 infrastructure building or structure 913
915 (sealing/closing) plug 915

### DETAILED DESCRIPTION OF THE INVENTION

In this patent application, the term “HLW” refers to high-level nuclear waste, which is radioactive. In this patent application, the term “SNF” refers to spent nuclear fuel and is a type of HLW. In this patent application, the terms “HLW” and “SNF” may be used interchangeably.

In this patent application, the terms “chip,” “chipped,” “fragment,” “cut-up,” and/or “shred” may be used interchangeably to refer portions of (nuclear) waste that are the outputs from mechanical modification means that have cut, chopped, fragmented, ground, and/or the like (nuclear) waste (e.g., SNF assemblies) into smaller (solid) pieces.

In this patent application, the terms “pucks,” “plugs,” and “discs” may be used interchangeably and refer to three-dimensional (3D) (cylindrical) elements (members) formed by compression, compaction, and/or by extrusion the chip waste into further smaller and/or denser members. That is, waste pucks comprise chipped SNF materials. Whereas, wellbore closure plugs are entirely different, for sealing up a given wellbore and are not to be confused with waste plugs.

In this patent application, the terms “die,” “mold,” “die-cavity,” may be used interchangeably to refer to a three-dimensional (3D) (enclosed) volume in which the SNF assembly materials (waste pucks) resides internally and into which the melted alloy is injected.

In this patent application, the term “ingot” or waste ingot may refer to the solid three-dimensional (3D) generally cylindrical element (member) formed by the high-pressure injection diecasting of a metal and/or alloy melt (with or without neutron absorber additives) into the mold (die) in which a plurality of waste pucks had been placed, wherein the waste pucks are derived from chipped and compacted HLW, such as, but not limited to, SNF.

In this patent application, the terms “capsule,” “carrier tube,” and “canister” may be used interchangeably with the same meaning referring to a (waste or disposal) capsule that is configured to house, hold, and/or retain (nuclear and/or radioactive) waste therein, such as, but not limited to, nuclear waste, radioactive waste, HLW, SNF, SNF assemblies, waste pucks, ingots, portions thereof, combinations thereof, and/or the like.

In this patent application, the terms “wellbore” and “borehole” may be used interchangeably. Note, unless “wellbore” is prefaced with “vertical,” “horizontal,” or “lateral,” then use of “wellbore” alone may refer to a vertical wellbore, a horizontal wellbore, and/or a lateral wellbore.

In this patent application, “lateral” and “horizontal” may be used interchangeably. A vertical wellbore may be a wellbore whose length is at least substantially (mostly) parallel with a local (proximate) gravitational vector of the Earth that coincides with that vertical wellbore. And a horizontal (lateral) wellbore has a length that is at least substantially (mostly) orthogonal (perpendicular) to that vertical wellbore.

In this patent application, the terms “tube,” “cylinder,” and “pipe” may be used interchangeably to refer to cylindrical elements implemented in the design and/or installation processes of some embodiments of the present invention.

In some embodiments, the use of appropriate personal protective equipment, appropriate protective equipment for machinery, and/or appropriate practices (protocols) with respect to ionizing radiation, radioactive materials, and/or radioactive contamination may be contemplated, implemented, and/or used. In some embodiments, any dangerous waste material may be remotely handled, appropriately safeguarded, and/or handled and/or transported under (U.S. federally) licensed means to protect workers.

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

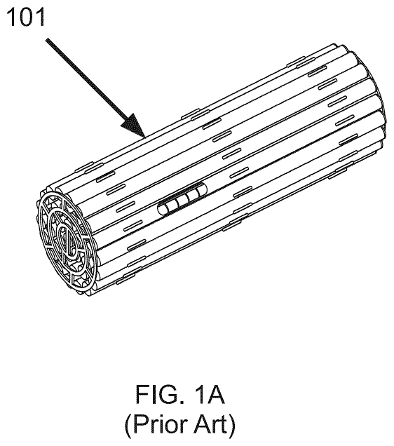

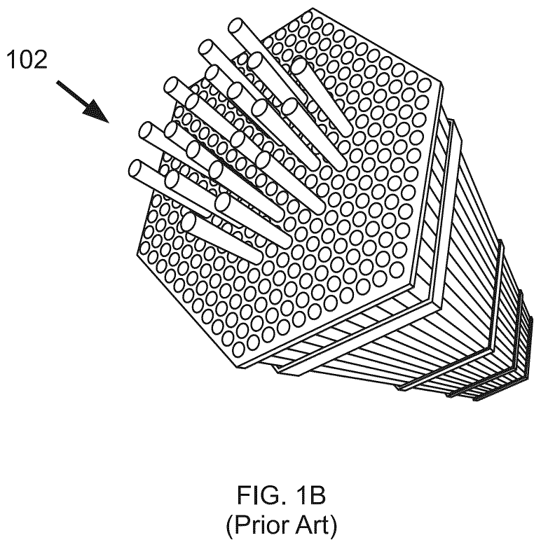

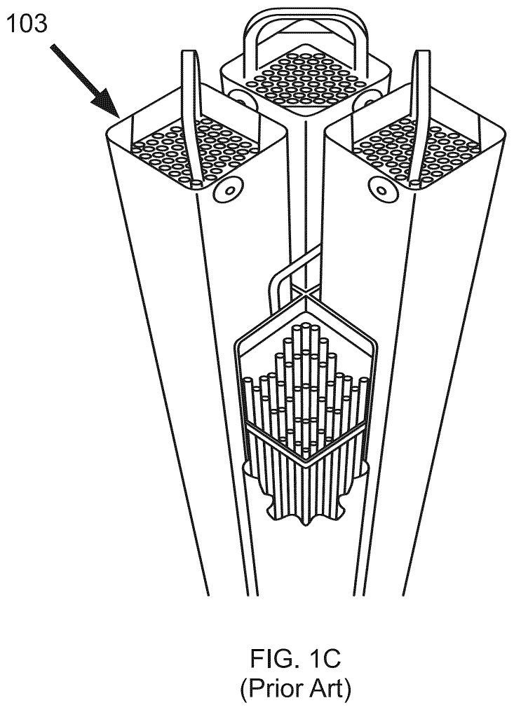

FIG. 1A, FIG. 1B, and FIG. 1C may collectively illustrate three (3) different types of prior art preexisting and current nuclear fuel assemblies 101, 102, and 103, at least used in Canada, Russia, and the U.S., respectively. These nuclear fuel assemblies 101, 102, and 103 vary in size and shape in actual practice and have been specifically designed to optimize performance during power generation. Some nominal dimensions of these types of nuclear fuel rod assemblies 101, 102, and 103 may be as follows: (a) square or rectilinear fuel rod assemblies 103 are usually between four (4) meters (m) to five (5) meters in length and about fourteen (14) centimeters (cm) to twenty-two (22) cm in cross-section; and (b) nominal dimensions of the circular fuel rod assemblies 101 are about fifty (50) cm long and about ten (10) cm in cross-section. In any event, as these nuclear fuel assemblies 101, 102, and/or 103, are prior art and existing, the precise dimensions and geometries are known in the industry.

Note, various embodiments of the present invention may act upon nuclear fuel assemblies 101, 102, 103 and/or the like, when they are SNF, for long-term disposal of such SNF.

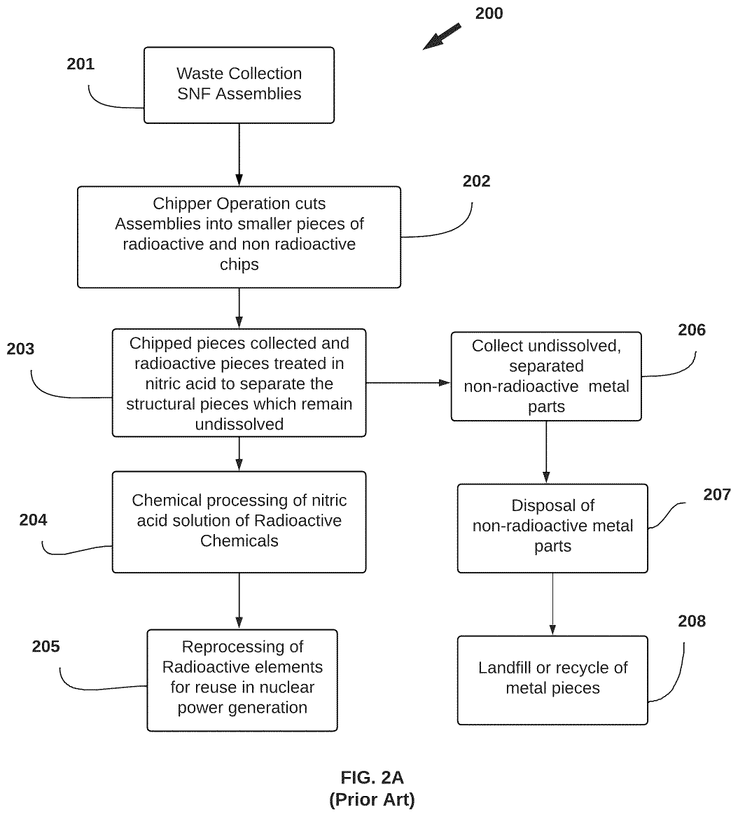

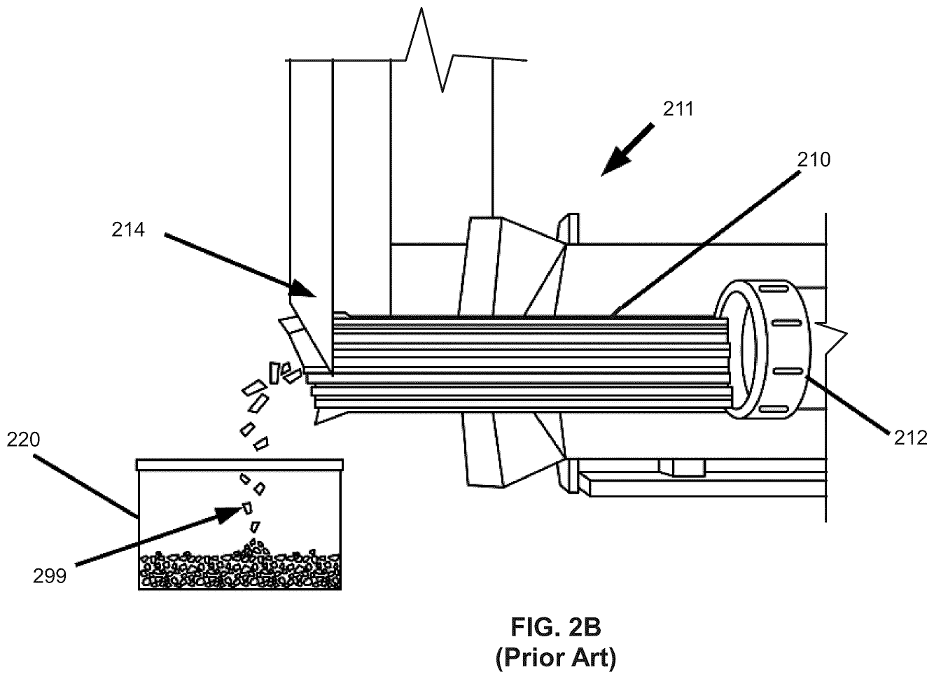

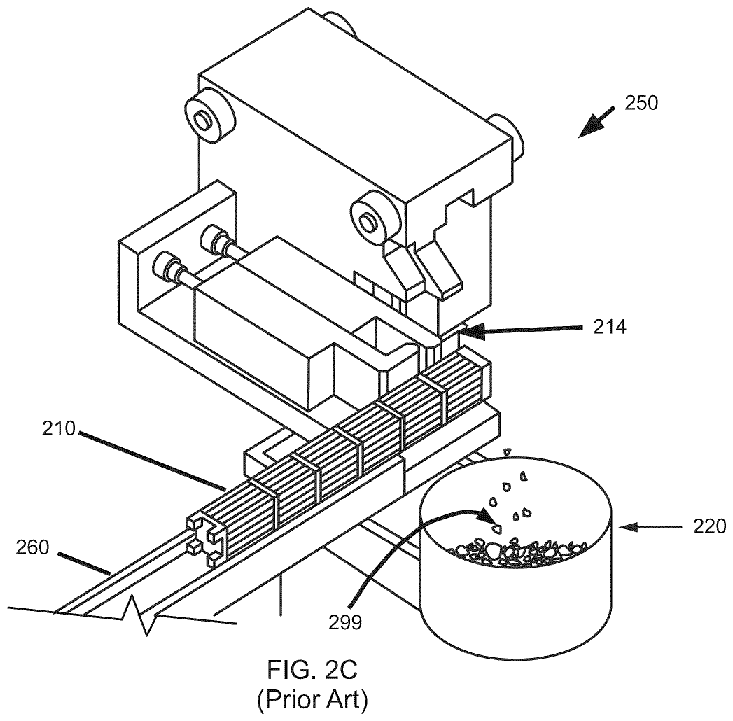

FIG. 2A depicts steps in a prior art method 200 of reprocessing SNF assemblies (such as, SNF assemblies 101, 102, and/or 103) for a goal of recovering and/or providing usable fissile HLW nuclear materials to be reused as nuclear fuel in nuclear power generating reactors. Such SNF assemblies reprocessing has been used in the U.K. and in France, see e.g., FIG. 2B and FIG. 2C, respectively. Method 200 includes steps of step 201, step 202, step 203, step 204, step 205, step 206, step 207 and step 208. Step 201 is a step of collecting SNF assemblies (such as, SNF assemblies 101, 102, 103, and/or the like) for use in method 200. These SNF assemblies are generally found in temporary storage in cooling ponds or in surface storage in dry cask containers. After execution of step 201, method 200 progresses to step 202. Step 202 is a step of chipping and/or cutting up the collected SNF assemblies into chips or fragments. In step 202, the SNF assemblies are mechanically fragmented into smaller particulate matter, denoted herein as, chipped SNF material 299. In the prior art, this step 202 fragmentation process is done by a chipper, cutter, saw, or other similar means of cutting the SNF assemblies into smaller components. At the end of step 202, the outputted material is chipped SNF material 299. After the execution of step 202, method 200 progresses to step 203.

Continuing discussing FIG. 2A, step 203 is a step of treating the chipped materials 299 output from step 202 with nitric acid to separate the nuclear fuel materials from the structural (metal) elements of the SNF assemblies that have been cutup and/or chipped. In step 203, the SNF assembly particulate material, the chipped SNF material 299, is chemically treated in nitric acid to dissolve the radioactive materials, which leaves the residual non-radioactive (metal) pieces as non-dissolved. The nitric acid treatment will dissolve the nuclear fuel materials and will leave the structural (metal) elements of the SNF assemblies that have been cutup and/or chipped as undissolved and thus the undissolved structural elements of the SNF assemblies that have been cutup and/or chipped are separated from the nitric acid solution with the dissolved the nuclear fuel materials. After execution of step 203, method 200 progresses to step 204 and to step 206.

Continuing discussing FIG. 2A, step 204 is a step of chemical processing nitric acid solution output from step 203 to obtain the target goal of the fissile radioactive fuel products. Step 204 is an expensive, complex chemical treating operation in which the output from step 203 is chemically treated to separate and produce the reusable fissile radioactive materials. Step 204 is usually done under extremely safe, highly controlled, remote operational conditions, and it is also a very costly process. The costs of reprocessing the fissile material have been quoted at six times (6X) the cost of sourcing the material from natural mining resources. The complexity and high costs of the prior art methods, such as method 200, are significant reasons that mandate that better, less complicated, inexpensive means of waste processing are required to allow the nuclear power industry to improve and become more productive overall and less cost prohibitive. The current patent application may address this current cost issue. After execution of step 204, method 200 progresses to step 205. Step 205 is a step of reprocessing the radioactive products outputted from step 204 for reuse in power generation from nuclear power generators/reactors. Step 205 may be a processing step in which the now recycled radioactive products and fissile elements are remade into the required forms (e.g., pellets) for re-use in nuclear power generation.

Continuing discussing FIG. 2A, step 206 is a step of collecting the undissolved assembly structural elements from the step 203. Step 206 may be a relatively simple separation and collection process in which the non-radioactive and former structural fragments of the original waste, chipped SNF material 299, are collected. After execution of step 206, method 200 progresses to step 207. Step 207 may be a disposal step of the undissolved assembly structural elements that were collected from step 206. Step 207 may lead to step 208, which is a step of landfilling or recycling the undissolved assembly structural elements that were collected from step 206. See e.g., FIG. 2A for prior art method 200.

FIG. 2B illustrates a prior art process practiced by the SELLAFIELD company in the United Kingdom (U.K.) for reprocessing of SNF assemblies 210 in which the SNF assemblies 210 that have been removed from cooling ponds (at the nuclear power plants or from other [surface] storage systems) are chipped by a chipper machine 211 into chipped SNF material 299. In this chipping operation depicted in FIG. 2B, a pusher mechanism 212 may force the SNF assembly 220 forward linearly into a guillotine 214 or the like cutting means, which vertically chips or cuts the SNF assembly 210 into prescribed length pieces of chipped SNF material 299. The chipped SNF material 299 is collected in container 220.

FIG. 2C illustrates a prior art process practiced by the ORANO company in France for reprocessing SNF assemblies 210. The SNF assemblies 210 removed from the cooling ponds (at the nuclear power plants or other [surface] storage systems) are fragmented by a chipper machine 250. In this operation depicted in FIG. 2C, a guide mechanism 260 allows the SNF assembly 210 to move forward linearly to a guillotine 214 or the like cutting means, which cuts the SNF assembly 210 into prescribed length pieces of chipped SNF material 299. The chipped SNF material 299 is collected in container 220. In practice, the chipping of the SNF assemblies 210 may take place under circulating water or a fluid stream.

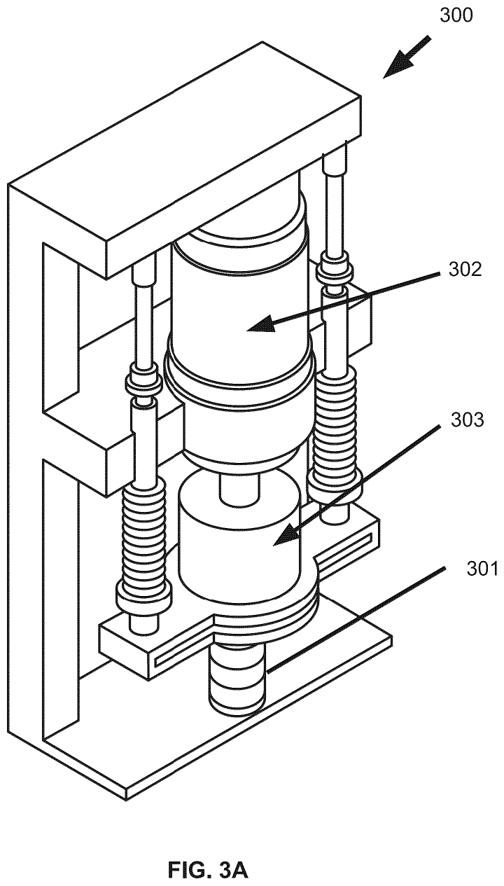

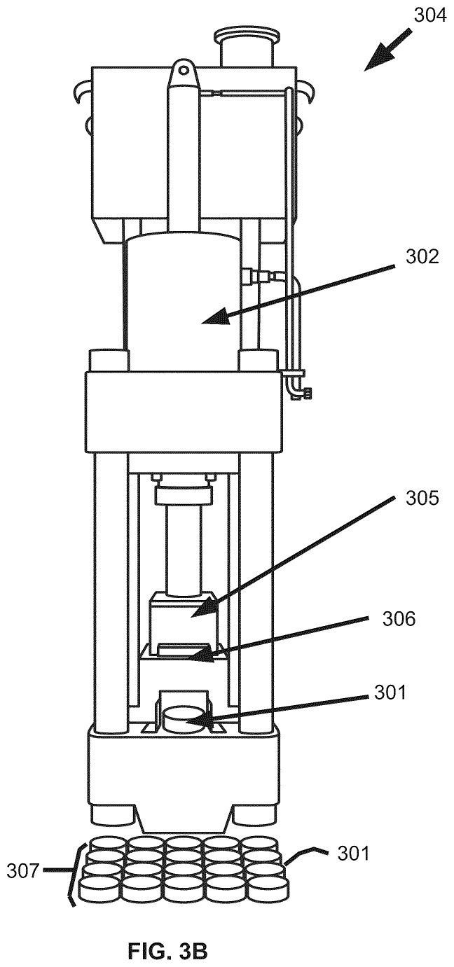

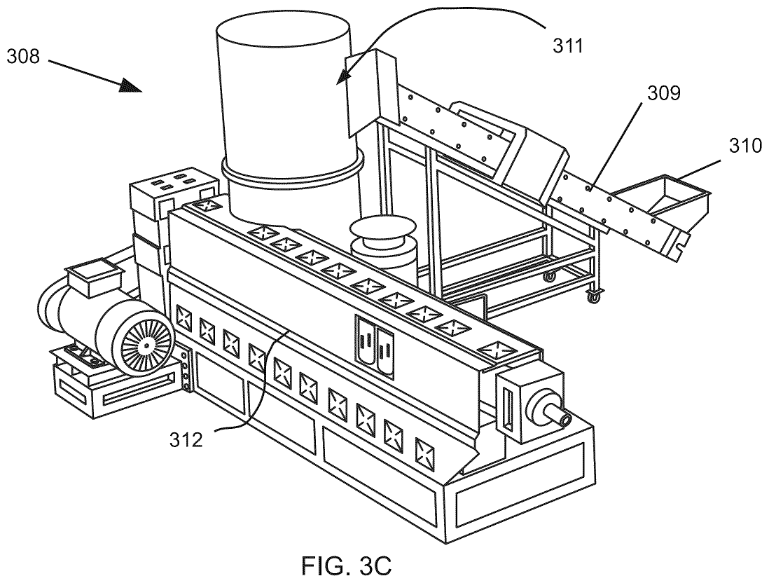

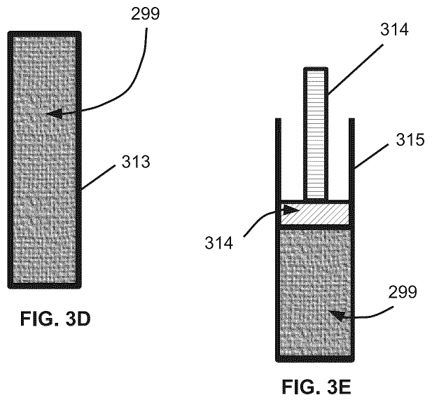

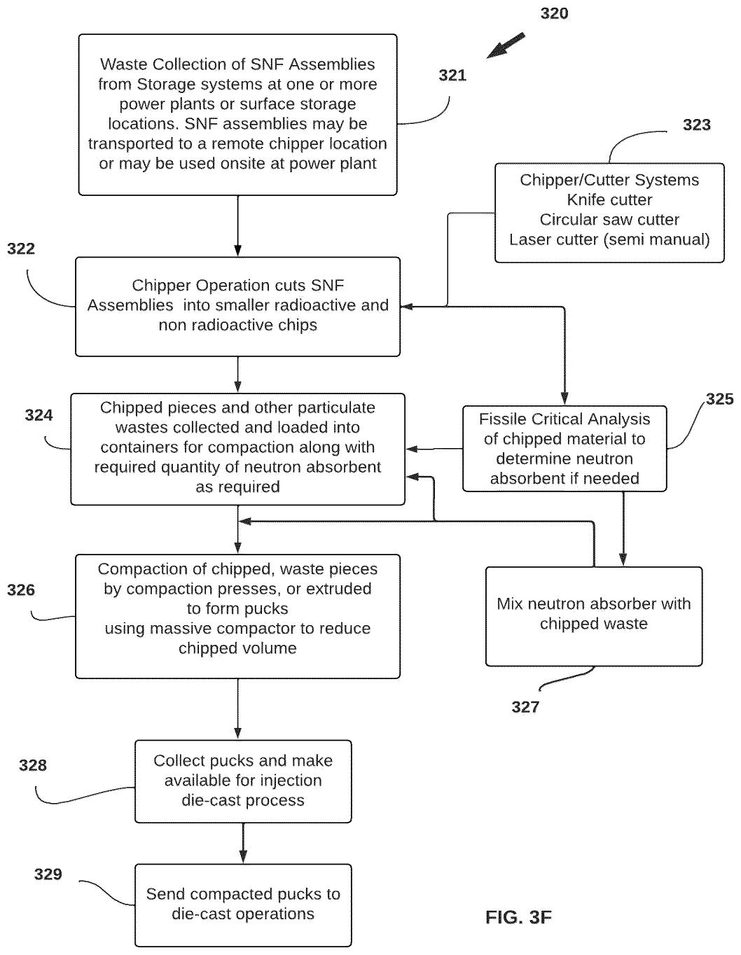

FIG. 3A may depict an isometric schematic of one type of industrial compactor system and/or machine 300 that may be configured for directly compacting the chipped SNF material 299 into compressed, compacted, and/or extruded denser flattened pucks 301 (or discs or plugs 301). In some embodiments, reference numeral “302” may represents a hydraulic system and its accessory (collateral) features (components), of industrial compactor system and/or machine 300, that generate the necessary compression, compacting, clamping, and/or extrusion forces to compress, compact, and/or extrude the chipped SNF material 299 into waste pucks 301. In some embodiments, waste pucks 301 may be denser, more compacted, more compressed, and/or intentionally shaped (e.g., as a cylindrical disc member) as compared to the chipped SNF material 299. In some embodiments, in FIG. 3A, container (cylinder) 303 encloses the feed stock material of chipped SNF material 299, which is then compressed, compacted, and/or extruded by the hydraulic subassembly of compactor/extruder 302, into the desired compression level of waste pucks 301. In some embodiments, with respect to industrial compactor system and/or machine 300, chipped SNF material 299 may be the feed input into industrial compactor system and/or machine 300, and waste pucks 301 may be the output from industrial compactor system and/or machine 300 operations. In some embodiments, industrial compactor system and/or machine 300 may comprise hydraulic subassembly of compactor/extruder 302 and/or container (cylinder) 303. In some embodiments, inputs to compactor machine 300 may be chipper waste 299; and outputs of compactor machine 300 may be waste pucks 301 and/or a plurality of waste pucks 307 (see e.g., FIG. 3B for use of reference numeral “307” for plurality of waste pucks 307, although a plurality of pucks 307 is shown, but not called out, in FIG. 3A).

FIG. 3B may depict an isometric schematic of one type of industrial compactor system and/or machine 304 that may be configured for directly compacting the chipped SNF material 299 into compressed, compacted, and/or extruded denser flattened waste pucks 301 (discs or plugs 301); and, at a same time, on-demand, sequentially extruding the compacted dense waste into flattened waste pucks 301. The system/machine 304 depicted in FIG. 3B may continuously feed the chipped SNF material by a feeder system that is not shown in FIG. 3B. This feeder feature addition allows for more efficient and rapid modification of the chipped SNF material 299 feed since the production of waste pucks 301 may run automatically and continuously, as long as the chipped SNF material 299 exists to be modified and not including maintenance downtime.

Continuing discussing FIG. 3B, in some embodiments, reference numeral “302” of FIG. 3B and/or of system/machine 304 may represent a hydraulic system and its accessory (collateral) features (components), of industrial compactor system and/or machine 304, that generates the necessary compression, compacting, clamping, and/or extrusion forces to compress, compact, and/or extrude the chipped SNF material 299 into waste pucks 301. In some embodiments, waste pucks 301 may be denser, more compacted, more compressed, and/or intentionally shaped (e.g., as a cylindrical disc member) as compared to the chipped SNF material 299. In some embodiments, during the operation of extruder-type compactor machine 304, sub-assemblies 305 and 306 may selectively and/or continuously extrude the chipped SNF material 299 into the outputted compressed, compacted, extruded, and/or shaped waste pucks 301 (or in some cases, outputted as bricks or briquettes). In FIG. 3B, the compacted or extruded waste pucks 301 may be collected as a plurality of waste pucks 307. In some embodiments, extruder-type compactor machine 304 may have and/or may comprise an added feeder system, not shown, to continuously load the chipped SNF material 299 into the extruder-type compactor machine 304 assembly. In some embodiments, compactor machine 300, compactor machine 304, combinations thereof, and/or the like may have an applied compressive force capacity of 2,235 metric tons (mt) or more. In some embodiments, compactor machine 300, compactor machine 304, combinations thereof, and/or the like may compress and/or compact the feed material (such as, but not limited to, the chipped SNF material 299) to at least twenty percent (20%) plus or minus (+/−) five percent of (5%) of the original (non-compressed) volume. In some embodiments, inputs to compactor machine 304 may be chipper waste 299; and outputs of compactor machine 304 may be waste pucks 301 and/or a plurality of waste pucks 307.

FIG. 3C may depict a schematic illustration of another type of industrial compactor 308 that may be configured for compacting the chipper waste 299 (chipped SNF material 299). In some embodiments, with respect to industrial compactor 308, a feeder system 309 (e.g., a conveyer, belt conveyor, screw (worm) conveyor, and/or the like) may pull (draw) chipped SNF material 299 from a hopper 310 (or the like), to convey (deliver and/or transport) the chipped SNF material 299 to the compactor systems 311 of industrial compactor 308, which may then be outputted as waste pucks 301. In some embodiments, this industrial compactor 308 may have an integrated and/or connected feeder system 309 which may allow continuous feeding of chipped SNF material 299 to the compactor systems 311 of industrial compactor 308, as long as chipped SNF material 299 may be available and industrial compactor 308 is not down for maintenance. In some embodiments, chipped SNF material 299 may be placed in waste hopper 310 before being moved by the feeder 309 all under the control of a system controller 394 (or the like). In some embodiments, the feeder-hopper system 309/310 may receive chipped SNF material 299 from various shredders/chippers 211 and/or 250 (and/or the like) upstream of industrial compactor 308. In some embodiments, compactor and/or extrusion operations of industrial compactor 308 may be controlled by controller 312. In some embodiments, industrial compactor 308 may comprise one or more of: feeder (conveyor) 309, waste feed hopper 310, compactor system 311, compactor controller 312, combinations thereof, a portion thereof, and/or the like. In some embodiments, inputs to industrial compactor 308 may be chipper waste 299; and outputs of industrial compactor 308 may be waste pucks 301 and/or a plurality of waste pucks 307.

In some embodiments, the features, elements, members, portions thereof, combinations thereof, and/or the like of industrial high-capacity compactor machine/system 300, extruder type compactor machine 304, and/or industrial compactor 308 may be combined. See e.g., FIG. 3A, FIG. 3B, and FIG. 3C.

FIG. 3D is a lengthwise cross-sectional block diagram of a container 313 configured for collecting and/or (temporarily) holding chipped SNF material 299 produced by the chipping process (such as, but not limited to, chipper machine 211, chipper machine 250, or the like). In some embodiments, container 313 and container 220 may be used interchangeably.

FIG. 3E is a lengthwise cross-sectional block diagram showing the compression and/or compaction processes that may be applied to the chipped SNF material 299. In some embodiments, FIG. 3E may show the compression and/or compaction processes, at least partially occurring within compactor machine(s) 300, 304, 308, and/or the like, as applied to the chipped SNF material 299. FIG. 3E shows a compactor rod (arm) and piston sub assembly 314. In some embodiments, compactor wall 315 may be at least substantially (mostly) cylindrical in shape. During compression and/or compaction operations, compactor rod (arm) subassembly 314 may press the chipped SNF material 299, within compactor walls 315, resulting in compression, compaction, and/or shaping of the chipped SNF material 299 into an output of the waste puck(s) 301. In some embodiments, before and/or during compression and/or compaction operations, at least some (predetermined) quantity of the chipped SNF material 299 may be disposed between compactor piston (ram) 314 and interior surfaces of compactor walls 315. The compactor rod (arm) and the compactor piston (ram) of the compactor rod (arm) subassembly 314, and the compactor walls 315 may be more rigid and/or structurally stronger than the chipped SNF material 299. The compactor rod (arm) and the compactor piston (ram) of the compactor rod (arm) subassembly 314, and the compactor walls 315 may together generate sufficient compressive loads to compress and/or compact the chipped SNF material 299 into waste puck(s) 301. The compactor walls 315 are sturdy enough to resist the compressive loads of the compactor rod (arm) and the compactor piston (ram) of the compactor rod (arm) subassembly 314.

In some embodiments, the compactor rod (arm) and the compactor piston (ram) subassembly 314, and/or compactor walls 315 may be components and/or portions of hydraulic subassembly of compactor/extruder 302, container 303, subassembly 305, extruder subassembly 306, combinations thereof, a portion thereof, and/or the like. See e.g., FIG. 3E, FIG. 3A, and FIG. 3B.

FIG. 3F may depict a flowchart of at least some steps in a method 320. In some embodiments, method 320 may represent a method of mechanically processing SNF assemblies (such as, but not limited to, SNF assemblies 101, 102, and/or 103) for eventual long-term disposing of the processed SNF assemblies in long horizontal wellbores that are implemented in deeply located geological repositories. In some embodiments, method 320 may show at least some of operations or at least some of steps involved in mechanical fragmentation, compression, compaction, extrusion, and/or shaping of the nuclear waste material (e.g., SNF assemblies or portions thereof) for subsequent disposal within long horizontal wellbores that are implemented in deeply located geological repositories. In some embodiments, method 320 may be a method of forming (creating, outputting, making, yielding, combinations thereof, and/or the like) waste pucks 301 (307), from HLW, such as, but not limited to, SNF assemblies (or portions thereof), for eventual long-term disposal in long and deeply located horizontal wellbores that are implemented in deeply located geological repositories. In some embodiments, method 320 may comprise at least one step selected from: step 321, step 322, step 323, step 324, step 325, step 326, step 327, step 328, step 329, combinations thereof, a portion thereof, and/or the like. In some embodiments, one or more of these steps may be: executed out of numerical order, omitted, skipped, and/or optional.

Continuing discussing FIG. 3F, in some embodiments, method 320 may begin with step 321. In some embodiments, step 321 may be a step of collecting SNF assemblies (such as, but not limited to, SNF assemblies 101, 102, and/or 103) for use in method 320. In some embodiments, these SNF assemblies (such as, but not limited to, SNF assemblies 101, 102, and/or 103) may be found in temporary storage in (surface) cooling ponds and/or in surface (or near surface) storage in dry cask containers. In some embodiments, execution of step 321 (and/or of any step of method 320) may be done physically onsite at a given nuclear power plant (with cooling ponds) in a specialized area of the grounds of that given nuclear power plant. In some embodiments, the collected SNF assemblies (such as, but not limited to, the SNF assemblies 101, 102, and/or 103) may be transported offsite from the temporary storage locations (e.g., cooling ponds and/or dry cask containers) to remote and/or different site(s) for further operations of method 320. In some embodiments, step 321 may be a step of locating and/or identifying the SNF assemblies (such as, but not limited to, SNF assemblies 101, 102, and/or 103) from multiple (different) nuclear power plant sites, cooling ponds' locations, dry cask containers' locations, combinations thereof, a portion thereof, and/or the like. In this type of multi-plant/multi-location operation, step 321 may be a means of accumulating and commingling various quantities of the SNF assemblies (such as, but not limited to, SNF assemblies 101, 102, and/or 103) for subsequent mechanical processing at one or more centrally located site(s), according to further steps of method 320. This approach may increase efficiencies and lower operational costs, and personnel needs for disposal of SNF assemblies (such as, but not limited to, SNF assemblies 101, 102, and/or 103). In some embodiments, at least partial completion of step 321 may progress method 320 to step 322.

Continuing discussing FIG. 3F, in some embodiments, step 322 may be a step of mechanically processing at least one of the SNF assemblies (or a portion thereof) collected from step 321. In some embodiments, this mechanical processing may be selected from one or more of: chipping, cutting, shredding, grinding, ripping, tearing, fragmenting, breaking up, combinations thereof, and/or the like, of at least one SNF assembly (or a portion thereof) (such as, but not limited to, SNF assemblies 101, 102, and/or 103). In some embodiments, execution of this step 322 mechanical processing may result in the given SNF assembly (or portion thereof) being transformed into smaller, more manageable pieces of materials, designated, the chipped SNF material 299. In some embodiments, step 322 may be executed under a fluid stream. (In some embodiments, that fluid stream may be collected for processing and/or disposal.) In some embodiments, at least some partial execution of step 322 may progress method 320 to step 324.

Continuing discussing FIG. 3F, in some embodiments, step 323 may feed into step 322. In some embodiments, step 323 may be a step of selecting one or more systems and/or equipment (machine) for executing step 322. In some embodiments, step 323 may be a step of selecting one or more systems and/or equipment (machine) that are configured for implementing the mechanical processing of step 322. In some embodiments, step 323 may be a step of selecting one or more mechanical processing systems and/or mechanical processing equipment (machine) that are configured for implementing the mechanical processing of step 322. In some embodiments, the one or more mechanical processing systems and/or mechanical processing equipment (machine) may be selected from tools, machines, and/or equipment that are configured for one or more of: chipping, cutting, shredding, grinding, ripping, tearing, fragmenting, breaking up, combinations thereof, and/or the like, of SNF assemblies (or a portion thereof) (such as, but not limited to, SNF assemblies 101, 102, and/or 103) into smaller more manageable pieces of materials, designated herein as the chipped SNF material 299. In some embodiments, the one or more mechanical processing systems and/or mechanical processing equipment (machine) may be selected from chipper 211, chipper 250, combinations thereof, and/or the like. In some embodiments, with respect to step 323, these chipper and/or mechanical fragmentation systems may be either single assembly (tool/machine) or a combination of chipper/cutter assemblies, knife cutters, circular saw systems, (semi-manual) laser cutters, laser cutters, torch cutters, plasma cutters, shredders, grinders, industrial machines/systems for reducing size of metal feed stock, portions thereof, combinations thereof, and/or the like. Many of these chipper/cutting systems noted in step 323 are currently available in the industry today and have been used for the SNF assemblies chipping purposes at SELLAFIELD operations in the U.K. (see e.g., FIG. 2B) and at the ORANO operations in France (see e.g., FIG. 2C).

Continuing discussing FIG. 3F, in some embodiments, chipper machine/system 211, chipper machine/system 250, and/or other options from step 323 and/or the like may be used to execute step 322. In the chipping/cutting process of step 322, chipper and/or the like systems identified in step 323 may be utilized to mechanically break down, fragment, chip, cut, shred, grind, rip, tear, and/or the like of the SNF assemblies (such as, but not limited to, SNF assemblies 101, 102, and/or 103) and its components into smaller pieces of fragments, the chipped SNF material 299, which are required for further mechanical processing (modification) according to this method 320. In some embodiments, at least partial execution of step 322 may progress method 320 to step 324 and/or to step 325.

Continuing discussing FIG. 3F, in some embodiments, step 324 may be a step of collecting the chipped SNF material 299, which may be the outputs from step 322. In some embodiments, the output of step 322, the chipped SNF material 299, may include (comprise) both radioactive and non-radioactive fragments. In some embodiments, the output of step 322, the chipped SNF material 299, may include (comprise) both fragmented radioactive spent nuclear fuel pellets/elements and fragmented non-radioactive structural elements (e.g., metals, steel, and the like) from the given SNF assemblies that were mechanically processed per step 322. In step 324, the collected chipped SNF materials 299, may be loaded into container(s) 313 and/or 220 (or the like) for further mechanical processing (modification, such as, compaction) according to step 326. In some embodiments, at least partial execution of step 324 may progress method 320 to step 326.

Continuing discussing FIG. 3F, in some embodiments, step 325 may be a step of conducting a fissile criticality analysis (FCA). See also step 809 of method 800 for FCA. In some embodiments, execution of step 325 may follow the teachings of step 809. In some embodiments, as a safety precaution, a fissile criticality analysis (FCA) may be desired, required, and/or implemented, to minimize the likelihood of undesired runaway nuclear reactions and/or excessive heating occurring within (or at) one or more of: chipped waste material 299; container(s) 313 and/or 220 of chipped waste material 299; waste pucks 301; container(s) of waste pucks 301; combinations thereof; a portion thereof; and/or the like. In some embodiments, as a safety precaution, a fissile criticality analysis (FCA) may be desired, required, and/or implemented, prior to making one or more of: chipped waste material 299; container(s) 313 and/or 220 of chipped waste material 299; waste pucks 301; container(s) of waste pucks 301; combinations thereof; a portion thereof; and/or the like. In some embodiments, at least partial execution of step 325 (the FCA) may progress method 320 to step 322, step 324, step 326, and/or step 327. In some embodiments, FCA may help to determine safe and appropriate dimensions, density, and/or quantity of: chipped material 299; amount of chipped material 299 in containers 313 and/or 220; waste puck(s) 301; amount of neutron absorber used in a given waste puck 301; type of neutron absorber used in a given waste puck 301; combinations thereof; a portion thereof; and/or the like. In some embodiments, this FCA analysis may provide (yield) upper limits on the weight per unit of material, typically called “gram-limits,” which may be the maximum quantity of fissile material in a given container of chipped waste material 299; of a given waste puck 301; a given plurality of waste pucks 307; a given container of waste pucks 301/307; combinations thereof; a portion thereof; and/or the like. In some embodiments, the required gram limits may be used in all the subsequent waste disposal processes. In addition, the criticality analysis (FCA) may utilize factors such as, physical volumes of waste, material burnup times, time out of the reactor, and other well-known safety metrics to define the final configuration of the waste package (waste capsule). Execution of FCA is well known in the industry and such FCA industry teachings are incorporated by reference as if fully set forth herein. Fissile Critical Analysis (FCA) may be performed by various presently available computer programs, codes, algorithms, models, and/or the like. Some of these may be as follows: SCALE (Standardized Computer Analysis for Licensing Evaluation); MCNP (Monte Carlo N-Particle Transport Code); MONK (Monte Carlo N-Particle Kinetics Code); AMPX (Advanced Multi-group Cross-section Processor); and PARTISN. These are available to researchers and many federal and private agencies alike. In some embodiments, step 325 may occur at the same of different locations as compared to other steps of method 320. In some embodiments, FCA may occur remotely to other steps of method 320.

In some embodiments, different types of nuclear and/or radioactive waste material in particulate form may be processed (modified) by method 320 and/or the teachings of this patent application. In some embodiments, different types of nuclear and/or radioactive waste material in particulate form may be diverse and in one or more of the following forms: SNF assembly (or a portion thereof); the chipped SNF material 299; shredded metal materials; shredded depleted uranium projectile uranium penetrators; particulate waste from (nuclear) weapons programs, such as, but not limited to, granulated activated carbon (GAC) produced at the Hanford, WA, remediation operations; also existing powder material such as uranium oxide powder may be treated and disposed of in the same manner; portions thereof; combinations thereof; and/or the like. In some embodiments, one or more of this diverse set of nuclear and/or radioactive waste materials may be mechanically processed (modified) per method 320 and/or the teachings of this patent application. In some embodiments, if the given nuclear and/or radioactive waste form is relatively large dimensionally, then it may be processed by step 322 before being compacted in step 326. Whereas, in some embodiments, if the given nuclear and/or radioactive waste form is relatively small dimensionally, such as, but not limited to, being in a particulate form, then step 322 may be omitted and it may be processed in step 326 to yield compacted waste pucks 301 and/or 307.

Continuing discussing FIG. 3F, in some embodiments, step 326 may be a step of compressing, compacting, extruding, and/or shaping the chipped SNF material 299 (and/or the other nuclear and/or radioactive waste forms noted above) into the outputted waste pucks 301 and/or 307. In some embodiments, step 326 may be executed, at least in part, by compactor machine(s) 300, 304, 308, combinations thereof, and/or the like. In some embodiments, compactor machine(s) 300, 304, 308, combinations thereof, and/or the like, may generate an applied compressive force capacity of 2,235 metric tons (mt) or more. In some embodiments, compactor machine(s) 300, 304, 308, combinations thereof, and/or the like, may generate an applied compressive force capacity of 2,500 metric tons (mt) or more. In some embodiments, step 326 may be executed according to the teachings of FIG. 3A to FIG. 3F, portions thereof, combinations thereof, and/or the like. In some embodiments, the nuclear and/or radioactive waste feed materials that may be fed into compactor machine 300, 304, 308, combinations thereof, and/or the like, may be selected from one or more of: the chipped SNF material 299; shredded metal materials; shredded depleted uranium projectile uranium penetrators; particulate waste from nuclear weapons programs; uranium oxide powder; with or without neutron absorber(s); portions thereof; combinations thereof; and/or the like. In some embodiments, the nuclear and/or radioactive waste output materials exiting from compactor machine 300, 304, 308, combinations thereof, and/or the like, may be waste pucks 301 and/or 307. In some embodiments, during execution of step 326, the feed material (such as, but not limited to, the chipped SNF material 299) may be compressed and/or compacted to at least twenty percent (20%) plus or minus (+/−) five percent of (5%) of its original (non-compressed) volume. In some embodiments, during execution of step 326, the feed material (such as, but not limited to, the chipped SNF material 299) may compressed and/or compacted to at least thirty percent (30%) plus or minus (+/−) five percent of (5%) of its original (non-compressed) volume. In other embodiments the amount of original volume reduction may be another value (amount) (that may be predetermined). In some embodiments, compactor machine 300, 304, 308 combinations thereof, and/or the like, may be configured to achieve a minimum percentage in original volume reduction of the feed material (e.g., chipped waste material 299). In some embodiments, during execution of step 326, the feed material (such as, but not limited to, the chipped SNF material 299) may be continuously fed into the given compactor machine 300, 304, 308 combinations thereof, and/or the like, by a feeder system. In some embodiments, this feeder feature addition may allow for more efficient and/or rapid preparation (modification) the feed material (such as, but not limited to, the chipped SNF material 299) since production of waste pucks 301 and/or 307 can run almost automatically and continuously, only being limited by availability of the feed material and/or shutdowns for maintenance. In some embodiments, during execution of step 326, a relatively small amount of spray-type binder substance, adhesive product, or the like, may be added to the shredded and/or chipped feed material (such as, but not limited to, the chipped SNF material 299) to allow for better binding and coalescing of the feed material while under compression, compaction, extrusion, and/or shaping. In some embodiments, during execution of step 326, an industrial release agent (e.g., similar to a mold release agent) may be used on interior/inside surfaces of compactor machine 300, 304, 308 combinations thereof, and/or the like, to facilitate and/or improve release and/or ejection of waste pucks 301 and/or 307 after compression, compaction, extrusion, and/or shaping processes are completed. In some embodiments, during execution of step 326, subassembly 305 and/or extruder subassembly 306 of a given compactor machine 304 may be fed the feed material (such as, but not limited to, the chipped SNF material 299) and may selectively and/or (continuously) extrude the waste pucks 301 and/or 307, which depending upon the extrusion ejection nozzle shape may be shaped at least substantially as cylindrical discs, plugs, and/or pucks, or as bricks or briquettes. In some embodiments, outputted waste pucks 301 may be organized and/or collected as plurality of waste pucks 307, which may comprise two or more waste pucks 301. In some embodiments, at least some partial execution of step 326 may progress method 320 to step 328. See also, FIG. 3A to FIG. 3E for figures relevant to compression, compaction, extrusion, and/or shaping operations of the feed material (such as, but not limited to, the chipped SNF material 299).

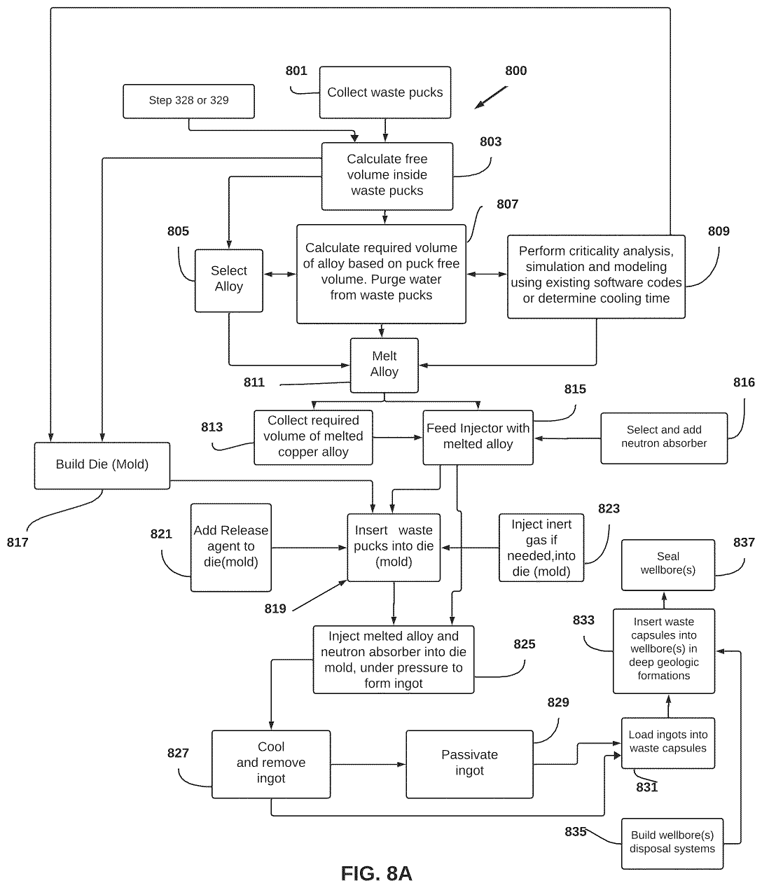

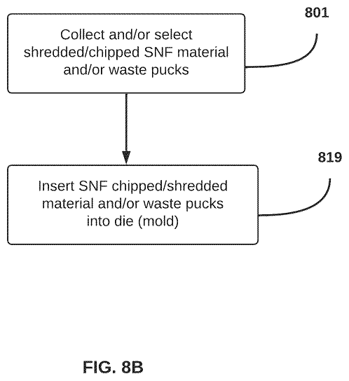

Continuing discussing FIG. 3F, in some embodiments, step 327 may be a step of adding in and/or mixing in one or more neutron absorbers into the chipped waste material 299 that is to be compacted into waste pucks 301 and/or 307. In some embodiments, a desired or a required amount of neutron-absorbing material may be added to the chipped waste material 299. The type and/or the quantity of neutron absorbent may be determined from a fissile criticality analysis (FCA) (see e.g., step 325). In some embodiments, the FCA is a standard type of technical analysis in the nuclear waste industry and is well-established and well-known, with such teachings being incorporated by reference herein. In some embodiments, a specific neutron-absorbing material may be selected from the available sources. In some embodiments, the neutron absorber may be selected from powdered boron carbide. In some embodiments, the powdered boron carbide may be easily and/or readily added, mixed, and/or distributed throughout the chipped waste material 299 of SNF assemblies. In some embodiments, in addition to this step 327 or as an alternative to step 327, a neutron absorber material may be effectively added during the diecast injection process as part of the melted alloy being injected (see e.g., method 800, step 825, and FIG. 8A). In some embodiments, execution of step 327 may occur before execution of step 326. In some embodiments, execution of step 327 may transition method 320 into step 324 and/or into step 326.

Continuing discussing FIG. 3F, in some embodiments, step 328 may be a step of collecting, and transporting, the outputted waste pucks 301 and/or 307 and making them available for the later diecast processes. In some embodiments, at least partial execution of step 328 may progress method 320 to step 329.

Continuing discussing FIG. 3F, in some embodiments, step 329 may be a step of making the waste pucks 301 and/or 307 available for the diecast injection processing which continues the processing of the SNF material waste. In some embodiments, the output of method 320 may be waste pucks 301 and/or 307.

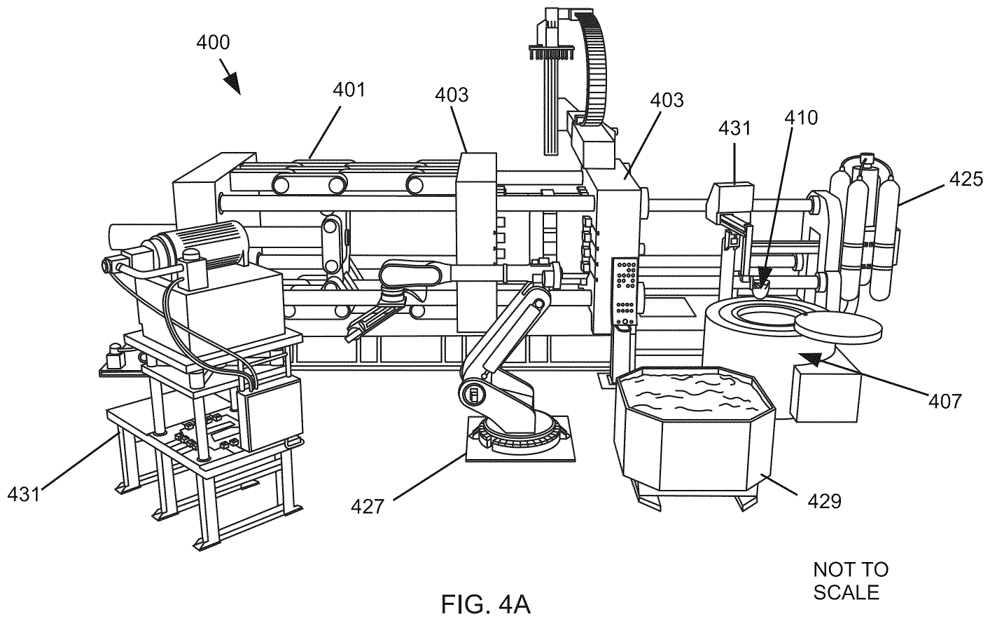

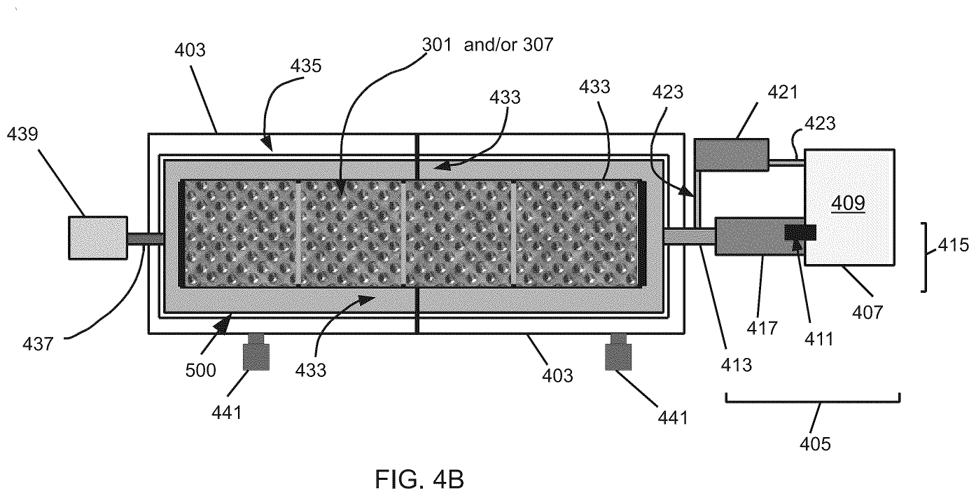

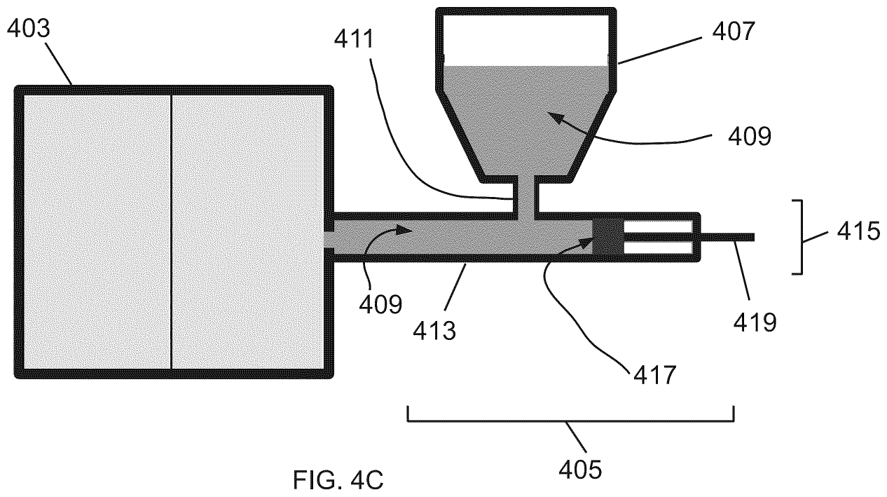

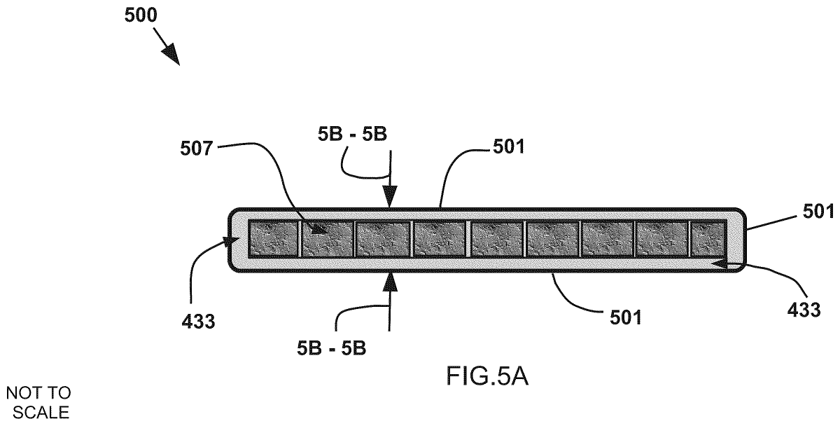

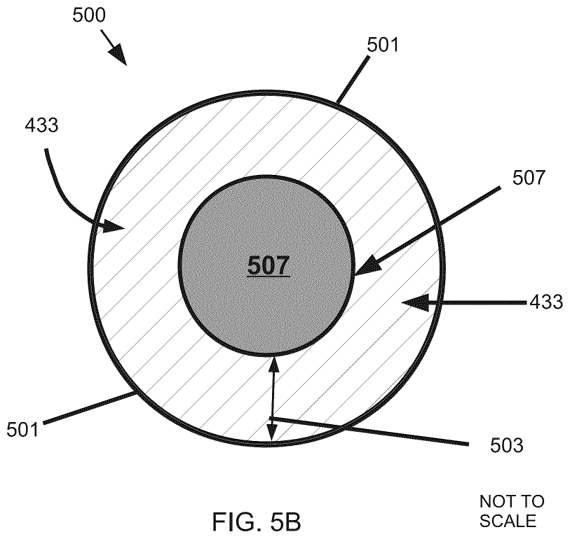

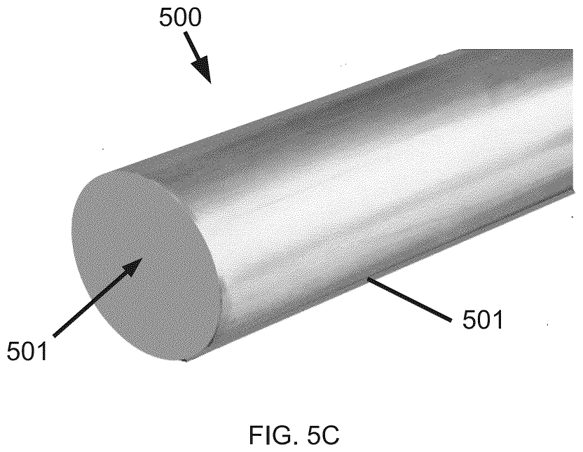

FIG. 4A is a perspective view showing a general diecast and/or injection molding system 400 for generating (producing and/or outputting) ingots 500, wherein a given ingot 500 comprises a plurality of waste pucks 307 within the given ingot 500. Note, a given ingot 500 is shown in FIG. 5A, in FIG. 5B, and in FIG. 5C.

Continuing discussing FIG. 4A, in some embodiments, a given diecast and/or injection molding system 400 may comprise at least one of: an injection molding and/or a die casting machine (press) 401, a die (mold) 403, an injection system 405, a robotic handler 427, a cooling bath 429, a controller 431, a portion thereof, combinations thereof, and/or the like. In some embodiments, die (mold) 403 may be (removably) attached to and/or fitted to injection molding and/or die casting machine (press) 401. In some embodiments, injection molding and/or die casting machine (press) 401 may be configured to open and/or close die (mold) 403. In some embodiments, injection molding and/or die casting machine (press) 401 may open and/or close die (mold) 403 using hydraulic and/or mechanical means. In some embodiments, die (mold) 403 may be configured to entirely house a plurality of waste pucks 307 therein. In some embodiments, die (mold) 403 may be in at least two separable parts (halves) (such as, but not limited to, a fixed half and a movable half).

Continuing discussing FIG. 4A, in some embodiments, injection system 405 may be configured to push and/or force a liquid (and/or molten) medium 409 into a volume 433 within closed die (mold) 403 from a melt furnace and/or reservoir 407. See FIG. 4B and FIG. 4C for further details on injection system 405, melt furnace and/or reservoir 407, liquid (and/or molten) medium 409, and volume 433. Continuing discussing FIG. 4A, in some embodiments, injection system 405 may comprise a ladle 410. In some embodiments, ladle 410 may be used for sampling liquid (and/or molten) medium 409 within melt furnace and/or reservoir 407. In some embodiments, injection system 405 may comprise a pressure means 415 (a pressurized means and/or a pressure generating means). In some embodiments, pressure means 415 may provide the motive force to push liquid (and/or molten) medium 409 from melt furnace and/or reservoir 407 and into closed die (mold) 403. In some embodiments, pressure means 415 may comprise a hydraulic system and/or the like. In some embodiments, pressure means 415 may comprise a hydraulic piston/ram and/or one or more (high pressure) gas cylinder(s) 425. In some embodiments, a gas within gas cylinder(s) 425 may be an inert gas with respect to medium liquid (and/or molten) medium 409. In some embodiments, a gas within gas cylinder(s) 425 may be nitrogen, argon, portions thereof, combinations thereof, and/or the like.

Continuing discussing FIG. 4A, in some embodiments, robotic handler 427 may be configured for (automatically) loading a given plurality of waste pucks 307 into the open die (mold) 403; unloading, ejecting, and/or extracting a newly formed ingot 500 from open die (mold) 403; moving a newly unloaded and/or extracted ingot 500 from open die (mold) 403 and into cooling bath 429 (passivating bath 429); moving a now cooled ingot 500 from out of cooling bath 429; portions thereof; combinations thereof; and/or the like. In some embodiments, robotic handler 427 may be at least one robotic arm. In some embodiments, robotic handler 427 may be remotely operated by a human and/or an AI (artificial intelligence) operator; and/or robotic handler 427 may be programmed to operate autonomously. In some embodiments, distal terminal end(s) of robotic handler 427 may comprise at least one of: a suction means for picking up and/or holding plurality of waste pucks 307 and/or ingot 500; physical manipulator(s) (e.g., claw, hand, grabber, magnet, and/or the like) for picking up and/or holding plurality of waste pucks 307 and/or ingot 500; portions thereof; combinations thereof; and/or the like.

In some embodiments, robotic handler 427 may be a component of an ejection means. In some embodiments, the ejection means may be configured for unloading, ejecting, and/or extracting a newly formed ingot 500 from open die (mold) 403. In some embodiments, the ejection means may comprise robotic handler 427, ejector pin(s), mold release agent(s), portions thereof, combinations thereof, and/or the like. In some embodiments, the ejector pin(s) may be ejector rod(s).

Continuing discussing FIG. 4A, in some embodiments, cooling bath 429 may be configured to cool, quench, and/or passivate ingot 500. In some embodiments, cooling bath 429 may be configured to more quickly lower temperatures of ingot 500 once ingot 500 leaves die (mold) 403. In some embodiments, cooling bath 429 may be at least partially filled with a cooling medium, such as, but limited to, a predetermined liquid and/or a predetermined fluid. In some embodiments, cooling bath 429 may be at least partially filled with water, oil, additives, portions thereof, combinations thereof, and/or the like.

In some embodiments, passivating bath 429 may be at least partially filled with a passivation medium, such as, but limited to, a predetermined liquid and/or a predetermined fluid.

Continuing discussing FIG. 4A, in some embodiments, controller 431 may be configured to operate, control, manage, monitor, open, close, start, stop, run, and/or the like at least one of: injection molding and/or die casting system 400, diecasting (injection molding) machine (press) 401, die (mold) 403, injection means 405, melt furnace/reservoir 407, flow port 411, injection port 413, pressure means 415, ram 417, pusher/arm 419, neutron absorber reservoir 421, port for neutron absorber 423, gas cylinder(s) 425, robotic handler 427, cooling bath 429, port (gate), control valve, solenoid valve, hydraulics, pressure regulator, ejection pin(s), material handler, portions thereof, combinations thereof, and/or the like. In some embodiments, controller 431 may be operatively connected to at least one of: injection molding and/or die casting system 400, diecasting (injection molding) machine (press) 401, die (mold) 403, injection means 405, melt furnace/reservoir 407, flow port 411, injection port 413, pressure means 415, ram 417, pusher/arm 419, neutron absorber reservoir 421, port for neutron absorber 423, gas cylinder(s) 425, robotic handler 427, cooling bath 429, port (gate), control valve, solenoid valve, hydraulics, pressure regulator, ejection pin(s), material handler, portions thereof, combinations thereof, and/or the like. In some embodiments, controller 431 may comprise at least one of: a computer, computer memory, computer storage, a screen and/or a display, a PLC (programmable logic controller), a sensor, input/output (I/O) means, a monitor, a meter, a gauge, a level sensor, an optical sensor, a PIR sensor, a motion sensor, a pressure sensor, an acoustic sensor, an accelerometer, a button, a switch, a membrane switch, a dial, a slide, a lever, non-transitorily stored control software, portions thereof, combinations thereof, and/or the like.

FIG. 4B depicts a two-dimensional (2D) schematic lengthwise cross-sectional view of a generalized diecast system 400 used for generating (producing and/or outputting) ingots 500, wherein the given ingot 500 may comprise a plurality of waste pucks 307 within that given ingot 500. In some embodiments, ingot 500 may comprise at least one waste puck 301. As compared to FIG. 4A, FIG. 4B may show inside of closed die (mold) 403; whereas, FIG. 4A may show the diecast system 400 from its exterior. In some embodiments, when die (mold) 403 has been closed by diecasting machine (press) 401, with a given plurality of waste pucks 307 located entirely inside of that closed die (mold) 403, then that given plurality of waste pucks 307 may be entirely disposed within that closed die (mold) 403 as shown in FIG. 4B. In some embodiments, closed die (mold) 403 may entirely surround a given (and predetermined) volume 433 within that closed die (mold) 403. In some embodiments, volume 433 may be configured to entirely house (hold) the given plurality of waste pucks 307. In some embodiments, any void spaces within volume 433, and any space between interior surfaces of die (mold) 403 and exterior surfaces of the housed plurality of waste pucks 307, may be configured to be at least substantially (mostly) filled and/or entirely immersed with (within) liquid (molten) medium 409 during injection operations of diecasting machine (press) 401 and with die (mold) 403 closed.

In some embodiments, reference numeral “409” may be associated with interchangeable terminology of “molten composition,” “molten materials,” “molten metal(s),” “molten alloy(s),” “molten copper,” “molten copper alloy(s),” portions thereof, combinations thereof, and/or the like. Further, “molten” may be replaced and/or interchanged with “melted” in this context. Further still, while molten composition 409 may be molten and/or melted, molten composition 409 may behave like a fluid and/or a liquid when composition 409 may be above its melting point; and once composition 409 has sufficiently cooled (e.g., below its melting point), then composition 409 may no longer be molten, melted, liquid, and/or fluid and may instead be solid (resolidified) and/or behave as a solid. See e.g., FIG. 4B and FIG. 4C for molten composition 409.

Continuing discussing FIG. 4B, in some embodiments, diecasting system 400 and/or diecasting machine (press) 401 may comprise at least one injection system 405 that may be operatively connected to diecasting machine (press) 401. In some embodiments, during active injection operations, when die (mold) 403 may be closed (and holding a plurality of waste pucks 307 [or at least one waste puck 301]) and fitted onto diecasting machine (press) 401, the operatively connected injection system 405 may force (squeeze) liquid (molten) medium 409 from melt furnace and/or reservoir 407 and into closed die (mold) 403, to (substantially [mostly]) fill all aforementioned void spaces within volume 433 and producing ingot 500 once that injected medium 409 has cooled sufficiently to resolidify. At the end of the injection and solidification process, the plurality of waste pucks 307 (or at least one waste puck 301) and the melt material 409 may form a heterogenous mass that is referred to as an “ingot” (e.g., ingot 500) in this patent application. In some embodiments, medium 409 may comprise at least one: metal, alloy, neutron absorber, portions thereof, combinations thereof, and/or the like. In some embodiments, the metal and/or the alloy of medium 409 may be at least partially or at least substantially (mostly) of copper. In some embodiments, liquid (molten) medium (composition) 409 may or may not include the neutron absorber(s). In some embodiments, melt furnace and/or reservoir 407 may be configured to house (hold) medium 409, with or without neutron absorber(s). In some embodiments, melt furnace and/or reservoir 407 may be operatively fitted with one or more heaters (and/or melting means). In some embodiments, during injection operations of system 400 and/or of machine (press) 401, medium 409 may be maintained in a molten, liquid, and/or fluid state within melt furnace and/or reservoir 407. In some embodiments, during injection operations of system 400 and/or of machine (press) 401, closed die (mold) 403 may be pressurized (e.g., above atmospheric pressure). In some embodiments, melt furnace and/or reservoir 407 may be heated to melt and/or liquify medium 409 within melt furnace and/or reservoir 407. In some embodiments, at least some liquid (molten) medium 409 may flow from melt furnace and/or reservoir 407 and into closed die (mold) 403 via at least one: flow port 411, injection port 413, portions thereof, combinations thereof, and/or the like. In some embodiments, flow port 411 may be a completely enclosed fluid path, as in a pipe or conduit from melt furnace and/or reservoir 407 to injection port 413, that is configured for moving (transporting) of at least some liquid (molten) medium 409 (from reservoir 407 and into flow port 411) (see e.g., FIG. 4C). In some embodiments, injection port 413 may be completely enclosed fluid path, as in a pipe or conduit for movement (transport) of liquid (molten) medium 409 and leading into (closed) die (mold) 403 (see e.g., FIG. 4C). Continuing discussing FIG. 4B, in some embodiments, item 417 may be an injector ram (piston), fed from the melt reservoir 409 via a connector 419. See also FIG. 4C for injector ram 417.

Continuing discussing FIG. 4B, in some embodiments, the molten composition (medium) 409, including the neutron absorbent material(s), if needed and/or desired, may be stored and maintained (together) in reservoir 407 (with medium 409 behaving as a liquid [fluid] and with the neutron absorbent material(s) being suspended and dispersed within medium 409). In other embodiments, the neutron absorber(s) may be stored separately in its own reservoir 421 and then introduced via a connector tube 423 into the injected melt alloy 409 stream during the injection process. In some embodiments, a given connector tube 423 may operatively connect neutron absorbent material(s) reservoir 421 to reservoir 409 and/or to injection port 413. In this patent application, a (typical) neutron absorber may be boron carbide (B₄C) which can be utilized as a powder. This powder is commercially available in sizes down to particles of five (5) microns (plus or minus 2 microns). This boron carbide (B₄C) neutron absorber powder may be blended with the melted alloy 407 since the melting point of the boron carbide (B₄C) (2,445 degrees Celsius [° C.]) is much higher than the contemplated molten copper alloy composition 407 (which may be around 1,084 degrees Celsius [C] or so). The boron carbide (B₄C) combined with the molten composition 407, forming a mix, when injected into the die (mold) 403, and deposited and dispersed inside the solidified ingot 500, acts as a neutron absorber, reducing the neutron flux and minimizing the risk of criticality, which refers to an uncontrolled nuclear chain reaction. In some embodiments, inclusion of one or more neutron absorber(s) into the composition 407 may be important for increased and/or better safe handling and storage of spent nuclear fuel (SNF) and/or other radioactive waste materials included in a given ingot 500.

Continuing discussing FIG. 4B, in some embodiments, diecasting system 400, diecasting machine (press) 401, and/or injection system 405 may comprise neutron absorber reservoir 421 and port(s) 423 for transport (movement) of neutron absorber material(s). In some embodiments, neutron absorber reservoir 421 may be configured to house one or more neutron absorber(s) (such as, but not limited to, boron carbide [B₄C]). In some embodiments, port(s) 423 may be an entirely closed fluid path, such as, but not limited to, a pipe or conduit from neutron absorber reservoir 421 and to molten reservoir 407 and/or to injection port 413. In some embodiments, port(s) 423 may be configured for the movement (transport) of the neutron absorber(s). In this manner the neutron absorber(s) may be mixed into and/or be added to liquid (molten) medium 409.

Continuing discussing FIG. 4B, in some embodiments, diecasting system 400, diecasting machine (press) 401, and/or die (mold) 403 may comprise one or more release agent(s) 435. In some embodiments, release agent(s) 435 may line (coat) interior surfaces of die (mold) 403 (prior to injection of liquid (molten) medium 409 into closed die [mold] 403). In some embodiments, release agent(s) 435 may be configured to promote release of a poured/molded ingot 500 from a now open die (mold) 403. In some embodiments, the internal walls (interior surfaces) of die (mold) 403 may be initially sprayed (coated) with release agent(s) 435. In some embodiments, release agent(s) 435 may be well known in the industry; and may allow the finished molded product (e.g., ingot 500) to be released from the diecast die (mold) 403 after the injection and after at least some cooling (such that ingot 500 is at least in a solid state). In some embodiments, release agent(s) 435 may be at least substantially (mostly) an oil, such as but not limited to, a vegetable oil.

Continuing discussing FIG. 4B, in some embodiments, item 437 may be a connector tube for the exhaust of an inert gas, wherein the inert gas may be used in the initial stage of loading of the die (mold) 403. In some embodiments, item 439 may be a gas reservoir to hold the inert gas which is purged from the die (mold) 403 during injection. Inert gases are commonly used in high-pressure diecasting operations to prevent or minimize oxidation and improve the casting quality. At least one primary purpose of using inert gases is to create a protective atmosphere within the diecasting machine, including the die (mold), during the casting (injection) process. Typically, an inert gas such as, but not limited to, nitrogen and/or argon is introduced into the diecasting machine's die cavity 403 prior to the injection of molten metal 409. In some embodiments, this inert gas may help in several ways, such as, but not limited to: (1) oxidation prevention (mitigation); (2) heat removal; (3) porosity reduction; (4) surface finish enhancement; portions thereof; combinations thereof; and/or the like. With respect to oxidation prevention (mitigation), inert gases may create (form) a barrier between the molten metal 409 and the surrounding air, minimizing or preventing oxidation of the composition 409. Oxidation can degrade the quality of the casting (ingot) 500 and affect its mechanical properties. With respect to heat removal, inert gases aid in the quicker cooling and re-solidification of the molten metal 409, reducing cycle times and improving productivity. The inert gas helps in extracting heat from the casting (ingot) 500, promoting re-solidification and maintaining dimensional accuracy and stability. Use of the inert gas into die (mold) 403 may be done before and after the injection process (operation). With respect to porosity reduction, the use of inert gases can help reduce the formation of gas porosity within the castings (ingots) 500. By displacing air and/or other gases from the die (mold) cavity 403, inert gases minimize the likelihood of gas entrapment in the molten metal 409, resulting in improved structural integrity of the resulting ingots 500. With respect to surface finish enhancement, inert gases may help improve the surface finish of the casting (ingot) 500 by reducing the formation of oxide films and promoting a cleaner mold surface contact. A specific choice of inert gas and its application may vary depending on particulars of given the die casting process, the type of metal(s) (alloy(s)) being cast, and other well know factors in the relevant art of metal/alloy diecasting. However, the general objective is to create a controlled environment within the diecasting machine, including the die (mold) 403, to enhance the casting (ingot) 500 quality and to reduce defects. In some embodiments, gas cylinder(s) 425 may house the insert gas. In some embodiments, gas cylinder(s) 425 may provide the insert gas to closed die (mold) 403.

However, in some embodiments, some or all of the beneficial features of the use of inert gases in the die (mold) 403, may not be necessary in this patent application since the end product, i.e., ingots 500, are not consumer nor industrial items of specific required look, feel, and/or quality, but rather items that are destined for deep underground burial encapsulated in a deep horizontal wellbore (and/or human-made cavern).

Continuing discussing FIG. 4B, in some embodiments, diecasting system 400, diecasting machine (press) 401, and/or die (mold) 403 may comprise an outlet port 437 and optionally an outlet reservoir 439. In some embodiments, outlet port 437 may be configured to bleed off excess liquid (molten) medium 409 from closed die (mold) 403. In some embodiments, outlet port 437 may be high pressure activated and/or high liquid level activated. In some embodiments, outlet port 437 may be operatively connected to die (mold) 403. In some embodiments, outlet port 437 may be enclosed fluid path, such as, but not limited to, a pipe or conduit that is configured for the movement of liquid (molten) medium 409. In some embodiments, outlet port 437 may also be operatively connected to outlet reservoir 439. In some embodiments, outlet reservoir 439 may be configured to receive and hold excess liquid (molten) medium 409.

Continuing discussing FIG. 4B, in some embodiments, diecasting system 400, diecasting machine (press) 401, and/or die (mold) 403 may comprise support(s) 441. In some embodiments, the die cast mold 403 may be supported by support 441. In some embodiments, support(s) 441 may be configured to support die (mold) 403, including when die (mold) 403 may house a plurality of waste pucks 307 or when die (mold) 403 may house a given ingot 500. In some embodiments, support(s) 441 may be operatively connected to an exterior of die (mold) 403. In some embodiments, support(s) 441 may be attached to an exterior of die (mold) 403.

FIG. 4C may depict a 2D schematic isolated cross-section close-up of injection system 405 and pressure system 415 for pushing (forcing) the liquid (molten) fluid medium 409 into closed die (mold) 403 from molten reservoir 407 that holds the liquid (molten) fluid medium 409. In some embodiments, pressure system 415 may be a hydraulic system. In some embodiments, pressure system 415 may comprise a ram 417 and a pusher/arm 419. In some embodiments, ram 417 may be a cylindrical plug member that is located within injection port 413, wherein one side of ram 417 may be in fluid contact with liquid (molten) fluid medium 409 and the other disposing side of ram 417 may be operatively connected to a structural pusher/arm 419. In some embodiments, pusher/arm 419 may be actuated by pressure, such as, but not limited to, from a hydraulic source and/or from gas cylinder(s) 425. In some embodiments, during active injection operations, hydraulic pressure may press against pusher/arm 419 and/or against ram 417, causing ram 417 to push (squeeze) at least some liquid (molten) fluid medium 409 from molten reservoir 407, through injection port 413, and into closed die (mold) 403.

In some embodiments, magneto-hydrodynamics (MHD) pumps may be used to pump and/or move the molten materials 409. In some embodiments, injection system 405 and/or pressure means 415 may comprise at least one magneto-hydrodynamic (MHD) pump.

With respect, to FIG. 4A, FIG. 4B, and/or FIG. 4C, note, at least some of the system 400, diecasting machine (press) 401, injection system 405, and/or pressure system 415, may be prior art, in that there already exists large diecasting machines (presses) that are fed molten metal(s) and/or alloy(s) to generate entirely large and sometimes solid metal parts. Specialized variations of this type of diecast injection process are available in the industry today. A major current example is the Tesla car company which uses the liquid metal injection process to produce vehicle body parts for its electric cars at a rate that is cheaper, faster, and less prone to defects than most (legacy) internal combustion engine car manufacturers in that industry. Telsa uses such large diecasting machines (presses) (i.e., the “Giga Presses” from Italian manufacturer Idra) that are fed molten metal(s) and/or alloy(s) to generate solid entirely large metal parts, namely motor vehicle body parts. The teachings of such preexisting industrial large scale diecasting machines (presses) and their supportive systems are incorporated by reference herein as is full set forth herein. These preexisting industrial large scale diecasting machines (presses) and their supportive systems may be modified for use in generating ingots, such as, but not limited to ingots 500, wherein these ingots may contain various types of waste, such as, but not limited to, nuclear waste, radioactive waste, waste puck(s) 301, plurality of waste pucks 307, HLW, SNF, SNF assemblies, LLW, hazardous waste, biological waste, portions thereof, combinations thereof, and/or the like. At least some unique aspects of such modified industrial large scale diecasting machines (presses) and their supportive systems may comprise the unique dies (molds) 403 (e.g., that are configured to house plurality of waste pucks 307, and material handling and radiation shielding precautions that may be applied since the waste within the ingots 500 may be radioactive. Using the technological means taught herein, modified industrial large scale diecasting machines (presses) and their supportive systems may be used in managing HLW disposal in ingot 500 and/or in capsule formats to achieve more efficiencies, increase safety, and cost reduction as compared to prior art means of HLW long-term disposal.

FIG. 5A is a lengthwise cross-sectional diagram of a given ingot 500 (casting 500) that was output from die casting injection molding system 400, diecasting injection molding machine (press) 401, die (mold) 403, and/or from method 800 (see FIG. 8 for method 800). In some embodiments, FIG. 5A shows at least substantially (mostly) all of volume 433 within an exterior surface 501 of ingot 500 is of the resolidified metal(s) and/or alloy(s) 409, aside from where a plurality of waste pucks 307 (or at least one waste puck 301) occupies that volume 433. Exterior surface 501 is an exterior surface of composite ingot 500. Also note, plurality of waste pucks 307 in FIG. 5A (and in FIG. 5B) is now shown with a reference numeral of “507” instead of 307 to emphasize that once ingot 500 is formed, that plurality of waste pucks 307 has been modified such that its prior free void spaces are now no longer free void spaces but are now instead occupied by the resolidified metal(s) and/or alloy(s) 409. This FIG. 5A cross-section shows the ingot 500 and the relationship between the solidified alloy 409, which surrounds the modified plurality of waste pucks 507 and forms a solid metal protective “cocoon” around that modified plurality of waste pucks 507. Recall, in some embodiments, this resolidified metal(s) and/or alloy(s) 409 of a given ingot 500, may also contain (comprise) dispersed neutron absorber(s) within the resolidified metal(s) and/or alloy(s) 409 of volume 433. Note, FIG. 5A includes sectional line 5B-5B, whose cross-section is shown in FIG. 5B.

FIG. 5B is a transverse width cross-sectional diagram taken through sectional line 5B-5B of FIG. 5A. FIG. 5B is a transverse width cross-sectional diagram taken through a middle portion (with respect to a length) of a given ingot 500 (casting 500) that was output from diecasting injection molding system 400, diecasting injection molding machine (press) 401, die (mold) 403, and/or from method 800 (see FIG. 8 for method 800). In some embodiments, FIG. 5B shows at least substantially (mostly) all of volume 433 within an exterior surface 501 of ingot 500 is of the resolidified metal(s) and/or alloy(s) 409, aside from where modified plurality of waste pucks 507 occupies that volume 433. Also note, plurality of waste pucks 307 in FIG. 5B (and in FIG. 5A) is now shown with a reference numeral of “507” instead of 307 to emphasize that once composite ingot 500 is formed, that plurality of waste pucks 307 has been modified such that is prior free void spaces (if any) are now no longer free void spaces, but are now instead occupied by the resolidified metal(s) and/or alloy(s) 409. This FIG. 5B cross-section shows the composite ingot 500 and the relationship between the solidified alloy 409, which surrounds the modified plurality of waste pucks 507 and forms a solid metal protective “cocoon” around that modified plurality of waste pucks 507. Recall, in some embodiments, this resolidified metal(s) and/or alloy(s) 409 of a given ingot 500, may also contain (comprise) dispersed neutron absorber(s) within the resolidified metal(s) and/or alloy(s) 409 of volume 433. Also shown in FIG. 5B, may be a minimum thickness 503 of ingot 500 from exterior surface 501 until an exterior structure of modified plurality of waste pucks 507. In some embodiments, thickness 503 of ingot 500 may be at least three (3) inches, plus or minus one (1.0) inch. In some embodiments, thickness 503 of ingot 500 may be at least two (2) inches, plus or minus one-half (0.5) inch.

FIG. 5C is a partial perspective (isometric) and exterior view of a given ingot 500 (casting 500) that was output from diecasting injection molding system 400, diecasting injection molding machine (press) 401, die (mold) 403, and/or from method 800 (see FIG. 8 for method 800). Recall, ingot 500 may internally hold a modified plurality of waste pucks 507 (see e.g., FIG. 4B, FIG. 5A, and FIG. 5B). However, note that modified plurality of waste pucks 507 may not be visible in FIG. 5C since modified plurality of waste pucks 507 may reside entirely within exterior surfaces 501 of ingot 500. FIG. 5C shows portions of exterior surface 501 of ingot 500. FIG. 5C shows exterior surface 501 may have a smooth and/or polished finish in some embodiments; however, exterior surface 501 may have other surface geometry depending upon the interior surface geometry of its generating die (mold) 403. In some embodiments, ingots 500 may be handled easily by existing material handling machinery developed and used for handling and transporting heavy solid cylindrical goods in industry today. Material handling operations of ingots 500 may not require any additional experimentation or development, aside from including radiation shielding where desired and/or needed to protect personnel and/or equipment/machinery.

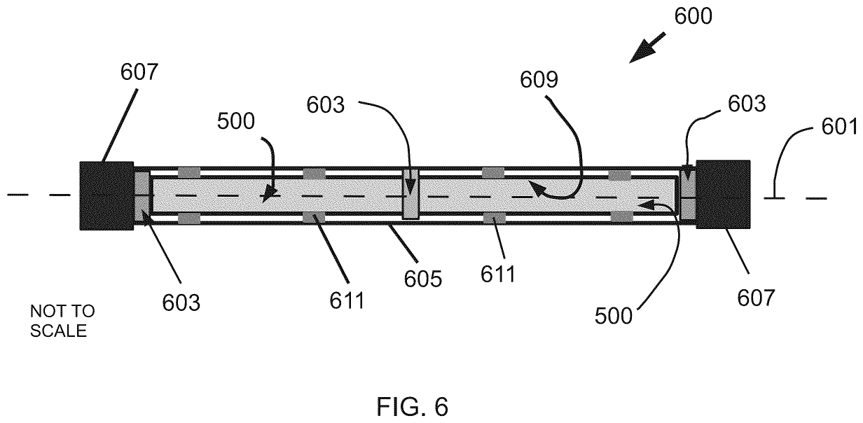

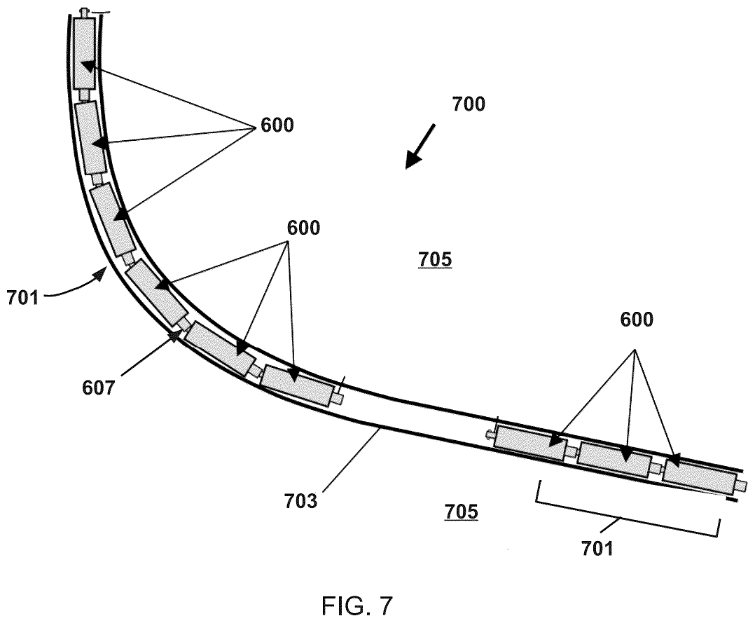

FIG. 6 is a lengthwise cross-sectional diagram through a given waste disposal capsule 600. In some embodiments, waste disposal capsule 600 may be comprised and/or configured to house at least one (1) ingot 500. In some embodiments, waste disposal capsule 600 may be comprised and/or configured to house at least two (2) ingots 500. In some embodiments, waste disposal capsule 600 may be comprised and/or configured to house three (3) or fewer ingots 500. In some embodiments, when two (2) or more ingots 500 may reside within a given waste disposal capsule 600, those ingots 500 may be arranged end-to-end within that given waste disposal capsule 600, such that the ingots 500 and the waste disposal capsule 600 are concentric about a common central axis 601 and/or such that the lengths of the ingots 500 and the waste disposal capsule 600 are all at least substantially (mostly) parallel with each other. In some embodiments, when two (2) or more ingots 500 may reside within a given waste disposal capsule 600, nearest terminal ends of those adjacent ingots 500 may be physically separate from each other by at least one plate 603. In some embodiments, between each sequential installed ingot 500 may be placed (disposed) at least one (1) neutron absorber plate 603. In some embodiments, plate 603 may be at least a substantially (mostly) (solid) cylindrical disc (disk) (or wafer). In some embodiments, plate 603 may be configured for neutron absorption. In some embodiments, waste disposal capsule 600 may be formed from a hollow metal cylinder (tube and/or pipe) 605. In some embodiments, waste disposal capsule 600 may be formed from a hollow steel cylinder (tube and/or pipe) 605. In some embodiments, an inside diameter of metal tube 605 may be larger than an outside diameter of ingot 500. In some embodiments, metal tube 605 may initially have open opposing terminal ends, which may provide access to an interior of metal tube 605 for loading of ingot(s) 500 therein. In some embodiments, the two opposing open terminal ends of a given metal tube 605 may be closed (sealed) by attaching one coupling 607 to each such open terminal end of the given metal tube 605. Thus, a given metal tube 605 that has both of its two opposing open terminal ends closed may then have two opposing couplings 607. In some embodiments, a given completed waste disposal capsule 600 may comprise one (1) metal tube 605 and two (2) opposing couplings 607. In some embodiments, a given coupling 607 may be attached to a given terminal end of a given metal tube 605 by mechanical means (such as, but not limited to, a threaded connection, crimping, and/or the like) and/or by welding. In some embodiments, inside of each coupling 607, inside of pipe 605, may be a plate 603.

Continuing discussing FIG. 6, in some embodiments, each coupling 607 may contain exterior geometry and/or structure that is configured to permit two different waste disposal capsules 600 to be (removably) connected to each other, in an end-to-end fashion such as is shown in FIG. 7, to yield a “string” of two or more (removably) connected waste disposal capsules 600. Note such exterior geometry and/or structure that permits such strings is well known in the oil field development industries, wherein such technology is incorporated by reference as if fully set forth herein. In some embodiments, two or more waste disposal capsules 600 may be connected linearly by their abutting couplings 607 which may allow a string of as many as twenty (20) waste disposal capsules 600 to be connected together (in the end-to-end fashion) to allow the waste disposal capsules 600 to be sequestered rapidly as a single unit by a drill rig capable of several hundred thousand pounds of lift capacity (such as, an oil field drill rig).

Continuing discussing FIG. 6, in some embodiments, disposed between a given attached coupling 607 and a terminal end of a closest installed ingot 500 may be at least one installed plate 603. Thus, a given completed waste disposal capsule 600, with only one (1) installed ingot 500 may have at least two opposing installed plates 603 installed, with one such plate 603 installed inside of each coupling 607. Thus, a given completed waste disposal capsule 600, with only two (2) installed ingots 500 may have at least three installed plates 603 installed, with one such plate 603 installed inside of each coupling 607 and the third plate 603 being installed between the two installed ingots 500.

Continuing discussing FIG. 6, in some embodiments, installed around each installed ingot 500 or each pair of end-to-end arranged ingots 500 may be a sleeve 609. In some embodiments, sleeve 609 may be configured for neutron absorption. In some embodiments, sleeve 609 may be at least a substantially (mostly) a hollow cylindrical member. In some embodiments, sleeve 609 may have a diameter that is larger than an outside diameter of ingot 500 but less than an inside diameter of metal tube 605. In some embodiments, with respect to an assembled given waste disposal capsule 600, lengths of metal tube 605, sleeve 609, and ingots 500 of that given waste disposal capsule 600 may be concentric with each other about a common central axis 601 and/or such that these lengths may all be at least substantially (mostly) parallel with each other. In some embodiments, a given waste disposal capsule 600 may comprise at least one (1) sleeve 609 that may be longer than the combined lengths of installed ingots 500 and their separating plates 603. In some embodiments, a given waste disposal capsule 600 may comprise at least one (1) sleeve 609 per each installed ingot 500.

In some embodiments, these neutron absorber systems of plates 603 and/or of sleeve 609 may be made at least partially of borated steel which has been demonstrated in the industry to safely moderate radiation and/or neutron emission effects.

Continuing discussing FIG. 6, in some embodiments, installed around the exterior and the lengths of each installed ingot 500, within a given waste disposal capsule 600, may be at least one support (standoff) 611. In some embodiments, installed supports (standoffs) 611 may prevent exterior surfaces along the length of installed ingot(s) 500 from physically touching interior surfaces of metal tube 605. In some embodiments, installed supports (standoffs) 611 may facilitate maintaining the concentric (and/or centralized) relationship(s) around the common central axis 601 of a given waste disposal capsule 600 with respect to the lengths of metal tube 605, sleeve 609, and ingots 500 of that given assembled waste disposal capsule 600.

Continuing discussing FIG. 6, in some embodiments, (assembled) waste disposal capsule 600 may comprise at least one of: plate 603, metal tube 605, coupling 607, sleeve 609, support (standoff) 611, portions thereof, combinations thereof, and/or the like. In some embodiments, (assembled) waste disposal capsule 600 may comprise at least one of: plate 603, metal tube 605, coupling 607, sleeve 609, support (standoff) 611, ingot 500, portions thereof, combinations thereof, and/or the like.

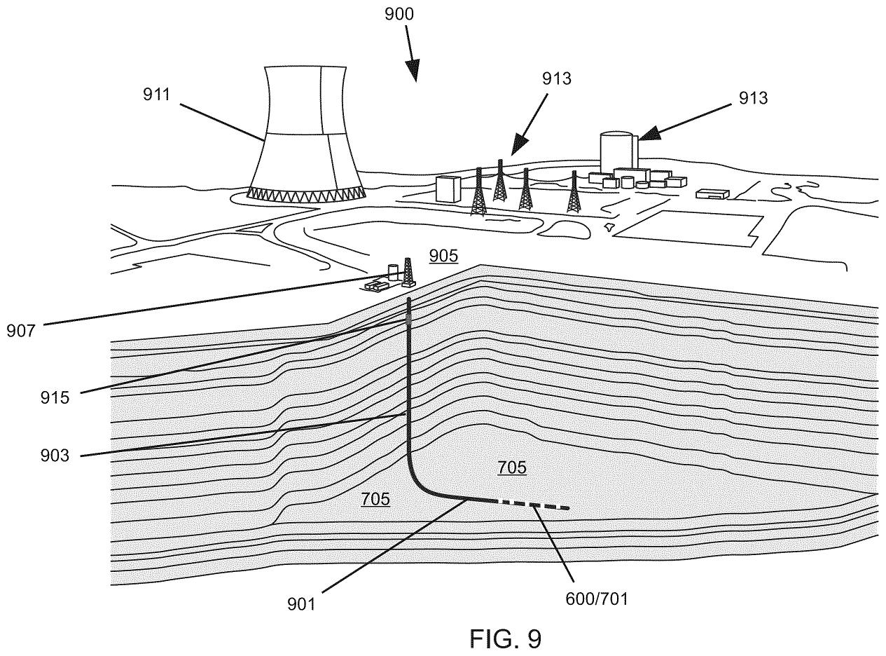

FIG. 7 shows a cross-section through a section (region and/or portion) of a system 700 for disposal of waste within deeply located wellbore(s) 703. FIG. 7 shows an illustration of at least two (end-to-end) adjacent physically linked waste disposal capsules 600, which in such a configuration may form a string 701 of waste capsules 600, located inside of a given wellbore 703. Note, in some embodiments, the system 700 section (region and/or portion) shown in FIG. 7 may be a section (region and/or portion) of waste disposal repository system 900 shown more fully in FIG. 9. Continuing discussing FIG. 7, in some embodiments, at least a portion of that wellbore 703 may be located within at least one deeply located geologic formation (rock) 705. In some embodiments, any two waste capsules 600 that may be adjacently aligned end-to-end (e.g., with one terminal end of one waste capsule 600 next to one terminal end of a different waste capsule 600) may be mechanically joined (linked) together via mechanical interactions of their two closest capsule connector devices 607 (couplings 607) from each of the two different waste capsules 600. Thus, two or more waste capsules 600 may be mechanically linked together to form a string 701 of waste capsules 600 by use of such couplings 607. In some embodiments, such a string 701 of waste capsules 600 may be loaded, landed, inserted, and/or emplaced within a given wellbore 703, wherein that given wellbore 703 may extend into at least one deeply located geological formation (rock) 705. In some embodiments, via mechanically interacting capsule connector devices 607 (couplings 607), at least two non-linked, but end-to-end adjacent waste capsules 600, may be (removably) coupled (linked and/or attached) together (e.g., to form a given string 701 of waste capsules 600 or to become part of an existing string 701 of waste capsules 600). In some embodiments, at least two non-linked, but end-to-end adjacent waste capsules 600, may be coupled (linked and/or attached) together, within or outside of a given wellbore 703, to form a given string 701 of waste capsules 600 or to become part of an existing string 701 of waste capsules 600. In some embodiments, at least two linked waste capsules 600 within a given string 701 of waste capsules 600, may be decoupled. In some embodiments, at least two linked waste capsules 600 within a given string 701 of waste capsules 600, may be decoupled, within or outside of a given wellbore 703.

Continuing discussing FIG. 7, in some embodiments, wellbore 703 may be lined with casing(s) and/or section(s) of pipe, such as, but not limited to, steel piping, with or without concrete and/or cement located exteriorly to the piping but inside of the native rock (e.g., formation 705). In some embodiments, wellbore 703 may comprise at least substantially (mostly) vertical sections, horizontal sections (lateral sections), transitional sections, portions thereof, combinations thereof, and/or the like. In some embodiments, the at least substantially (mostly) vertical sections, horizontal sections (lateral sections), transitional sections, portions thereof, combinations thereof, and/or the like, of a given wellbore 703 may be operatively connected to each other. In some embodiments, the at least substantially (mostly) vertical sections, horizontal sections (lateral sections), transitional sections, portions thereof, combinations thereof, and/or the like, of a given wellbore 703 may be integral to each other. See also, FIG. 9.

In some embodiments, handling waste capsule(s) 600 and/or string(s) 701 of waste capsule(s) 600, within wellbore(s) 703, may be accomplished using downhole tools, tooling, machines, devices, apparatus, systems, methods, processes, and/or techniques of the oil field industry that are in use today and well understood. Such preexisting downhole tools, tooling, machines, devices, apparatus, systems, methods, processes, and/or techniques of the oil field industry are incorporated by reference herein as if fully set forth herein.

Also note, the waste capsules 600 in FIG. 7 need not be (removably) connected to each other for forming string(s) 701. In some embodiments, waste capsules 600 within a given wellbore 703 need not be (removably) connected to each other in the string(s) 701 configuration.

FIG. 8A is a flow diagram showing at least some steps in a method 800. In some embodiments, method 800 may be a method for one or more of the following: processing waste pucks 301 and/or 307; processing waste pucks 301 and/or 307 for long-term disposal; processing waste pucks 301 and/or 307 to be entirely encapsulated within ingot(s) 500; inserting ingot(s) 500 (with waste pucks 301 and/or 307) into waste capsule(s) 600; inserting loaded waste capsule(s) 600 into wellbore(s) system(s) 700 and/or 900; portions thereof; combinations thereof; and/or like. In some embodiments, method 800 may comprise at least one of the following steps: step 801, step 803, step 805, step 807, step 809, step 811, step 813, step 815, step 816, step 817, step 819, step 821, step 823, step 825, step 827, step 829, step 831, step 833, step 835, step 837, portions thereof, combinations thereof, and/or the like. In some embodiments, step 328 and/or step 329 (e.g., from method 320 of FIG. 3F) may feed into method 800. In some embodiments, at least one of these steps of method 800 may be optional, skipped, omitted, executed out of numeral order with respect to a step's reference numeral, portions thereof, combinations thereof, and/or the like.

Continuing discussing FIG. 8A, in some embodiments, step 801 may be a step of selecting, collecting, and/or gathering shredded/chipped SNF assembly material 299 (or portions thereof) for use in method 800. In some embodiments, step 801 may be a step of selecting, collecting, and/or gathering waste pucks 301 and/or plurality (pluralities) of waste pucks 307 for use in method 800. In some embodiments, the SNF assemblies or portions thereof that may be processed and/or acted upon by method 800 (and/or by method 320) may be at least one of: SNF assembly 101, SNF assembly 102, SNF assembly 103, SNF assembly 210, chipped SNF material 299, waste pucks 301, plurality of waste pucks 307, modified plurality of waste pucks 507, spent nuclear fuel assembly, fuel rod, fuel pellet, control rod, portions thereof, combinations thereof, and/or the like. In some embodiments, these SNF assemblies may be found in temporary storage in (surface) cooling ponds and/or in surface (or near surface) storage in dry cask containers. In some embodiments, step 801 may be a step of locating, identifying, and/or selecting the SNF assemblies (or portions thereof) from multiple power plant 911 sites (see FIG. 9 for nuclear power plant 911), cooling pond's locations, dry cask (intended temporary storage) containers locations, portions thereof, combinations thereof, and/or the like. In some embodiments, any such located and/or identified SNF assemblies (or portions thereof) may be selected for use in method 800 (and/or in use by method 320). In some embodiments, execution of step 801 may be done onsite at a given nuclear power plant 911 (with cooling ponds) in a specialized area of the “site” (grounds) of that given nuclear power plant 911. In some embodiments, “site” may be defined in U.S. nonprovisional patent application Ser. No. 18/108,001, filed on Feb. 9, 2023, by the same inventor as the present patent application; wherein the disclosure of U.S. nonprovisional patent application Ser. No. 18/108,001 is incorporated herein by reference in its entirety as if fully set forth herein. In some embodiments, the collected SNF assemblies (or portions thereof) may be transported offsite from the temporary storage locations (e.g., cooling ponds and/or dry cask containers) to remote and/or different site(s) for further operations of method 800 (such as, but not limited to, sites of wellbore system 700 and/or repository system 900). In some embodiments, this type of multi-plant/multi-location operation, step 801 may be a means of accumulating and commingling various quantities of the SNF assemblies (or portions thereof) for processing at one or more centrally located site(s), according to further steps of method 800. In some embodiments, in step 801 the modified SNF assembly material 299, waste pucks 301, plurality of waste pucks 307 may be collected. In some embodiments, this approach may increase efficiencies and lower operational costs, and personnel needs for disposal of SNF assemblies (or portions thereof). In some embodiments, at least partial execution of step 801 (e.g., collection of at least one SNF assembly, modified portion thereof (such as, but not limited to, chipped waste material 299, waste pucks 301, plurality of waste pucks 307, and/or the like), or portion thereof may progress method 800 to step 803 and/or to step 819 (see e.g., FIG. 8B for an embodiment where step 801 may progress to step 819).

In some embodiments, step 328 and/or step 329 (e.g., from method 320 of FIG. 3F) may feed into method 800. In some embodiments, step 328 and/or step 329 (e.g., from method 320 of FIG. 3F) may feed into step 803 of method 800. In some embodiments, step 328 and/or step 329 may replace step 801 of method 800. In some embodiments, execution of method 320 may conclude by flowing into execution of method 800.

Continuing discussing FIG. 8A, in some embodiments, step 803 may be a step of calculating, determining, measuring, and/or the like, the free (void) volume (space) of a given SNF assembly material (or portion thereof), the chipped waste material 299, the waste pucks 301, the plurality of waste pucks 307, and/or the like. This computation and/or determination may be important in order to accurately determine a volume of melted metal(s), alloy(s), and/or (optional) neutron absorbent that may be used during a molten diecasting injection process step(s) to will both entirely fill any such free void spaces and that will entirely cover over an exterior of the given SNF assembly (or portion thereof), the chipped waste material 299, the waste pucks 301, the plurality of waste pucks 307, and/or the like, by a minimum thickness (that minimizes criticality). This internal intricate free void space, of the typical SNF assembly (or portion thereof), the chipped waste material 299, the waste pucks 301, the plurality of waste pucks 307, and/or the like, may be easily and readily determined by a number of well-known techniques, all of which are incorporated by reference. For example, and without limiting the scope of the present invention, this internal intricate free void space, of the typical SNF assembly (or portion thereof), the chipped waste material 299, the waste pucks 301, the plurality of waste pucks 307, and/or the like, may be easily and readily determined from digital 3D modeling software used to model the given SNF assembly (or portion thereof), the chipped waste material 299, the waste pucks 301, the plurality of waste pucks 307, and/or the like. For example, and without limiting the scope of the present invention, this internal intricate free void space, of the typical SNF assembly (or portion thereof), the chipped waste material 299, the waste pucks 301, the plurality of waste pucks 307, and/or the like, may be easily computed empirically by a liquid displacement process on a given finished SNF assembly (or portion thereof), the chipped waste material 299, the waste pucks 301, the plurality of waste pucks 307, and/or the like. In some embodiments, execution of step 803 may progress method 800 to step 805 and/or to step 807.

Continuing discussing FIG. 8A, in some embodiments, step 805 may be a step of determining and/or selecting the metal(s) and/or the alloy(s) that will be used in the diecast injection molding process to produce a given ingot 500 that houses nuclear and/or radioactive waste, such as, but not limited to, a SNF assembly material or portion thereof, chipped waste material 299, waste pucks 301, plurality of waste pucks 307, and/or like, located within that given ingot 500. In some embodiments, this metal(s) and/or the alloy(s) may be at least one copper alloy. In some embodiments, this metal(s) and/or the alloy(s) may be at least one copper and aluminum alloy (Cu—Al alloy(s)), copper and nickel alloy (Cu—Ni alloy(s)), portions thereof, combinations thereof, and/or the like. Copper-aluminum alloys offer high strength and excellent corrosion resistance. Copper-aluminum alloys are suitable for this type of application discussed herein in this patent application for forming the ingots 500 because of their comparable light weight and corrosion-resistant properties (e.g., as compared to other alloys, such as steel which is comparably heavier and generally less corrosion-resistant). In addition, copper-nickel alloys are also usable because of their outstanding corrosion resistance in the deep geological disposal formation 705 environments and geological conditions. The composition of this determined and/or selected metal(s) and/or the alloy(s) may be accomplished to provide optimal temperature response during diecasting injection operations, fluidity for injection, and/or overall cost lowering of operations. Such parameters and/or details are well-known in the industrial diecasting industry and may be modeled to provide sufficient accuracy and repeatability of operations for method 800. In some embodiments, execution of step 805 may progress method 800 to step 807 and/or to step 811.

Continuing discussing FIG. 8A, in some embodiments, step 807 may be a step of calculating, determining, measuring, and/or the like, a volume of the selected and/or determined metal(s) and/or alloy(s) from step 805 that may be used to form the given ingot 500. In some embodiments, step 807 may be a step of calculating, determining, measuring, and/or the like, the volume of the selected and/or determined metal(s) and/or alloy(s) from step 805 that may be used to fill the inside of die (mold) 403, and to surround and penetrate the waste (such as, but not limited to, SNF assembly [or portion thereof], chipped waste material 299, waste pucks 301, plurality of waste pucks 307, and/or the like) within that die (mold) 403, such that after the diecasting injection process a given ingot 500 may be formed. In some embodiments, as inputs, this step 807 may utilize: the exterior dimensions of the given waste material that shall be inside the die (mold) 403 (such as, but not limited to, SNF assembly [or portion thereof], chipped waste material 299, waste pucks 301, plurality of waste pucks 307, and/or the like); the determined free void space for the given waste material that shall be inside the die (mold) 403 (e.g., from the step 803); a volume of that die (mold) 403; a density of the selected and/or determined metal(s) and/or alloy(s) from step 805 (e.g., when molten); portions thereof; combinations thereof; and/or the like. In some embodiments, this melt volume of step 807 may be based (calculated, determined, measured, and/or the like), at least in part, by adding the free void space volume determined in step 803 above (if any) to the volume inside of that die (mold) 403 minus the volume occupied by the given waste material that shall be inside that die (mold) 403 (such as, but not limited to, SNF assembly [or portion thereof], chipped waste material 299, waste pucks 301, plurality of waste pucks 307, and/or the like); and optionally, plus some additional amount of the determined molten alloy(s) and/or metal(s) as a buffer to make sure there is sufficient determined molten alloy(s) and/or metal(s) to form at least one complete ingot 500. In some embodiments, a maximum or upper limit for this volume (of the determined molten alloy(s) and/or metal(s)) of step 807 may be the (interior) volume of die (mold) 403. In some embodiments, step 807 may include a process of purging with air or a gas to remove any liquid water from the given waste material (such as, but not limited to, SNF assembly [or portion thereof], chipped waste material 299, waste pucks 301, plurality of waste pucks 307, and/or the like) that shall be inside of that die (mold) 403 before the determined molten alloy(s) and/or metal(s) are injected (under pressure) into that die (mold) 403. In some embodiments, this purge action prevents (or minimizes) the formation of super-heated steam by any such water during the melt injection step(s). In some embodiments, execution of step 807 may progress method 800 to step 809, to step 805, and/or to step 811.

Continuing discussing FIG. 8A, in some embodiments, step 809 may be a step of performing a fissile criticality analysis (FCA) with respect to at least one of: the given waste material (such as, but not limited to, SNF assembly [or portion thereof], chipped waste material 299, waste pucks 301, plurality of waste pucks 307, and/or the like) that shall be inside of a die (mold) 403, with respect to the dimensions, size, density, and/or type of the given waste material; die (mold) 403 design, dimensions, size, and/or material(s) of construction; ingot 500 design, dimensions, size, and/or material(s) of construction; loaded waste capsule 600 design, dimensions, size, and/or material(s) of construction; wellbore(s) system(s) 700 and/or 900 design, dimensions, size, and/or material(s) of construction; portions thereof, combinations thereof, and/or the like.

A fission criticality analysis (FCA) on the nuclear waste form may be performed to assess the potential for a dangerous self-sustaining nuclear chain reaction within the waste package. This analysis may be important crucial to ensure the safe handling, transportation, and/or storage of nuclear waste. Past criticality incidents have occurred in the U.S., Japan, and Russia because of inadequate criticality analysis.

In some embodiments, general steps involved in conducting a criticality analysis (FCA) may be: define the system boundaries; identify the fissile materials; determine the neutron multiplication factors; assess neutron moderation; consider neutron absorption; perform criticality calculations, using computational tools and established mathematical models. And finally, in some embodiments, meet all applicable and/or relevant regulatory requirements.

Continuing discussing FIG. 8A and step 809, in some embodiments, as a safety precaution, a fissile criticality analysis (FCA) may be desired, required, and/or implemented, prior to making (building and/or constructing) a given die (mold) 403, ingot 500, loaded waste capsule 600, wellbore(s) system(s) 700 and/or 900, portions thereof, combinations thereof, and/or the like, with respect to the given waste material (such as, but not limited to, SNF assembly [or portion thereof], chipped waste material 299, waste pucks 301, plurality of waste pucks 307, and/or the like) that shall be inside of a die (mold) 403, with respect to the dimensions, size, density, and/or type of the given waste material to be used in method 320, method 800, ingots 500, loaded waste capsules 600, wellbore(s) system(s) 700 and/or 900, portions thereof, combinations thereof, and/or the like. In some embodiments, a fissile criticality analysis (FCA) may be performed on at least one of: the given waste material (such as, but not limited to, SNF assembly [or portion thereof], chipped waste material 299, waste pucks 301, plurality of waste pucks 307, and/or the like) that shall be inside of a die (mold) 403, with respect to the dimensions, size, density, and/or type of the given waste material; die (mold) 403 design, dimensions, size, and/or material(s) of construction; ingot 500 design, dimensions, size, and/or material(s) of construction; loaded waste capsule 600 design, dimensions, size, and/or material(s) of construction; wellbore(s) system(s) 700 and/or 900 design, dimensions, size, and/or material(s) of construction; portions thereof; combinations thereof; and/or the like; and/or on the equipment that may handle the ingots 500 and/or the waste capsules 600 and/or that may handle the nuclear (radioactive) waste, to determine metrics such as, waste composition; waste type; waste density; waste weight; waste volume; waste size (dimensions); waste shape (geometry); ingot 500 composition; (loaded) waste capsule 600 composition; ingot 500 density; (loaded) waste capsule 600 density; ingot 500 weight; (loaded) waste capsule 600 weight; ingot 500 volume; (loaded) waste capsule 600 volume; ingot 500 size (dimensions); (loaded) waste capsule 600 size (dimensions); ingot 500 shape (geometry); (loaded) waste capsule 600 shape (geometry); ingot 500 materials of construction; (loaded) waste capsule 600 materials of construction; ingot 500 thickness; (loaded) waste capsule 600 thickness; quantity of ingots 500 per a given waste capsule 600; plates 603 materials of construction; plates 603 thickness; plates 603 size (dimension); plates 603 shape (geometry); plates 603 quantity per a given waste capsule 600; plates 603 placement locations within a given waste capsule 600; sheaths 609 materials of construction; sheaths 609 thickness; sheaths 609 size (dimension); sheaths 609 shape (geometry); sheaths 609 quantity per a given waste capsule 600; sheaths 609 placement location within a given waste capsule 600; formation (rock) properties of the formation (rock) 705 that immediately surrounds a given or planned deeply located geological repository 700; and/or geometry of the disposal system 700 and/or 900 and its contents such that the nuclear (radioactive) waste material always remains subcritical. In some embodiments, this FCA analysis may provide (yield) upper limits on the weight per unit of material, typically called “gram-limits,” which may be the maximum quantity of fissile material in a given ingot 500 and/or waste capsule 600. In some embodiments, the required gram limits may be used in all the subsequent waste disposal processes (e.g., that involve such ingots 500, waste capsules 600, and/or the like). In addition, the criticality analysis (FCA) may utilize factors such as, physical volumes of waste, material burnup times, time out of the reactor, and other well-known safety metrics to define the final configuration of the waste package (waste capsule). Execution of FCA is well known in the industry and such FCA industry teachings are incorporated by reference as if fully set forth herein. Fissile Critical Analysis (FCA) may be performed by various presently available computer programs, codes, algorithms, models, and/or the like. Some of these may be as follows: SCALE (Standardized Computer Analysis for Licensing Evaluation); MCNP (Monte Carlo N-Particle Transport Code); MONK (Monte Carlo N-Particle Kinetics Code); AMPX (Advanced Multi-group Cross-section Processor); and PARTISN. These are available to researchers and many federal and private agencies alike. In some embodiments, execution of step 809 may progress method 800 to step 811, step 807, and/or to step 817.

Continuing discussing FIG. 8A and step 809, in some embodiments, the FCA may also determine inclusion of neutron absorbing parameters to minimize the risk of fissile criticality. This may include determining neutron absorbing materials (such as, but not limited to, materials with boron), elements, members, placement, location, distribution, amounts, combinations thereof, portions thereof, and/or the like. In some embodiments, neutron absorbing materials may be included in one or more of: the chipped waste material 299, in the waste pucks 301, in the plurality of waste pucks 307, in the molten material 409, in the ingots 500, in the waste capsules 600, in the plates 603, in the sleeves 609, combinations thereof, a portion thereof, and/or the like.

Note, prior art neutron absorbing utilization has involved using neutron absorbing inserts within steel capsules that contain SNF assemblies. Neutron-absorbing inserts or rods were placed strategically around the SNF assemblies, but never within the internal structures of the SNF assemblies, such as, never within the internal free void spaces of the SNF assemblies or other waste forms (such as, but not limited to, the chipped waste material 299, the waste pucks 301, the plurality of waste pucks 307, the ingots 500, and/or the like). These prior art neutron absorbing surrounding members were usually made of boron carbide, or borated steel, which has a high neutron absorption cross-section, making it an effective neutron absorber. In the present patent application, in some embodiments, because of high pressure and high temperature molten injection process using molten composition 409, the molten composition 409 when it contains neutron absorbent materials, places and forces these neutron absorbent materials into the internal free void space matrix structure of the given waste material within the die (mold) 403 (such as, but not limited to, SNF assembly [or portion thereof], chipped waste material 299, waste pucks 301, plurality of waste pucks 307, and/or the like), which the prior art never did.

Continuing discussing FIG. 8A, in some embodiments, step 809 may also be a step of determining an important operating parameter which may be the cooling time where ingot 500 may be removed from the die (mold) 403 after the injection process has completed (see also step 827 for when method 800 executes this cooling). In some embodiments, this cooling time for a diecasting molten injection process may be a minimum time required before a given produced ingot 500 may be ready to be removed from its die (mold) 403. Cooling time may vary depending on several factors, such as, but not limited: injection operating temperatures and pressures; die (mold) 403 size, complexity, and materials of construction; waste material type, size, and complexity (the waste material that shall be in the die 403 may be selected from: SNF assembly [or portion thereof], chipped waste material 299, waste pucks 301, plurality of waste pucks 307, and/or the like); the type and the volume of molten (melted) materials being used (e.g., the metal(s) and/or the alloy(s)); ingot 500 size and complexity; the cooling method(s) being employed; the cooling medium(s) being employed; portions thereof; combinations thereof; and/or the like. During the high-pressure diecasting process illustrated in FIG. 4A to FIG. 4C, molten material 409 is injected into the die (mold) 403 under high pressure and at high enough temperatures to keep 409 liquid (molten and/or melted) during the active injection process (step). After the injection, the cooling phase begins (even when the die (mold) 403 may still be closed), during which the liquid (molten and/or melted) material(s) 409 solidifies (resolidifies) taking the shape of the die (mold) 403 to produce a solid ingot 500 (with the waste material located within that ingot 500). The cooling time typically refers to the duration required for ingot 500 (the casting) to reach a temperature where ingot 500 (the casting) may safely be ejected (removed) from die (mold) 403 without unacceptable deformation of the resulting ingot 500. In some embodiments, the cooling time can range from a few seconds to several minutes, depending on several factors. In some embodiments, at least some of the factors that may influence the cooling time include (comprise): casting size and thickness; metal(s) and/or alloy(s) type(s) and/or composition(s); cooling method(s); injection operating temperatures and pressures; die (mold) 403 size and complexity; waste material type, size, and complexity (the waste material that shall be in the die 403 may be selected from: SNF assembly [or portion thereof], chipped waste material 299, waste pucks 301, plurality of waste pucks 307, and/or the like); the type and the volume of molten (melted) materials being used (e.g., the metal(s) and/or the alloy(s)); ingot 500 size and complexity; the cooling method(s) being employed; the cooling medium(s) being employed; portions thereof; combinations thereof; and/or the like. With respect to, casting size and thickness: larger and thicker castings (ingots 500) generally take longer to cool due to the increased amount of heat that needs to be dissipated (i.e., heat transfer is often proportional to the mass that needs cooling). With respect to, metal(s) and/or alloy(s) type(s) and/or composition(s): different metals and/or alloys have varying cooling rates. Some metals, such as aluminum, cool relatively quickly, while others, like steel, may require longer cooling times. With respect to, the cooling method: the cooling method used can also affect the cooling time. Cooling can be accomplished through natural radiation, conduction, and/or convection, and/or cooling can be accelerated using additional cooling mechanisms such as water (or other liquids and/or fluid) and/or air (or other gas) sprays, cooling channels within the mold (die), cooling baths, and/or other cooling means that are well used and well understood in the industrial diecasting injection molding processes. In some embodiments, an initial cooling time may be determined, calculated, selected, and/or approximated prior to diecasting operations during the initial process of modeling the system operations, such as, in step 809 of method 800, prior to method 800 executing the cooling step 827. And then, the cooling time may change during operation as experience is gained on the behavior of the total diecast injection system. This optimization process may allow for more efficient operations as thousands of SNF assemblies (possibly modified to be in waste puck 301 form) are processed according to method 800. In some embodiments, execution of step 809 may progress method 800 to step 811, to step 807, and/or to step 817.

Continuing discussing FIG. 8A, in some embodiments, step 811 may be a step of melting the melt materials 409 that are intended to be injected into the closed die (mold) 403 and around and into the included waste material within that closed die 403 during step 825. In some embodiments, step 811 may be accomplished with a melt furnace 407, melting means, and/or the like. In some embodiments, at least some of the melt materials 409 may be maintained in the liquid (molten and/or melted) status by melt furnace 407, the melting means, and/or the like. In some embodiments, the liquid (molten and/or melted) materials 409 may comprise the at least one selected and/or determined metal(s), alloy(s), and/or the neutron absorbing members (e.g., boron carbide [B₄C]), portions thereof, combinations thereof, and/or the like. In some embodiments, execution of step 811 may progress method 800 to step 813 and/or to step 815.

Continuing discussing FIG. 8A, in some embodiments, step 813 may be a step of measuring, collecting, gathering, and/or the like the volume of melt materials 409 from step 807, and making such collected volume ready for injection (in step 825). In some embodiments, this molten composition 409 that is measured, collected, gathered, and/or the like in step 813 may be maintained in its molten state. In some embodiments, this collected volume of melt materials 409 of this step 813, may be stored in melt reservoir 407 and/or in the injection cylinder (injection port 413) that is downstream of the ram 417 and/or downstream of the pusher arm 419. In some embodiments, execution of step 813 may progress method 800 to step 815.

Continuing discussing FIG. 8A, in some embodiments, step 815 may be a step of feeding the injection cylinder (injection port 413) that is downstream of the ram 417 and/or downstream of the pusher arm 419 with the melted (molten) materials 409. In some embodiments, execution of step 815 may progress method 800 to step 819 and/or to step 825.

Continuing discussing FIG. 8A, in some embodiments, step 816 may be a step of feeding the injection cylinder (injection port 413) that is downstream of the ram 417 and/or downstream of the pusher arm 419 with at least one neutron absorber (such as, but limited to boron carbide [B₄C]) (e.g., from neutron absorber reservoir 421). In some embodiments, execution of step 816 may progress method 800 to step 815. In some embodiments, step 816 may be optional, skipped, or omitted. In some embodiments, use of and/or inclusion of at least one neutron absorber (such as, but limited to boron carbide [B₄C]) may be determined from the fissile criticality analysis (FCA) of step 809.

Continuing discussing FIG. 8A, in some embodiments, step 817 may be a step of building a given die (mold) 403 that shall be configured to generate ingots 500 and/or to house the waste material during the injection step. In some embodiments, a given die (mold) 403 may be designed, engineered, sized, dimensioned, shaped, and/or the like, so that the given waste material (such as, but not limited to, SNF assembly [or portion thereof], chipped waste material 299, waste pucks 301, plurality of waste pucks 307, and/or the like) fits entirely within that given die (mold) 403 and with a minimum ingot 500 wall thickness 503. Recall, the size, shape, dimensions, exterior surface geometry, weight, and/or the like of a given waste material are either preexisting and well-known or will be known prior to building a given die (mold) 403. A given die (mold) 403 is designed and/or engineered so that the given waste material fits entirely within that given die (mold) 403. In some embodiments, the given die (mold) 403 may be at least partially designed, engineered, sized, dimensioned, shaped, and/or the like, from results of the step 809 fissile criticality analysis (FCA). In some embodiments, execution of step 817 may progress method 800 to step 819.

Continuing discussing FIG. 8A, in some embodiments, step 819 may be a step of inserting (loading) the given waste material (such as, but not limited to, SNF assembly [or portion thereof], chipped waste material 299, waste pucks 301, plurality of waste pucks 307, and/or the like) into an open die (mold) 403, prior to injection operations commencing within that closed die (mold) 403 that now entirely houses that waste material. In some embodiments, step 819 may be accomplished with a robotic handler 427 or the like. In some embodiments, after step 819 has completed, die (mold) 403 may be closed (with the loaded waste material now located within that now closed die [mold] 403). In some embodiments, execution of step 819 may progress method 800 to step 825.

Continuing discussing FIG. 8A, in some embodiments, step 819 may also entail prior to loading the nuclear and/or radioactive waste materials (such as, but not limited to, waste pucks 301 and/or 307) into the die (mold) 403, that nuclear and/or radioactive waste materials may be pre-heated (pre-warmed) with a heating means, such as, but not limited to, heated air (gas) or other means. This pre-heat option may allow the injected melt to be efficiently injected without undesired excessive cooling effects on contacting the nuclear and/or radioactive waste materials within the die (mold) 403 that may be too cold (cool).

Continuing discussing FIG. 8A, in some embodiments, step 821 may be a step of adding, applying, lining, covering, spraying, and/or the like, at least most of the interior surfaces of die (mold) 403 with at least one release agent 435 that may be configured to aid in the removal (ejection) of ingot 500 after die (mold) 403 of a given injection cycle completes and die (mold) 403 opens. In some embodiments, release agent(s) 435 may reduce friction and/or general stickiness between an exterior of ingot 500 of interior surfaces of die (mold) 403. Release agents for industrial metal/alloy based diecasting injection molding processes are well known in the industry and such release agents are incorporated by reference. Such release agent(s) and the release process are both well known in the industry and allows the molded finished product (casting) to be quickly released from the given mold cavity after injection and at least some cooling without undue sticky to its mold (die). For example, and without limiting the scope of the present invention, in some embodiments, high temperature capability release agents such as, but not limited to, graphite-based release agents, silicone-based release agents, and/or boron nitride based release agents may be used. In some embodiments, the release agent(s) 435 may be applied to the interior surfaces of the die (mold) 403 when die (mold) 403 may be empty (i.e., without the given waste material located within that die [mold] 403). In some embodiments, the release agent(s) 435 may be applied to the interior surfaces of the die (mold) 403 when die (mold) 403 may be open or closed, but empty (i.e., without a given waste material). In some embodiments, execution of step 821 may progress method 800 to step 819.

Continuing discussing FIG. 8A, in some embodiments, step 823 may be a step of injecting a purge (inert) gas into die (mold) 403 that has the given waste material (such as, but not limited to, SNF assembly [or portion thereof], chipped waste material 299, waste pucks 301, plurality of waste pucks 307, and/or the like) located within that given die (mold) 403 and before the actual injection of the molten materials 409 into that given die (mold) 403 begins (in step 825). In some embodiments, the inert gas may be used in the initial stage of the loading process of the die (mold) 403. Inert gases are commonly used in high-pressure diecasting operations to prevent oxidation and improve the casting quality. At least one primary purpose of using inert gases is to create a protective atmosphere within the diecasting machine, including within the closed die (mold), during the casting (injection) process. Typically, an inert gas such as, but not limited to, nitrogen and/or argon is introduced into the diecasting machine's die cavity 403 prior to the injection of molten metal(s) and/or alloy(s) 409. In some embodiments, this inert gas may help in several ways, such as, but not limited to: (1) oxidation prevention (mitigation); (2); heat removal (3) porosity reduction; (4) surface finish enhancement; portions thereof; combinations thereof; and/or the like. With respect to oxidation prevention (mitigation), inert gases may create (form) a barrier between the molten metal 409 and the surrounding air, minimizing or preventing oxidation of the metal (alloy) 409. Oxidation can degrade the quality of the casting (ingot) 500 and affect its mechanical properties. With respect to heat removal, inert gases aid in the quicker cooling and solidification of the molten metal 409, reducing cycle times and improving productivity. Use of the inert gas may help in extracting heat from the casting (ingot) 500, promoting solidification and maintaining dimensional accuracy. Use of the inert gas into die (mold) 403 may be done before and/or after the injection process (operation). With respect to porosity reduction, the use of inert gases can help reduce the formation of gas porosity within the castings (ingots) 500. By displacing air and/or other gases from the die (mold) cavity 403, inert gases minimize the likelihood of gas entrapment in the molten metal 409, resulting in improved structural integrity of the resulting ingots 500. With respect to surface finish enhancement, inert gases may help improve the surface finish of the casting (ingot) 500 by reducing the formation of oxide films and promoting a cleaner mold surface contact. A specific choice of inert gas and its application may vary depending on particulars of given the die casting process, the type of metal(s) (alloy(s)) being cast, and other well-known factors in the relevant art of metal/alloy diecasting—which are incorporated by reference. However, the general objective is to create a controlled environment within the diecasting machine, including within the closed the die (mold) 403, to enhance the casting (ingot) 500 quality and to reduce defects. However, in some embodiments, some or all of the beneficial features of the use of inert gases in the die (mold) 403, may not be necessary for disposal use applications taught in this patent application since the end product, i.e., ingots 500, may not be for consumers nor are they industrial items of specific required look, feel, and/or quality; but rather, ingots 500 are items that are destined for deep underground burial encapsulated in a deep horizontal wellbore (and/or within human-made cavern(s)). In some embodiments, execution of step 823 may progress method 800 to step 819. In some embodiments, step 823 may be optional, skipped, or omitted.

Continuing discussing FIG. 8A, in some embodiments, step 825 may be a step of injecting melted (molten) metal(s) 409 and/or alloy(s) 409 into loaded and closed die (mold) 403, wherein that loaded and closed die (mold) 403 entirely encloses the given waste material (such as, but not limited to, SNF assembly [or portion thereof], chipped waste material 299, waste pucks 301, plurality of waste pucks 307, and/or the like). In some embodiments, execution of step 825 may utilize at least one of: flow port 411, injection port 413, pressure means 415 (e.g., hydraulic means), ram 417, pusher/arm 419, portions thereof, combinations thereof, and/or the like. In some embodiments, in practice, the injection pressure may generally be between 1,000 psi (pounds per square inch) and 20,000 psi (and/or may occur while molten material 409 may be molten, i.e., at high temperature). In some embodiments, because of such high pressures and/or high temperatures, molten material 409 may be forced into and completely permeate any otherwise free void space(s) within die (mold) 403, such as, but not limited to, within puck(s) 301 and/or 307 (or other waste forms within that die [mold] 403). In some embodiments, in practice, injection occurs in a very short time, generally a few seconds (e.g., at least two [2] seconds) to two (2) to three (3) minutes of elapsed time, to minimize the potential of premature cooling of the melt 409 during transit into the closed die (mold) 403 and distribution into the void space interstices of the inserted waste material that is located within that closed die (mold) 403. Thus, injection occurs at both high temperature and at high pressure. In some embodiments, upon completion of step 825 a given ingot 500 (with the given waste material located within that produced ingot 500) may have been generated (outputted). In some embodiments, execution of step 825 may progress method 800 to step 827.

Continuing discussing FIG. 8A, in some embodiments, step 827 may be a step of cooling the newly formed ingot 500 sufficiently so that die (mold) 403 may be opened and that newly formed ingot 500 may be removed without that newly formed ingot 500 losing its 3D shape. Once, ingot 500 has sufficiently cooled (after execution of step 825), at least an exterior of that ingot 500 will be a solid 3D shape that is self-supporting (with no appreciable liquid flow). In some embodiments, cooling may take only a few seconds to less than an hour. In some embodiments, die (mold) 403 may comprise cooling channels for the movement of a cooling fluid, such as, but not limited to, a liquid and/or gas. In some embodiments, cooling may be aided by use of a cooling bath 429. In some embodiments, once ingot 500 has cooled sufficiently (i.e., the at least the exterior of that ingot 500 is a solid 3D shape that is self-supporting), die (mold) 403 may be opened, and that ingot 500 may be ejected (removed). In some embodiments, ingot 500 ejection (removal) from die (mold) 403 may be accomplished with robotic handler 427, with injector pins of die (mold) 403, combinations thereof, a portion thereof, and/or the like. Note, injector pins of a given diecasting mold are well understood in the industry and are incorporated by reference. In some embodiments, ingot 500 may be removed from die (mold) 403 and into a cooling bath 429. In some embodiments, step 827 may be a step of cooling ingot 500 and/or removing (ejecting) ingot 500 from die (mold) 403. In some embodiments, execution of step 827 may progress method 800 to step 829 or to step 831.

Continuing discussing FIG. 8A, in some embodiments, step 829 may be a step of passivating exterior surfaces of ingot 500. In some embodiments, once a given ingot 500 has been ejected (removed) from die (mold) 403, its exterior surfaces may be passivated. In some embodiments, the exterior surfaces of ingot 500 may be passivated by immersing, spraying, painting, and/or coating those exterior surfaces of ingot 500 in a bath of predetermined chemicals. In some embodiments, bath 429 may be configured for such passivation of the exterior surfaces of ingot 500. Passivation of copper (and/or its alloys) is a process used to create a protective layer on an exterior surface of the copper (or copper alloy) to improve its corrosion resistance. The passivation process involves first removing any impurities, oxides, and/or contaminants from its exterior surface and then secondly, forming a thin, (relatively) chemically inert layer that acts as a barrier against further oxidation and corrosion. The passivation of copper (or copper alloy) is typically achieved through chemical treatments. The specific chemicals and steps used in the passivation process can vary depending on the desired outcome and the application. Some effective protective layers may be organic and/or inorganic. The organic compounds form protective layers on the copper's exterior surface, enhancing its corrosion resistance. Some common organic compounds used for passivating copper (or copper alloy) may include: benzotriazole (BTA), imidazoles, portions thereof, combinations thereof, and/or the like. Benzotriazole (BTA) is a widely used organic compound for copper (or copper alloy) passivation. Benzotriazole (BTA) forms a protective layer on the copper's exterior surface, inhibiting corrosion caused by various environmental factors. Imidazoles, such as 1-methylimidazole and 1,2,4-triazole, are organic compounds that can passivate copper (or copper alloy) exterior surfaces effectively. Imidazoles form stable complexes with copper (or copper alloy), preventing further oxidation and corrosion of the copper's exterior surfaces that have treated (coated). In some embodiments, execution of step 829 may progress method 800 to step 831. In some embodiments, execution of step 829 may optional, skipped, or omitted.

Continuing discussing FIG. 8A, in some embodiments, step 831 may be a step of loading ingot(s) 500 into waste capsule(s) 600 (see e.g., FIG. 6). In some embodiments, completion of step 831 may result in at least one loaded (filled) and closed (sealed) waste capsule 600 that comprises at least one ingot 500, wherein that at least one ingot 500 comprises at least one entirely (completely) enclosed waste material (such as, but not limited to, SNF assembly [or portion thereof], chipped waste material 299, waste pucks 301, plurality of waste pucks 307, and/or the like). In some embodiments, execution of step 831 may progress method 800 to step 833.

Continuing discussing FIG. 8A, in some embodiments, step 833 may be a step of inserting (landing) loaded waste capsules 600 (which may be in string 701 format/configuration) into at least one (1) horizontal (lateral) wellbore(s) 703 and/or 901, wherein that at least one (1) horizontal (lateral) wellbore(s) 703 and/or 901 is at least partially located within a deeply located geologic formation 705. See e.g., FIG. 7 and FIG. 9. In some embodiments, drilling rig 907 (or the like) may be used in executing step 833. In some embodiments, execution of step 833 may progress method 800 to step 837.

Continuing discussing FIG. 8A, in some embodiments, step 835 may be a step of building and/or constructing at least one waste disposal system 900 (SuperLAT system 900) that uses deeply located horizontal wellbore(s) 901 that are located at least partially within the given deeply located geologic formation 705. See e.g., FIG. 9. In some embodiments, drilling rig 907 (or the like) may be used in executing step 835, in the building and/or in the constructing of at least one waste disposal system 900 (SuperLAT system 900). In some embodiments, execution of step 835 may progress method 800 to step 833.

Continuing discussing FIG. 8A, in some embodiments, step 837 may be a step of sealing (closing) a given waste disposal system 900 (SuperLAT system 900). In some embodiments, in executing step 837 at least one plug 915 may be emplaced within a (vertical) wellbore 703 and/or 903 of the given waste disposal system 900 (SuperLAT system 900) to seal that wellbore 703 and/or 903. In some embodiments, plug 915 may be made at least mostly (substantially) from concrete, cement, rock, portions thereof, combinations thereof, and/or the like.

FIG. 8B illustrates a flow chart of a portion of method 800, namely, how step 801 may interact and/or lead (flow) into step 819, in some embodiments, wherein method 800, step 801, and step 819 were discussed above in the discussion of FIG. 8A. FIG. 8B may be used because including the teachings of FIG. 8B into FIG. 8A would have made such a FIG. 8A undesirably visually crowded.

FIG. 9 may depict a waste disposal repository system 900 in which waste capsules 600 (with ingots 500) are sequestered in horizontal wellbore(s) 901, wherein the horizontal wellbore(s) 901 are at least partially located within deeply located geological formation(s) 705 (wherein a waste disposal repository system 900 that uses such horizontal wellbore(s) 901 that are located within deeply located geological formation(s) 705 may be referred to as a SuperLAT deep disposal system 900). FIG. 9 may depict a partial cutaway view of a system 900 for (long-term) disposing of nuclear, radioactive, hazardous, and/or dangerous waste, such as, but not limited to, ingots 500 (with radioactive waste therein, such as, but not limited to, SNF assembly [or portion thereof], chipped waste material 299, waste pucks 301, plurality of waste pucks 307, and/or the like), within the waste capsules 600, wherein such loaded waste capsule(s) 600 may be emplaced within horizontal (lateral) wellbore(s) 901, wherein at least some section(s) (portion(s) and/or region(s)) of the horizontal (lateral) wellbore(s) 901 may be located within at least one deeply located geologic formation (rock) 705. In some embodiments, each horizontal (lateral) wellbore 901 may be operatively connected to at least one vertical wellbore 903. In some embodiments, lengths of a pair of operatively connected horizontal (lateral) wellbore 901 section and vertical wellbore 903 section may be at least substantially (mostly) orthogonal (perpendicular) to each other (e.g., lateral wellbore 901 segments may be five [5] degrees or less off from being fully ninety degrees orthogonal with its connected vertical wellbore 903). In some embodiments, the vertical wellbore 903 (that is operatively connected to a section of horizontal [lateral] wellbore 901) may run from that section of horizontal (lateral) wellbore 901 (vertically) to a terrestrial (Earth) surface 905. In some embodiments, terrestrial (Earth) surface 905 may be an above ground local terrestrial surface of the Earth, wherein a given vertical wellbore 903 may originate at and descend (vertically) downwards into at least one deeply located geologic formation (rock) 705, which that wellbore may then change directions into the horizontal (lateral) direction to form at least one horizontal (lateral) wellbore 901 located within that at least one deeply located geologic formation (rock) 705. In some embodiments, “vertical” in the context of vertical wellbore 903, may mean that a given vertical wellbore 903 has a (majority) length that runs in a direction that is at least substantially (mostly) parallel with a local gravitational vector (local to that given vertical wellbore 903). In some embodiments, at a given well head site, using a given drilling rig 907 (or the like), from terrestrial (Earth) surface 905, first a given vertical wellbore 903 may be formed and drilled to at least a depth of and into the at least one deeply located geologic formation (rock) 705; and then, using a given drilling rig 907 (or the like), that wellbore may then change directions into the horizontal (lateral) direction to form at least one horizontal (lateral) wellbore 901 located at least partially within that at least one deeply located geologic formation (rock) 705.

Continuing discussing FIG. 9, in some embodiments, drilling rig(s) 907, from surface 905, may be used to form wellbore(s) 901, 903, and/or 703. In some embodiments, drilling rig(s) 907 using downhole tools and techniques, from surface 905, may be used to land, emplace, load, insert, place, and/or the like waste capsule(s) 600 (with ingots 500 therein) and/or string(s) 701 of waste capsules 600 (with ingots 500 within the waste capsules 600) within wellbore(s) 901, 903, and/or 703. In some embodiments, drilling rig(s) 907 using downhole tools and techniques, from surface 905, may be used to retrieve waste capsule(s) 600 (with ingots 500 within) and/or to retrieve string(s) 701 of waste capsules 600 (with ingots 500 within) from within wellbore(s) 901, 903, and/or 703. In some embodiments, drilling rig 907 may be at least substantially similar to a drilling rig used to form and/or case wellbores in oil and/or gas fields. In some embodiments, forming wellbore(s) 901, 903, and/or 703, as well as, handling waste capsule(s) 600 and/or string(s) 701 of waste capsule(s) 600, within wellbore(s) 901, 903, and/or 703, may be accomplished using drilling rigs, downhole tools, tooling, machines, devices, apparatus, systems, methods, processes, and/or techniques of the oil field industry that are in use today and well understood. Such preexisting downhole drilling rigs, tools, tooling, machines, devices, apparatus, systems, methods, processes, and/or techniques of the oil field industry are incorporated by reference herein as if fully set forth herein.

Continuing discussing FIG. 9, in some embodiments, deeply located geologic formation (rock) 705 may be located at least 5,000 feet (ft) below the surface 905, plus or minus 100 feet (ft). In some embodiments, deeply located geologic formation (rock) 705 may have a vertical thickness between fifty (50) feet (plus or minus ten feet) and 3,000 feet (plus or minus fifty feet). In some embodiments, deeply located geologic formation(s) (rock(s)) 705 may be of geological formations selected from tight shales, deeply bedded salt formations, deep bed-rock granite formations, portions thereof, combinations thereof, and/or the like. These types of geological formations usually (typically and/or often) all have very limited permeability and very low intrinsic water saturations, which contribute to be suitable geologic formations for deeply located geologic formation(s) (rock(s)) 705 that may accommodate long-term storage (disposal) of dangerous wastes therein with risking harm to the exterior ecosphere.

Continuing discussing FIG. 9, in some embodiments, located local to, adjacent to, and/or proximate to a given vertical wellbore 903 wellhead, on terrestrial (Earth) surface 905, may be at least one nuclear power generation reactor plant 911. In some embodiments, located onsite to a given vertical wellbore 903 wellhead, on terrestrial (Earth) surface 905, may be at least one nuclear power generation reactor plant 911. In some embodiments, operation of nuclear power generation reactor plant 911 may yield electrical power, typically for grid level distribution and may also yield SNF that requires safe, efficient, and cost-effective long-term disposal, such as, but not limited to, disposal within a given waste repository system 900. In some embodiments, located, local to, adjacent to, and/or proximate to a given vertical wellbore 903 wellhead, on terrestrial (Earth) surface 905, may be at least one infrastructure building or structure 913. In some embodiments, located onsite to a given vertical wellbore 903 wellhead, on terrestrial (Earth) surface 905, may be at least one infrastructure building or structure 913. In some embodiments, infrastructure building or structure 913 may comprise one or more of: SNF cooling pools, SNF cooling ponds, SNF temporary storage casks, control rooms, operations rooms, warehouses, maintenance and engineering workshops, offices, and/or other building(s) and/or structures typical to have at a nuclear power generation reactor plant 911 site. In this context of surface 905 structure(s), objects, and/or building(s) 913 of a particular nuclear power generation reactor plant 911 site, SNF cooling pond(s)/pool(s) site, SNF temporary storage site, and/or system 900 site, “local,” “onsite,” “adjacent,” and/or “proximate” may be five (5) miles or less. Note, “site” may be as that term is used and/or defined in U.S. nonprovisional utility patent application, patent application Ser. No. 18/108,001, filed Feb. 9, 2023, by the same inventor as the present patent application (Henry Crichlow).

Continuing discussing FIG. 9, in some embodiments, after a given horizontal (lateral) wellbore 901 has been at least partially to fully filled with waste capsules 600 (containing ingots 500), that given repository system 900 may be sealed (closed off) by placing at least one plug 915 within a section of vertical wellbore 903, that operatively connects to that at least partially filled horizontal (lateral) wellbore 901. In some embodiments, plug 915 may be at least partially made from concrete, steel, and/or rock 705 material. In some embodiments, an emplaced plug 915, within a given wellbore 903, may close off that wellbore system, from liquid (water) and/or mechanical/particulate intrusion and/or migration issues.

In some embodiments, a given nuclear, radioactive, hazardous, and/or dangerous waste repository disposal system 900 (SuperLAT system 900) may comprise at least one of (one or more of): at least one horizontal (lateral) wellbore 901 located (entirely or at least partially) within at least one deeply located geologic formation (rock) 705; at least one vertical wellbore 903 that may operatively connect to that at least one horizontal (lateral) wellbore 901 and that may run from that at least one horizontal (lateral) wellbore 901 to surface 905; at least one waste capsule 600 (with at least one ingot 500 located within that at least one waste capsule 600); at least one emplaced plug 915 located within that at least one vertical wellbore 903; at least one drilling rig 907; at least one nuclear power generation reactor plant 911 (operational, non-operational, and/or decommissioned); at least one infrastructure building or structure 913; combinations thereof; and/or the like.

Note, various embodiments of the present invention may be characterized as methods, systems, devices, apparatus, portions thereof, and/or the like.

For example, and without limiting the scope of the present invention, device and/or apparatus embodiments of the present invention may comprise ingot 500. In some embodiments, ingot 500 may comprise at least one puck 301, wherein the at least one puck 301 may comprises a portion of a spent nuclear fuel assembly or a section thereof that has been chipped and compacted, and ingot 500 may further comprise a molten composition 409 that has resolidified, wherein the molten composition 409 that has resolidified both entirely and completely covers an exterior of the at least one puck 301 and may also penetrate into internal void spaces of the at least one puck 301 (if any). In some embodiments, ingot 500 may be manufactured from a diecasting injection molding process. In some embodiments, the molten composition 409 may comprise at least one alloy of copper and optionally, at least one neutron absorber, such as, but not limited to, boron carbide (B₄C). See e.g., FIG. 3F and method 320, FIG. 8A and method 800, and FIG. 4A to FIG. 5C.

For example, and without limiting the scope of the present invention, system embodiments of the present invention may comprise a system for processing spent nuclear fuel assemblies or portions thereof, wherein the system may comprise at least one ingot 500. In some embodiments, ingot 500 may comprise at least one puck 301, wherein the at least one puck 301 may comprises a portion of a spent nuclear fuel assembly or a section thereof that has been chipped and compacted, and ingot 500 may further comprise a molten composition 409 that has resolidified, wherein the molten composition 409 that has resolidified both entirely and completely covers an exterior of the at least one puck 301 and may also penetrate into internal void spaces of the at least one puck 301 (if any). In some embodiments, this system may further comprise at least one of: at least one diecast mold 403; at least one diecast injection molding press machine 401; at least one waste capsule 600; at least one string 701 of two or more waste capsules 600; at least one horizontal wellbore 703 and/or 901 that is located at least partially within a deeply located geologic formation 705; injection system 405; melt furnace 407 and/or melt reservoir 407; molten composition 409; ladle 410; flow port 411; injection port 413; pressure means 415; ram 417; pusher (arm) 419; neutron absorber reservoir 421; port 423 for neutron absorber; neutron absorber; gas cylinder 425; robotic handler 427; cooling bath 429; controller 431; release agent 435; outlet port 437; outlet reservoir 439; support 441; ejection means; plate 603; sleeve 609; support (standoff) 611; pipe 605; pipe coupling 607; vertical wellbore 903; drilling rig 907; plug 915; portions thereof; combinations thereof; and/or the like. In some embodiments, the at least one diecast mold 403 may have been used in forming the at least one ingot 500 from a diecast injection molding process (e.g., method 800), wherein the at least one diecast mold 403 may be configured to house the at least one puck 301. In some embodiments, the at least one diecast injection molding press machine 401 may have been used in forming the at least one ingot 500 from a diecast injection molding process (e.g., method 800). In some embodiments, the at least one waste capsule 600 may be configured to house the at least one ingot 500. In some embodiments, the at least one horizontal wellbore 901 (703) may be configured to hold the at least one ingot 500 (and/or at least one waste capsule 600) therein, wherein the at least one horizontal wellbore 901 (703) may operationally connect to at least one vertical wellbore 903 that runs to a terrestrial surface 905.

For example, and without limiting the scope of the present invention, method embodiments of the present invention may comprise method 320 and/or method 800 for processing spent nuclear fuel assemblies or portions thereof for long-term disposal. In some embodiments, the at least one spent nuclear fuel assembly or portion thereof that is referred to in method 320 and/or method 800 and/or in this patent application may be a spent nuclear fuel assembly or portion thereof that was manufactured in: the United States of America (U.S.), Canada, Russia, Sweden, Finland, France, Germany, or the like. In some embodiments, method 320 and/or method 800 may comprise a step (a), a step (b), a step (c), a step (d), and a step (e).

In some embodiments, the step (a) may be the same or at least substantially (mostly) the same as step 322. In some embodiments, the step (a) may comprise reducing a size of a spent nuclear fuel assembly or a portion thereof into chips 299 by chipping, cutting, shredding, and/or grinding the spent nuclear fuel assembly or the portion thereof, using at least one chipper machine. See e.g., FIG. 3A to FIG. 3F.

In some embodiments, the step (b) may be the same or at least substantially (mostly) the same as step 326. In some embodiments, the step (b) may comprise compressing the chips 299 into at least one puck 301 using at least one compactor machine. See e.g., FIG. 3A to FIG. 3F.

In some embodiments, the step (c) may be the same or at least substantially (mostly) the same as step 819. In some embodiments, the step (c) may comprise placing at least one waste puck 301, into a diecast mold 403 and closing the diecast mold 403 around the at least one waste puck 301. In some embodiments, the diecast mold 403 may be configured to entirely and completely enclose the at least one waste puck 301 when the diecast mold 403 may be closed. See e.g., FIG. 4A and FIG. 4B and step 819 in FIG. 8A.

In some embodiments, the step (d) may be the same or at least substantially (mostly) the same as step 825. In some embodiments, the step (d) may comprise injecting into the diecast mold 403, that is closed and that houses the at least one puck 301, a molten composition 409, that upon sufficient cooling after the injecting has finished forms ingot 500. In some embodiments, the sufficient cooling may be when a temperature of at an exterior of the molten composition 409 within the diecast mold 403 has lowered enough after the step (d) injection has stopped for the exterior of the molten composition 409 to have resolidified. In some embodiments, ingot 500 may comprise the molten composition 409 that was injected into the diecast mold 403 and that has solidified and wherein the ingot 500 may further comprise the at least one puck 301. See e.g., FIG. 4A and FIG. 4B and step 825 in FIG. 8A.

In some embodiments, the step (e) may be the same or at least substantially (mostly) the same as step 827. In some embodiments, the step (e) may comprise ejecting the ingot 500 from the diecast mold 403 by opening the diecast mold 403 and using an ejection means to eject the ingot 500. In some embodiments, the ejection means may comprise at least one robotic handler 427 that may be configured to remove the ingot 500 from the diecast mold 403 that is open. In some embodiments, the ejection means may additionally or alternatively comprise ejection pins (rods).

In some embodiments, the step (d) injection step may be accomplished by an injection system 405 and a pressure means 415. In some embodiments, the injection system 405 physically and operationally links a reservoir 407 to the diecast mold 403. In some embodiments, the reservoir 407 may be configured to hold at least some of the molten composition 409. In some embodiments, the pressure means 415 may generate (sufficient) pressure that pushes (forces) a portion of the molten composition 409 in the injection system 405 into the diecast mold 403. In some embodiments, the reservoir 407 may be heated to generate and/or maintain the at least some of the molten composition 409 in a molten (melted and/or liquid) configuration (state). In some embodiments, the pressure means 415 may comprise a hydraulic piston 419 and ram 417 assembly. See e.g., FIG. 4A to FIG. 4C.

In some embodiments, during the step (d) injection, the molten composition 409 that is injected into the diecast mold 403 both entirely covers exteriors of the at least one puck 301 that is located within the diecast mold 403 and may also penetrate into internal void spaces (if any) of the at least one puck 301.

In some embodiments, the molten composition 409 may comprise at least one alloy of copper. In some embodiments, the molten composition 409 may further comprise at least one neutron absorber. In some embodiments, the at least one neutron absorber is configured to absorb neutron emissions from the at least one puck 301. In some embodiments, the at least one neutron absorber may be boron carbide (B₄C).

In some embodiments, with respect to a given ingot 500, the at least one puck 301 may be entirely and completely disposed within an exterior of that ingot 500 after the step (d) injection is stopped such that between the exterior of the ingot 500 and an exterior of the at least one puck 301 may be a minimum thickness 503 of the molten composition 409 that has resolidified. See e.g., FIG. 5B and FIG. 5A.

In some embodiments, the method 800 (after executing the step (e)) may further comprise a step of passivating an exterior of the ingot 500 (see e.g., step 829); wherein, in some embodiments, this passivating step may occur after the step (e).

In some embodiments, the method 800 (after executing the step (e)) may further comprise a step of placing at least one ingot 500 into at least one waste capsule 600 (see e.g., FIG. 6 and FIG. 8A, step 831). In some embodiments, the at least one waste capsule 600 may comprise neutron absorbing members that are configured to surround the at least one ingot 500 within the waste capsule 600. In some embodiments, the neutron absorbing members may be configured to absorb neutron emissions from the at least one ingot 500 (within that waste capsule 600). In some embodiments, the neutron absorbing members may comprise a sleeve 609 and/or plates 603. In some embodiments, the sleeve 609 may be hollow and may be configured to fit over an exterior length of the at least one ingot 500. In some embodiments, the plates 603 may be configured to be placed at opposing terminal ends of the at least one ingot 500 (within that waste capsule 600). In some embodiments, the sleeve 609 and/or the plates 603, may be at least partially made from borated steel. See e.g., FIG. 6.

In some embodiments, the method 800 (after executing the step (e)) may further comprise a step of inserting the at least one waste capsule 600 into a horizontal wellbore 901 that is located at least partially within a deeply located geologic formation 705 (see e.g., step 833). In some embodiments, the horizontal wellbore 901 may (operationally) connect to a vertical wellbore 903 that runs to a terrestrial surface 705. See e.g., FIG. 7, FIG. 8A, and FIG. 9.

In some embodiments, prior to the step (c), the method 800 may comprise a step of coating at least some of the interior surfaces of the diecast mold 403 with at least one release agent 435 (see e.g., step 821). In some embodiments, the at least one release agent 435 may be configured to promote the step (e) ejection of the ingot 500 from the diecast mold 403. In some embodiments, the at least one release agent 435 may be at least one component/aspect of the ejection means. See e.g., FIG. 4B and FIG. 8A.

In some embodiments, after the step (c) but prior to the step (d), the method 800 may further comprise a step of purging an internal volume 433 of inside of the diecast mold 403 that is closed with at least one purge gas (see e.g., step 823). In some embodiments, this purge process may be done to remove at least substantially (most) of oxygen (e.g., from atmospheric air) from the internal volume 433 of inside of the diecast mold 403 that is closed, to minimize oxidation of exterior surfaces of the to be formed ingot 500. In some embodiments, the at least one purge gas may be a gas that is generally considered to be substantially (mostly) inert, such as, but not limited to, nitrogen, argon, portions thereof, combinations thereof, and/or the like.

In some embodiments, the method 320 and/or 800 does not utilize a chemical treatment of the chips 299, aside from during execution of the step (b) (step 326), wherein during execution of the step (b) the method may optionally use a binding agent on at least some of the chips 299 and/or the method optionally uses a release agent on the at least one compactor machine (e.g., to help with release of generated chips 299). In some embodiments, the method 320 and/or 800 does not utilize an acidic chemical treatment of the chips 299. In some embodiments, the method 320 and/or 800 does not utilize a nitric acid chemical treatment (or the like) of the chips 299. In some embodiments, with respect to the chips 299, the method 320 and/or 800 does not separate radioactive materials from non-radioactive materials.

In some embodiments, other forms of radioactive waste (e.g., aside from SNF) may be fed into the at least one chipper machine during execution of the step (a) (step 322) that contributes to generation of the chips 299. In some embodiments, the other forms of radioactive waste may be selected from at least one of: radioactive metal materials; depleted uranium penetrators; waste from nuclear weapons programs; uranium oxide powder; a portion thereof; combinations thereof; and/or the like.

In some embodiments, die (mold) 403 may be configured to entirely house (hold) any nuclear and/or radioactive waste noted and/or discussed herein, such as, but not limited to, chipped waste 299 and/or waste puck(s) 301/307. In some embodiments, the nuclear and/or radioactive waste noted and/or discussed herein may be selected from one or more of: SNF assembly 101, 102, 103, and/or 210; chipped waste 299; waste puck(s) 301/307; ingot(s) 500; modified plurality of waste pucks 507; spent nuclear fuel assembly; fuel rod; fuel pellet; control rod; radioactive metal materials; depleted uranium penetrators; waste from nuclear weapons programs; uranium oxide powder; a portion thereof; combinations thereof; and/or the like.

Methods of forming metal alloy ingots that contain high-level nuclear waste (HLW), such as, but not limited to, spent nuclear fuel (SNF) assemblies, or portions thereof (including in chipped and/or waste puck format), from diecast injection molding operations, these ingots, methods of disposing of these ingots into deeply located wellbores, and systems thereof have been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A method for processing spent nuclear fuel assemblies or portions thereof for long-term disposal, wherein the method comprises steps of:
(a) reducing a size of a spent nuclear fuel assembly or a portion thereof into chips by chipping, cutting, shredding, and/or grinding the spent nuclear fuel assembly or the portion thereof, using at least one chipper machine;
(b) compressing the chips into at least one puck using at least one compactor machine;
(c) placing the at least one puck into a diecast mold and closing the diecast mold around the at least one puck;
(d) injecting into the diecast mold that is closed and that houses the at least one puck, a molten composition that upon sufficient cooling after the injecting has finished forms an ingot, wherein the ingot comprises the molten composition that was injected into the diecast mold and that has solidified and wherein the ingot further comprises the at least one puck; and
(e) ejecting the ingot from the diecast mold by opening the diecast mold and using an ejection means to eject the ingot.

2. The method according to claim 1, wherein the method does not utilize a chemical treatment of the chips, aside from during execution of the step (b), wherein during execution of the step (b) the method optionally uses a binding agent on at least some of the chips and/or the method optionally uses a release agent on the at least one compactor machine.

3. The method according to claim 1, wherein the method does not utilize an acidic chemical treatment of the chips.

4. The method according to claim 1, wherein the method does not utilize a nitric acid chemical treatment of the chips.

5. The method according to claim 1, wherein with respect to the chips, the method does not separate radioactive materials from non-radioactive materials.

6. The method according to claim 1, wherein other forms of radioactive waste are fed into the at least one chipper machine during execution of the step (a) that contributes to generation of the chips, wherein the other forms of radioactive waste are selected from at least one of: radioactive metal materials; depleted uranium penetrators; waste from nuclear weapons programs; or uranium oxide powder.

7. The method according to claim 1, wherein the spent nuclear fuel assembly or the portion thereof was manufactured in: United States of America, Canada, Russia, Sweden, France, Germany, or Finland.

8. The method according to claim 1, wherein the diecast mold is configured to entirely and completely enclose the at least one puck when the diecast mold is closed.

9. The method according to claim 1, wherein the step (d) injection step is accomplished by an injection system and a pressure means; wherein the injection system physically and operationally links a reservoir to the diecast mold, wherein the reservoir is configured to hold at least some of the molten composition; and wherein the pressure means generates pressure that pushes and/or forces a portion of the molten composition in the injection system into the diecast mold.

10. The method according to claim 9, wherein the reservoir is heated to generate and/or maintain the at least some of the molten composition in a molten configuration.

11. The method according to claim 9, wherein the pressure means comprises a hydraulic piston and ram assembly.

12. The method according to claim 1, wherein the sufficient cooling is when a temperature of an exterior of the molten composition within the diecast mold has lowered enough after the step (d) injection has stopped for the exterior of the molten composition to have resolidified.

13. The method according to claim 1, wherein the molten composition comprises at least one alloy of copper.

14. The method according to claim 13, wherein the molten composition further comprises at least one neutron absorber, wherein the at least one neutron absorber is configured to absorb neutron emissions from the at least one puck.

15. The method according to claim 14, wherein the at least one neutron absorber is boron carbide (B₄C).

16. The method according to claim 1, wherein with respect to the ingot, the at least one puck is entirely and completely disposed within an exterior of the ingot after the step (d) injection is stopped such that between the exterior of the ingot and an exterior of the at least one puck there is a minimum thickness of the molten composition that has resolidified.

17. The method according to claim 1, wherein the ejection means comprises at least one robotic handler that is configured to remove the ingot from the diecast mold that is open.

18. The method according to claim 1, wherein the method further comprises a step of passivating an exterior of the ingot.

19. The method according to claim 1, wherein the method further comprises a step of placing at least one ingot into at least one waste capsule.

20. The method according to claim 19, wherein the at least one waste capsule comprises neutron absorbing members that are configured to surround the at least one ingot within the at least one waste capsule, wherein the neutron absorbing members are configured to absorb neutron emissions from the at least one ingot.

21. The method according to claim 20, wherein the neutron absorbing members comprise a sleeve and plates, wherein the sleeve is hollow and is configured to fit over an exterior length of the at least one ingot, and wherein the plates are configured to be placed at opposing terminal ends of the at least one ingot.

22. The method according to claim 21, wherein the sleeve and/or the plates, at are least partially made from borated steel.

23. The method according to claim 19, wherein the method further comprises a step of inserting the at least one waste capsule into a horizontal wellbore that is located at least partially within a deeply located geologic formation, wherein the horizontal wellbore connects to a vertical wellbore that runs to a terrestrial surface.

24. The method according to claim 1, wherein prior to the step (c), the method comprises a step of coating at least some of the interior surfaces of the diecast mold with at least one release agent, wherein the at least one release agent is configured to promote the step (e) ejection of the ingot from the diecast mold.

25. The method according to claim 1, wherein after the step (c) but prior to the step (d), the method further comprises a step of purging an internal volume of inside of the diecast mold that is closed with at least one purge gas.

26. A system for processing spent nuclear fuel assemblies or portions thereof, wherein the system comprises at least one ingot, wherein the at least one ingot comprises at least one puck, wherein the at least one puck comprises a portion of a spent nuclear fuel assembly or a section thereof that has been chipped and compacted, and wherein the at least one ingot further comprises a molten composition that has resolidified, wherein the molten composition that has resolidified both entirely and completely covers an exterior of the at least one puck.

27. The system according to claim 26, wherein the system further comprises at least one diecast mold, wherein the at least one diecast mold was used in forming the at least one ingot from a diecast injection molding process, wherein the at least one diecast mold is configured to house the at least one puck.

28. The system according to claim 26, wherein the system further comprises at least one diecast injection molding press machine, wherein the at least one diecast injection molding press machine was used in forming the at least one ingot from a diecast injection molding process.

29. The system according to claim 26, wherein the system further comprises at least one waste capsule, wherein the at least one waste capsule is configured to house the at least one ingot.

30. The system according to claim 26, wherein the system further comprises at least one horizontal wellbore that is located at least partially within a deeply located geologic formation, wherein the at least one horizontal wellbore is configured to hold the at least one ingot therein, wherein the at least one horizontal wellbore connects to at least one vertical wellbore that runs to a terrestrial surface.

31. An ingot that comprises at least one puck, wherein the at least one puck comprises a portion of a spent nuclear fuel assembly or a section thereof that has been chipped and compacted, and wherein the ingot further comprises a molten composition that has resolidified, wherein the molten composition that has resolidified both entirely and completely covers an exterior of the at least one puck.

32. The ingot according to claim 31, wherein the ingot is manufactured from a diecasting injection molding process.

33. The ingot according to claim 31, wherein the molten composition comprises at least one alloy of copper.
